(19) United States
(12) Patent Application Publication
(10) Pub. No.: US 2022/0413943 A1
(43) Pub. Date: Dec. 29, 2022

(54) APPARATUS, ARTICLES OF MANUFACTURE, AND METHODS FOR MANAGING PROCESSING UNITS

(71) Applicant: Intel Corporation, Santa Clara, CA (US)

(72) Inventors: Rajesh Poornachandran, Portland, OR (US); Kaushik Balasubramanian, Beaverton, OR (US); Karan Puttannaiah, Hillsboro, OR (US)

(21) Appl. No.: 17/705,256

(22) Filed: Mar. 25, 2022

Related U.S. Application Data
(63) Continuation-in-part of application No. PCT/CN2021/141150, filed on Dec. 24, 2021.
Application No. PCT/CN2021/141150 is a continuation-in-part of application No. 17/645,742, filed on Dec. 22, 2021.
Application No. 17/645,742 is a continuation-in-part of application No. 17/560,025, filed on Dec. 22, 2021.
Application No. 17/560,025 is a continuation-in-part of application No. 17/559,730, filed on Dec. 22, 2021.
Application No. 17/559,730 is a continuation-in-part of application No. 17/558,284, filed on Dec. 21, 2021.
(60) Provisional application No. 63/222,938, filed on Jul. 16, 2021.
(60) Provisional application No. 63/222,938, filed on Jul. 16, 2021.
(60) Provisional application No. 63/222,938, filed on Jul. 16, 2021.

(30) Foreign Application Priority Data
Jun. 23, 2021 (IN) 202141028125
Aug. 10, 2021 (IN) 202141036070

(51) Int. Cl. G06F 9/50; G06F 9/455; G06F 11/34; H04L 9/00

(52) U.S. Cl. CPC G06F 9/5088; G06F 9/45558; G06F 9/5077; G06F 11/3409; H04L 9/50; G06F 2009/4557; G06F 2209/503

(57) ABSTRACT

interface circuitry to detect a request to obtain a resource request from a workload and processor circuitry including one or more of: at least one of a central processing unit, a graphic processing unit or a digital signal processor, the at least one of the central processing unit, the graphic processing unit or the digital signal processor having control circuitry, arithmetic and logic circuitry, and one or more registers, the processor circuitry to execute instructions to: determine if resources are available for the workload on an infrastructure processing unit managed system; negotiate with the infrastructure processing unit to determine if an executing workload can be migrated; in response to determining that an executing workload can be migrated, cause the executing workload to be migrated; and cause the workload to execute on the resource.

### RELATED APPLICATION

This patent arises from a continuation of PCT Application No. PCT/CN2021/141150, filed Dec. 24, 2021, which claims the benefit of Indian Patent Application No. 202141028125, which was filed on Jun. 23, 2021, U.S. Patent Application No. 63/222,938, which was filed on Jul. 16, 2021, Indian Patent Application No. 202141036070, which was filed on Aug. 10, 2021, U.S. patent application Ser. No. 17/645,742, which was filed Dec. 22, 2021, U.S. patent application Ser. No. 17/559,730, which was filed Dec. 22, 2021, U.S. patent application Ser. No. 17/560,025, which was filed Dec. 22, 2021, and U.S. patent application Ser. No. 17/558,284, which filed Dec. 21, 2021. Indian Patent Application No. 202141028125, U.S. Patent Application No. 63/222,938, Indian Patent Application No. 202141036070, U.S. patent application Ser. No. 17/645,742, U.S. patent application Ser. No. 17/559,730, U.S. patent application Ser. No. 17/560,025, and U.S. patent application Ser. No. 17/558,284 are hereby incorporated herein by reference in their entireties. Priority to Indian Patent Application No. 202141028125, U.S. Patent Application No. 63/222,938, Indian Patent Application No. 202141036070, U.S. patent application Ser. No. 17/645,742, U.S. patent application Ser. No. 17/559,730, U.S. patent application Ser. No. 17/560,025, and U.S. patent application Ser. No. 17/558,284 is hereby claimed.

### FIELD OF THE DISCLOSURE

This disclosure relates generally to computing systems and, more particularly, to apparatus, articles of manufacture, and methods for managing processing units.

### BACKGROUND

Evolutions in computing systems has led to the utilization of computing systems with many types of processing units. For example, the concept of XPU is directed to the utilization of application specific processing units that may be included in a computing system. For example, a computing system may include a general purpose processing unit, a graphics processing unit, and an artificial intelligence processing unit. An XPU is a cross-architecture computing solution that may be tied together in a single application programming interface (e.g., the oneAPI Standard Application Programming Interface), which manages the assignment of assigning each task to whichever processing unit is best suited to process it. For example, many cloud Service Providers (CSPs) are evolving their hardware platforms to disaggregated elements consisting of general-purpose processors, heterogeneous accelerators and purpose-built vertically integrated Infrastructure Processing Units (IPUs). Such processing units may be implemented by attached cards (e.g., peripheral control interconnect express (PCIE) attached cards), external processing units connected via a table (e.g., via a Thunderbolt port), via a motherboard-down (MB-down) solution soldered or otherwise attached to the motherboard, built into a central processing unit (CPU), etc.

### BRIEF DESCRIPTION OF THE DRAWINGS

FIG. 1 is a block diagram of an example architecture for supporting heterogenous computing.

FIG. 2 is a block diagram of an example architecture for sharing memory between two processing units (e.g., a CPU and a GPU).

FIG. 3 is a block diagram of an example approach for sharing the SPI flash using attached flash sharing.

FIG. 4 illustrates an example updated IFWI layout for the SPI flash of FIG. 2.

FIG. 5 is a flowchart representative of example machine readable instructions and/or example operations that may be executed and/or instantiated by processor circuitry to perform a firmware boot of a system where shared access flash has been implemented between two processing units.

FIG. 6 is a block diagram of an example layout of BIOS (e.g., the BIOS stored in Region 2 of the IFWI layout of FIG. 4).

FIGS. 7A and 7B are a flowchart representative of example machine readable instructions and/or example operations that may be executed and/or instantiated by processor circuitry to perform unified initialization of processing units using silicon initialization code.

FIG. 8 is a flowchart illustrating an example detailed Unified FSP initialization flow with integrated graphics device (IGD) and GPU.

FIG. 9 is a block diagram of an example architecture for IPURDT.

FIG. 10 is a flowchart representative of example machine readable instructions and/or example operations that may be executed and/or instantiated by processor circuitry to perform configuring using IPURDT.

FIG. 11 is a flowchart representative of example machine readable instructions and/or example operations that may be executed and/or instantiated by processor circuitry to conduct negotiation to dynamically allocate resources based on tolerances prescribed by an application and available IPU resources.

FIG. 12 illustrates an example environment in which resources managed by IPUs have various states of free and busy resources among CPU, GPU, SSD, etc.

FIG. 13 illustrates an example environment in which consensus in collaborative resource management is accomplished via a decentralized public block chain ledger.

FIG. 14 is a block diagram of an example dynamic negotiable dynamic neural network library.

FIG. 15 is a flowchart representative of example machine readable instructions and/or example operations that may be executed and/or instantiated by processor circuitry to select features for deep neural network learning based on hardware capabilities.

FIG. 16 is a block diagram of an example processing platform including processor circuitry structured to execute the example machine readable instructions and/or the example operations to implement the example composable machine learning system configurator of FIGS. 1, 2, and/or 3.

FIG. 17 is an illustration of an example automatic machine learning (AutoML) architecture including an example machine-learning system configurator to identify and/or generate a composable machine learning compute node.

FIG. 18 is a block diagram of an example configuration of a dynamic XPU hardware-aware deep learning (DL) model management system 200, implemented in accordance with the teachings of this disclosure.

FIG. 19 is a flowchart representative of example machine readable instructions and/or example operations that may be executed by example processor circuitry to implement the example model training circuitry of FIG. 18.

FIG. 20 is a flowchart representative of example machine readable instructions and/or example operations that may be executed by example processor circuitry to implement the example model management circuitry of FIG. 18.

FIG. 21 is a block diagram of an example processing platform including processor circuitry structured to execute the example machine readable instructions and/or the example operations of FIG. 19 to implement the model training circuitry and model management circuitry of FIG. 18.

FIG. 22 is a block diagram of an example system implemented in accordance with the teachings of this disclosure for data enhanced automated model generation.

FIG. 23 is a block diagram of an example process flow utilizing the example system of FIG. 22.

FIG. 24 is a flowchart representative of example machine readable instructions and/or example operations that may be executed by example processor circuitry to implement the example knowledge builder circuitry and the example model builder circuitry of FIG. 22.

FIG. 25 is a flowchart representative of example machine readable instructions and/or example operations that may be executed by example processor circuitry to implement the example target hardware of FIG. 22.

FIG. 26 is a block diagram of an example processing platform including processor circuitry structured to execute the example machine readable instructions and/or the example operations of FIG. 24 to implement the example knowledge builder circuitry and the example model builder circuitry of FIG. 22.

FIG. 27 is a block diagram of an example computing device.

FIG. 28 is a block diagram of an implementation of the example instructions set architecture (ISA) managing circuitry and the microcode processing circuitry of FIG. 27.

FIGS. 29 and 30 are flowcharts representative of example machine readable instructions that may be executed by example processor circuitry to implement the ISA managing circuitry of FIG. 28.

FIG. 31 is a flowchart representative of example machine readable instructions that may be executed by example processor circuitry to implement the microcode processing circuitry of FIG. 28.

FIG. 32 is an example diagram representative of example operations that may be executed by the ISA managing circuitry of FIG. 28.

FIG. 33 is a block diagram of an example processing platform including processor circuitry structured to execute the example machine readable instructions of FIGS. 29-31 to implement the example computing device of FIG. 27.

FIG. 34 is an illustration of an example automatic machine learning (AutoML) architecture including an example machine-learning system configurator to identify and/or generate a composable machine learning compute node.

FIG. 35 is a block diagram of an example implementation of the machine-learning system configurator of FIG. 34.

FIG. 36 is a block diagram of an example implementation of the machine-learning system configurator of FIGS. 34 and/or 35.

FIG. 37 is an illustration of an example workflow to generate a composable machine learning compute node.

FIG. 38 is an illustration of another example workflow to identify a composable machine learning compute node.

FIG. 39 is an illustration of an example implementation of an example ontology database.

FIG. 40 is an illustration of yet another example workflow to identify a composable machine learning compute node.

FIG. 41 is a flowchart representative of example machine readable instructions and/or example operations that may be executed by example processor circuitry to implement the example composable machine learning system configurator of FIGS. 34, 35, and/or 36 to execute a workload with a composable machine learning compute node.

FIG. 42 is a flowchart representative of example machine readable instructions and/or example operations that may be executed by example processor circuitry to implement the example composable machine learning system configurator of FIGS. 34, 35, and/or 36 to generate a first configuration of one or more machine-learning models based on a machine-learning workload.

FIG. 43 is a flowchart representative of example machine readable instructions and/or example operations that may be executed by example processor circuitry to implement the example composable machine learning system configurator of FIGS. 34, 35, and/or 36 to generate a second configuration of hardware.

FIG. 44 is a flowchart representative of example machine readable instructions and/or example operations that may be executed by example processor circuitry to implement the example composable machine learning system configurator of FIGS. 34, 35, and/or 36 to adjust a first configuration based on an evaluation parameter.

FIG. 45 is a flowchart representative of example machine readable instructions and/or example operations that may be executed by example processor circuitry to implement the example composable machine learning system configurator of FIGS. 34, 35, and/or 36 to adjust a second configuration based on an evaluation parameter.

FIG. 46 is a flowchart representative of example machine readable instructions and/or example operations that may be executed by example processor circuitry to implement the example composable machine learning system configurator of FIGS. 34, 35, and/or 36 to deploy a compute node to execute a machine-learning workload.

FIG. 47 is a block diagram of an example processing platform including processor circuitry structured to execute the example machine readable instructions and/or the example operations of FIGS. 41-46 to implement the example composable machine learning system configurator of FIGS. 34, 35, and/or 36.

FIG. 48 is a block diagram of an example implementation of the processor circuitry of FIG. 16, FIG. 21, FIG. 26, FIG. 33, and/or FIG. 47

FIG. 49 is a block diagram of another example implementation of the processor circuitry of FIG. 16, FIG. 21, FIG. 26, FIG. 33, and/or FIG. 47.

FIG. 50 is a block diagram of an example software distribution platform (e.g., one or more servers) to distribute software (e.g., software corresponding to the example machine readable instructions described herein) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” and “substantially simultaneously” refers to occurrence in a near instantaneous manner recognizing there may be real world delays for computing time, transmission, etc. Thus, unless otherwise specified, “substantially real time” and “substantially simultaneously” refer to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system (e.g., a computing system having one or more heterogenous processing unit(s)) including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry best suited to execute the computing task(s).

Computer components, such components that include processors, including heterogeneous processors, and/or other computer components may use firmware for booting, initialization, and/or operation. It is desirable to provide computer components and computers with multiple processing capabilities, such as graphics and/or artificial intelligence. It is also desirable to reduce the bill of materials (BoM) and/or cost of such computing systems. Apparatus, articles of manufacture, and methods are disclosed that facilitate sharing of resources among processors, such as CPUs, GPUs, AI chips, FPGAs, ASICs, microcontrollers (e.g., embedded microcontrollers), etc. Identifying the common and/or sharable resources among CPU and other processors in a heterogeneous processor platform (e.g., a platform including a CPU and discrete graphics) may reduce dedicated hardware usage at the platform, which may help to reduce BoM cost. Disclosed apparatus, articles of manufacture, and methods disclosed herein improve efficiency such as by reusing firmware and/or software (e.g., using a OneAPI library).

Some cloud Service Providers (CSPs) are evolving their hardware platforms to disaggregated elements consisting of general-purpose processors, heterogeneous accelerators and purpose-built vertically integrated Infrastructure Processing Units (IPUs), XPUs, DPUs, etc. Some resource management systems (RMS) (e.g., INTEL® RDT) operate on the realm of a CPU as the control point and managing server node level platform resources pivoted around the CPU. Such approaches may not be scalable or even applicable to IPU-hosted microservices-based infrastructure wherein the IPU become the control point. IPU-based systems are disrupting the way Data Center Resource Management systems operate (e.g., moving away from the CPU as the control point to disaggregated heterogenous self-manageable smart accelerators).

Apparatus, articles of manufacture, and methods disclosed herein facilitate the implementation of IPU resource management systems (IPURMS) that provide distributed services. In some examples, the proposed IPURMS provides decentralized peer-to-peer IPU resource negotiation and management without CPU centric involvement towards low latency micro-services. In some examples, the proposed IPURMS provides application aware resource management wherein IPUs can dynamically renegotiate RMS service level agreements (SLAs) for a variety of micro-services at run-time. In some examples, the proposed IPURMS facilitate IPUs P2P negotiations and resource management tracked via a decentralized distributed public ledger like blockchain with revocation capabilities to track/record telemetry with auditability. In some examples, the proposed IPURMS includes an IPU divided into two portions, namely i) data plane, and ii) control plane. The control plane handles resource allocation, monitoring and policy enforcement, and the data plane handles the data flow between IPUs and the logical units associated with the IPU.

A Deep Neural Network (DNN) Library (e.g., a oneAPI Deep Neural Network (oneDNN)) provides compute primitives to facilitate improved Deep Learning Performance on CPUs and GPUs with a uniform/same API developed for CPUs, GPUs, etc. or any combination. Existing DNN libraries detect underlying target hardware capabilities (e.g., INTEL® Deep Learning Boost technology) to accelerate inference/training performance. For example, oneDNN may utilize Just-in-Time (JIT) code generation and tries to choose instruction set architecture (ISA) or mix of ISA based on detected target hardware features. Even though this abstraction provides the capabilities to take advantage of the underlying hardware capability presents challenges. Apparatus, articles of manufacture, and methods disclosed herein provide a dynamic negotiable deep learning neural network library that facilitates a configurable and negotiable interface for application frameworks to specify SLA to configure JIT code generation params at run-time. Such systems may be policy configurable with or without platform Trusted Execution Environment (TEE) that can help to dynamically manage the Kernel in terms power, performance, energy efficiency, optimization in addition to pure capabilities of the hardware. Apparatus, articles of manufacture, and methods disclosed herein filter an implementation set of parameters to identify a candidate set based on application SLA and platform information. A corresponding JIT kernel may be dynamically generated for each from the candidate set. Apparatus, articles of manufacture, and methods disclosed herein may dry run the kernels one by one, pick out the one with best performance (e.g., Power/Energy Efficiency, TCO advantage, etc.), and cache it for later usage.

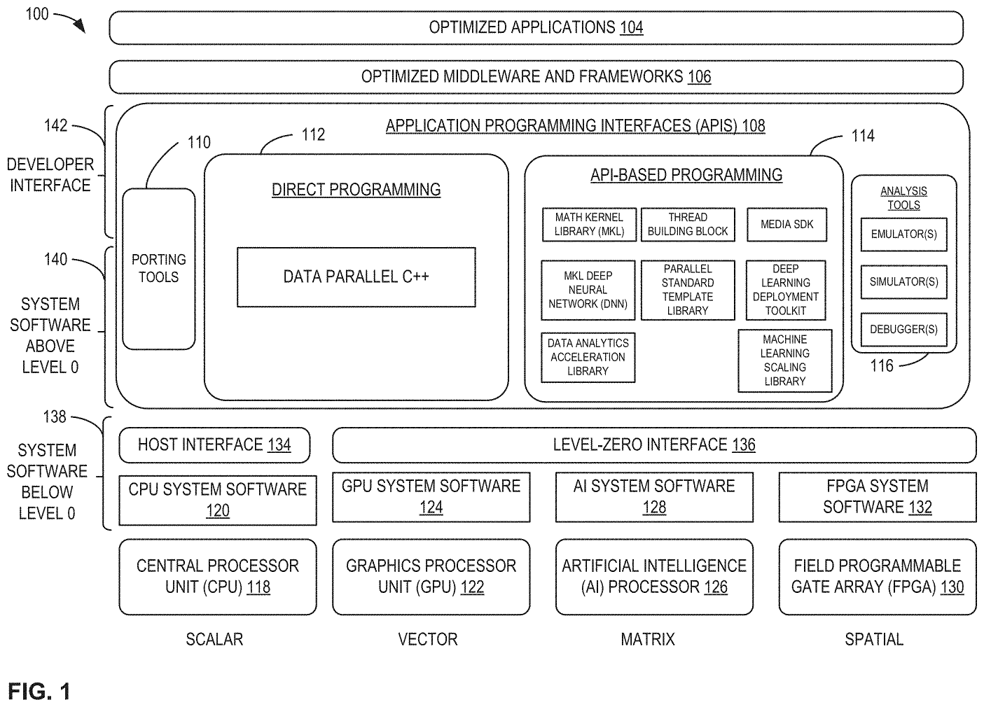

FIG. 1 is a block diagram of an example architecture 100 includes example optimized applications 104, example optimized middleware and frameworks 106, and example application programming interfaces (APIs) 108. In some examples, the optimized applications 104 can be implemented by applications (e.g., software applications, web- or browser-based applications, etc.) that are customized, tailored, and/or otherwise optimized to effectuate the identification and/or generation of a composable ML compute node. For example, the optimized applications 104 can be accessed, utilized, etc., by a developer (e.g., a software developer, a researcher, etc.), Information Technology (IT) personnel, etc. In some such examples, the optimized applications 104 can be accessed, utilized, etc., to co-design a hardware/software (HW/SW) solution for a technical problem that can benefit from AI/ML techniques. In some examples, the optimized middleware and frameworks 106 can be implemented by middleware and frameworks that are customized, tailored, and/or otherwise optimized to effectuate the identification and/or generation of a composable ML compute node. For example, the optimized middleware and frameworks 106 can implement an interface (e.g., communication, connectivity, etc.) between the optimized applications 104 and the APIs 108.

The APIs 108 of the illustrated example can be invoked to program, develop, and/or otherwise generate an AI/ML application by at least one of direct programming or API-based programming. The APIs 108 of the illustrated example include example porting tools 110, example direct programming APIs 112, example API-based programming APIs 114, and example analysis tools 116.

In some examples, the porting tools 110 can be implemented by software (e.g., a software application) that can adapt a program for the purpose of achieving some form of execution in a first computing or electronic environment that is different from a second computing or electronic environment for which the program was originally designed. For example, the porting tools 110 can convert and/or otherwise adapt a first program developed for a first type of hardware, operating system (OS), library, etc., into a second program for a second type of hardware, OS, library, etc.

In some examples, the direct programming APIs 112 can be invoked to effectuate direct programming tasks, which may include developing and/or compiling data parallel C++ applications. In some examples, the API-based programming APIs 114 can be invoked to effectuate API-based programming, which may include developing and/or compiling applications that call (or invoke, instantiate, etc.) a Math Kernel Library (MKL), an MKL Deep Neural Network (DNN) library, a data analytics acceleration library, a thread building block library, a parallel standard template library, a media software development kit (SDK), a deep learning deployment toolkit, a machine learning scaling library, etc., and/or any combination(s) thereof.

In some examples, the analysis tools 116 can be called, instantiated, and/or otherwise invoked to analyze hardware, software, and/or configuration(s) thereof of a composable ML compute node. For example, the analysis tools 116 can instantiate emulator(s) to emulate all of the hardware and/or software features of the composable ML compute node to generate and/or otherwise output one or more evaluation parameters. In some such examples, the evaluation parameters can include parameters representative and/or otherwise indicative of accuracy, latency, a number of cycles to complete a workload, or throughput of the composable ML compute node. In some examples, the evaluation parameters can include parameters representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof. For example, the analysis tools 116 can execute an emulator based on the composable ML compute node. In some such examples, the analysis tools 116 can execute the emulator to determine a throughput of the composable ML compute node when the composable ML compute node executes a particular AI/ML model having a particular configuration.

In some examples, the analysis tools 116 can instantiate simulator(s) to simulate the behavior, the configuration, etc., of a composable ML compute node to generate and/or otherwise output one or more evaluation parameters. For example, the analysis tools 116 can execute a model (e.g., a simulation model, an AI/ML model, etc.) based on the composable ML compute node. In some such examples, the analysis tools 116 can execute the model to estimate, predict, and/or otherwise determine a throughput of the composable ML compute node when the composable ML compute node executes a particular AI/ML model having a particular configuration.

The architecture 100 of the illustrated example includes different types of hardware and/or software from which a composable ML compute node can be generated. In the illustrated example, the architecture 100 includes interfaces and target system software for scalar, vector, matrix, and spatial hardware. Additionally and/or alternatively, any other type of hardware may be used. In this example, the scalar hardware is implemented by an example CPU 118 and example CPU system software 120. For example, the CPU system software 120 can include instructions corresponding to a CPU Instruction Set Architecture (ISA). In this example, the vector hardware is implemented by an example GPU 122 and example GPU system software 124. For example, the GPU system software 124 can include kernels, portion(s) of code, etc., such as kernels, compute kernels, and/or shaders. In some examples, the kernels, the portion(s) of code), etc., can be represented in a high-level programming language such as, for example, a High-Level Shader Language (HLSL), OpenCL, etc.

In this example, the matrix hardware is implemented by an example AI processor 126 and example AI system software 128. For example, the AI system software 128 can include one or more AI/ML algorithms, models, etc., such as neural networks (e.g., convolution neural networks (CNNs), deep neural networks (DNNs), recurrent neural networks (RNNs), etc.), Linear Regression models, Logistic Regression Models, Decision Tree Models, Learning Vector Quantization Models, etc., and/or combination(s) thereof. In this example, the spatial hardware is implemented by an example FPGA 130 and example FPGA system software 132. For example, the FPGA system software 132 can include kernels, portion(s) of code, etc., based on a hardware description language (HDL) such as Verilog.

In the illustrated example, the CPU system software 120, the GPU system software 124, the AI system software 128, the FGPA system software 132, the host interface 134, and/or the level-zero interface 136 can correspond to and/or otherwise implement example system software below level zero 138. For example, system software below level zero 138 can correspond to and/or otherwise implement low-level direct-to-metal interfaces that are tailored to hardware, such as the CPU 118, the GPU 122, etc.

In the illustrated example, the APIs 108 can implement example system software above level zero 140 and an example developer interface 142. For example, a developer, a user, etc., can access and/or otherwise utilize the architecture 100 by way of the APIs 108. In some examples, a developer, a user, etc., can access and/or otherwise utilize system software at a higher level than low-level direct-to-metal interfaces by way of the APIs 108. In some examples, a developer, a user, etc., can access and/or otherwise utilize the system software below level zero 138 via the host interface 134 and/or the level-zero interface 136.

The architecture 100 is well-suited for facilitating efficient utilization of the hardware such as the CPU 118, the GPU 122, etc. by way of the APIs 108. For example, APIs may be added to the APIs 108 to facilitate and/or improve various processes. For example, disclosed example include APIs directed a set of library functions that may communicate with XPU hardware (e.g., to facilitate the sharing of firmware and software resources among processing units). In some disclosed examples, the APIs 108 may includes platform components to support machine learning (e.g., a dynamic negotiable deep neural network platform). For example, the machine learning components of the APIs 108 may operate to improve the targeting of hardware capabilities to improve performance (e.g., improve deep learning inference performance). The disclosed API improvements (and other improvements disclosed herein) may be implemented separately and/or in combination. For example, the APIs 108 may include the APIs directed a set of library functions that may communicate with XPU hardware to facilitate the sharing of firmware and software resources among processing units and the APIs 108 may include the APIs to improve the targeting of hardware capabilities to improve deep learning inference performance. For example, the various improvements, when combined, may provide additive system performance increases and reduced BOM costs.

### Symbiotic Boot

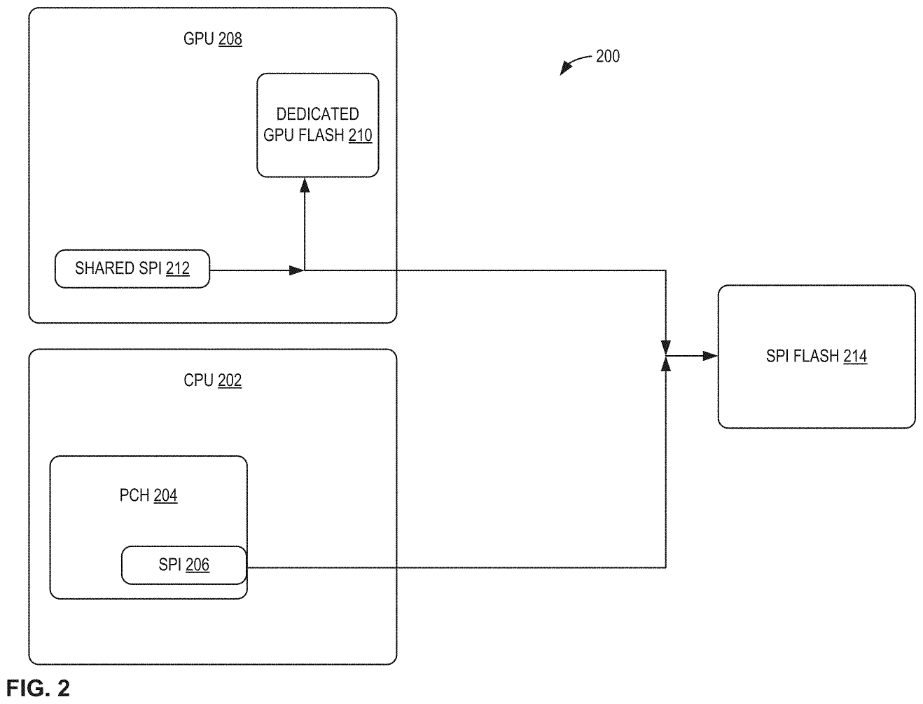

FIG. 2 is a block diagram of an example architecture 200 for sharing memory between two processing units (e.g., a CPU and a GPU). For example, the architecture 200 may be utilized in conjunction with the architecture 100 of FIG. 1 or any other computer architecture including multiple processing units. The example architecture 200 of FIG. 2 includes an example CPU 202, which includes an example platform controller hub 204 and an example serial peripheral interface (SPI) 206, an example GPU 208, which includes an example dedicated GPU flash 210 and an example shared SPI 212, and an example SPI flash 214. According to the illustrated example, the architecture 200 facilitates the CPU 202 and the GPU 208 sharing the SPI flash 214.

The example CPU 202 is a central processing unit for a computing system. Alternatively, the CPU 202 may be any other type of processing unit. The example CPU 292 includes the example platform control hub (PCH) 204, which comprises circuitry, software, and/or firmware to manage data paths and support functions of the CPU 202. Alternatively, any other type of control circuitry, chipset, software, and/or firmware may be utilized. The example PCH 204 may include a number of interfaces including, according to the illustrated example, the SPI 206. The example SPI 206 interfaces the PCH 204 and the CPU 202 with the SPI flash 214 to facilitate initialization and booting of the CPU 202 and the architecture 200 as a whole.

The example GPU 208 is a graphics processing unit system-on-chip (SoC) soldered to a motherboard on which the CPU 202 is installed (e.g., a motherboard (MB) down solution). Alternatively, the GPU 208 may be any other type of processing unit (e.g., an AI processing unit, XPU, etc.) coupled to the architecture 200 in any other manner (e.g., a discrete PCIE based add-in-card (AIC) attached to PCIE slot in client device, an external graphics processing unit connected via a cable/port (e.g., a Thunderbolt port) of the architecture 200, etc.).

While a typical GPU would have its own SPI memory (e.g., 8 MB flash memory) storing instructions for handling a boot process associated with the GPU in addition to the SPI memory of the CPU (e.g., 32 MB flash memory), the example GPU 208 includes a dedicated GPU flash 210 and a shared SPI 212 that facilitates sharing the SPI flash 214 with the CPU 202. According to the illustrated example, an integrated firmware image (IFWI) of the GPU is stored in the shared SPU flash 214.

The example SPI flash 214 is a SPINOR flash memory device that includes a SPI interface for access. The SPI flash 214 stores IFWI information for initialization and boot of the CPU 202 and the GPU 208. Alternatively, any other type of flash memory may be utilized

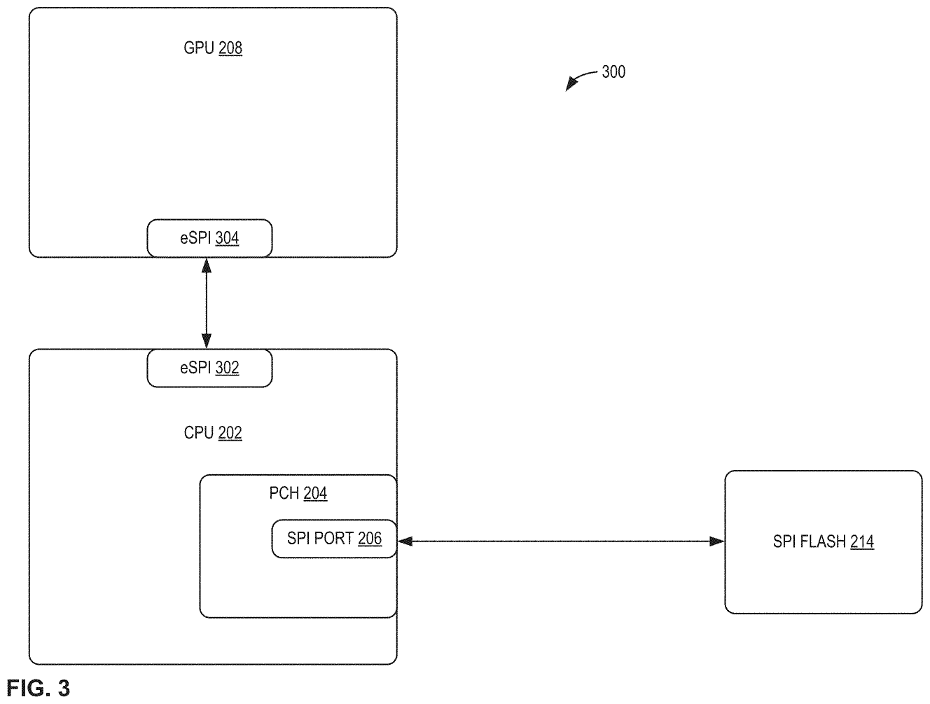

FIG. 3 is a block diagram of an example approach for sharing the SPI flash 214 using attached flash sharing. According to the illustrated example, the example GPU 208 is communicatively coupled to the example CPU 202 via an example first enhanced SPI (eSPI) interface 302 of the CPU 202 in communication with an example second eSPI interface 304 of the GPU 208. Thus, the GPU 208 can access the SPI flash 214 through the Flash Access Channel supported by the first eSPI interface 302 and the second eSPI interface 304 while the PCH 204 of the CPU 202 accesses the SPI flash 214 via the SPI 206.

Run-time access to the SPI flash 214 through the eSPI interface established by the first eSPI 302 and the second eSPI 304 will go through the eSPI primary (CPU 202), which then routes the cycle to the Flash Access block of the CPU 202 before the cycle is forwarded to the PCH (e.g., a SPI flash controller of the PCH 204) of the CPU 202. Then the SPI flash controller will perform the access to the SPI flash 214 on behalf of eSPI secondary (GPU 208). As the flash access addresses used by the eSPI secondary devices (e.g., GPU 208) are physical flash linear addresses, which covers the entire flash addressing space. However, the SPI flash controller may impose access restrictions of certain regions of the SPI flash 214 to ensure security.

The proposed hardware changes to support sharing the SPI flash 214 may be coupled with updates to the layout of the SPI flash 214 (e.g., an updated master section descriptor) to accommodate a dedicated secondary device firmware mapped into the SPI flash 214. A descriptor change may facilitate injecting a secondary device firmware region into an IFWI layout on the SPI flash 214.

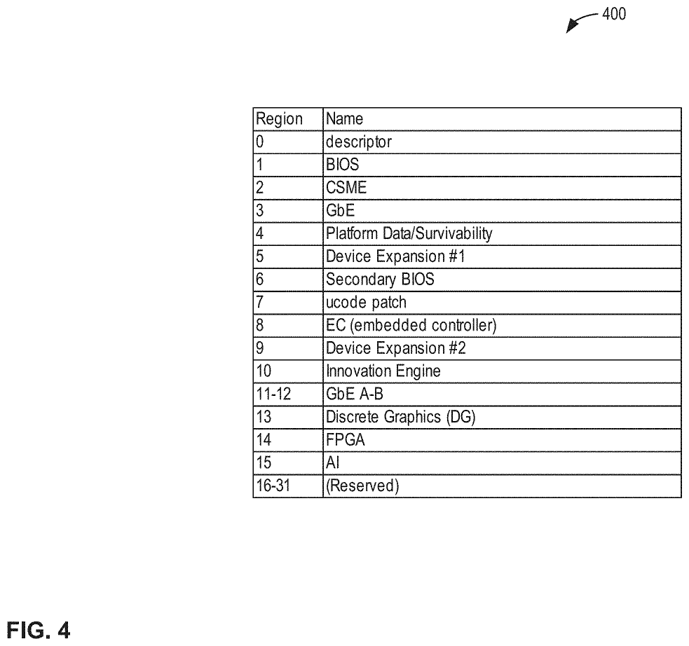

FIG. 4 illustrates an example updated IFWI layout 400 for the SPI flash 214. As illustrated in FIG. 4, the IFWI layout 400 includes a dedicated firmware region for each XPU device. For example, the example IFWI layout 400 includes Region 13 for storing firmware for initializing the GPU (e.g., country specific code (CSC) firmware, firmware patches, and redundant images), Region 14 for storing firmware for a field programmable gate array (FPGA), and Region 15 for storing firmware for an AI processing unit. During Boot, the basic input output system (BIOS) (e.g., a system boot software) is accessed from the SPI flash to before booting and initialization. Once a hardware reset (e.g., RESET #) is issued to the GPU 208, the GPU 208 will bring up ROM to start fetching a firmware image from the SPI flash 214 to read a descriptor to know a dedicated flash range mapped for initializing the GPU 208.

The Regions of the SPI flash 214 may be defined for read or write access by settings a protection parameter in the flash descriptor. For example, Region 0 may be read only for the CPU and not accessible for the GPU, Region 1 may be read and written by the CPU (e.g., prior to end of POST (EOP)) and not accessible for the GPU, Region 13 may be read and written by the CPU (e.g., for firmware updates) and the GPU.

While an example manner of implementing components of the architecture 100 of FIG. 1 is illustrated in FIGS. 2 and 3, one or more of the elements, processes, and/or devices illustrated in FIGS. 2 and/or 3 may be combined, divided, re-arranged, omitted, eliminated, and/or implemented in any other way. Further, the example CPU 202, the example PCH 204, the example SPI 206, the example GPU 208, the example shared SPI 212, the example first eSPI 302, the example second eSPI 304, and/or more generally the architectures 200 and/or 300 of FIGS. 2 and/or 3 may be implemented by hardware alone or by hardware in combination with software and/or firmware. Thus, for example, any of the example CPU 202, the example PCH 204, the example SPI 206, the example GPU 208, the example shared SPI 212, the example first eSPI 302, the example second eSPI 304, and/or more generally the architectures 200 and/or 300 of FIGS. 2 and/or 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example architecture 100 of FIG. 1 may include one or more elements, processes, and/or devices in addition to, or instead of, those illustrated in FIG. 2 and FIG. 3, and/or may include more than one of any or all of the illustrated elements, processes and devices.

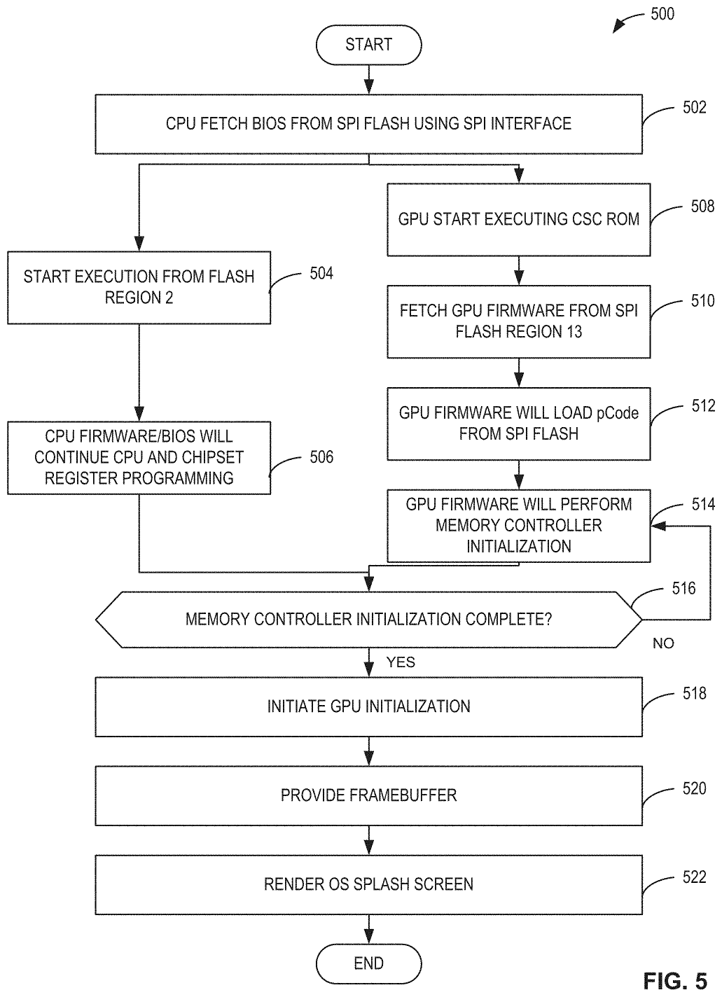

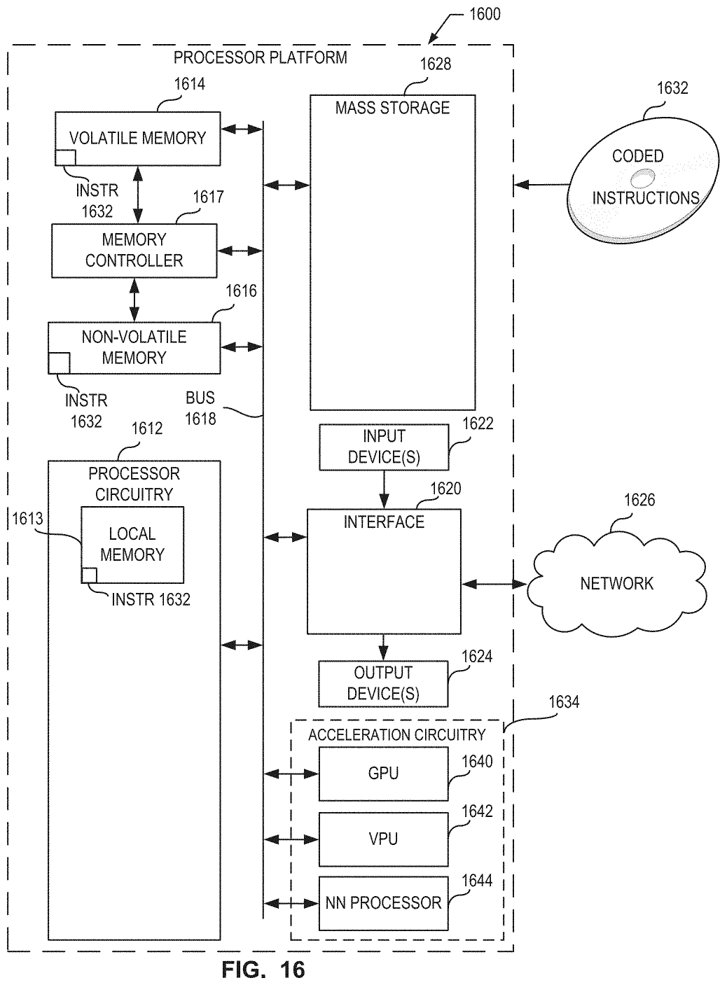

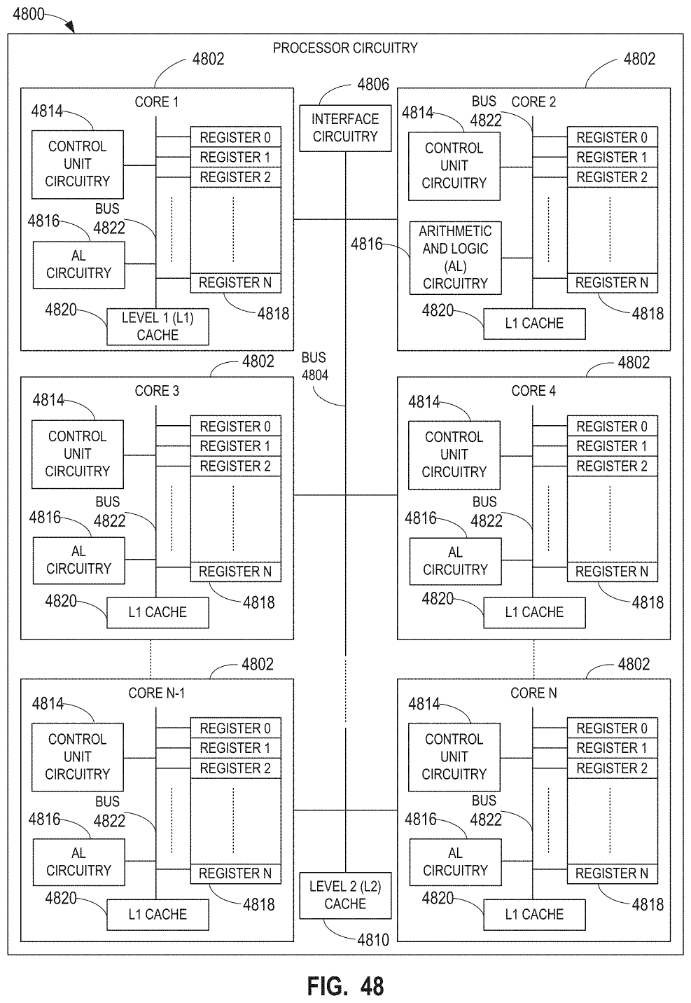

A flowchart representative of example hardware logic circuitry, machine readable instructions, hardware implemented state machines, and/or any combination thereof for implementing the architecture 200 of FIG. 2 and/or the example architecture 300 of FIG. 3 is shown in FIG. 5. The machine readable instructions may be one or more executable programs or portion(s) of an executable program for execution by processor circuitry, such as the processor circuitry 1612 shown in the example processor platform 1600 discussed below in connection with FIG. 16 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 5, many other methods of implementing the example architectures 200 and/or 300 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to perform a firmware boot of a system where shared access flash has been implemented between two processing units (e.g., the CPU 202 and the GPU 208).

The machine readable instructions and/or the operations 500 of FIG. 5 begin at block 502, at which the CPU 202 fetches BIOS from the SPI flash 214 via the SPI 206 (block 502). According to the illustrated example, the BIOS begins execution from Region 2 according to the IFWI layout 400 of FIG. 4 (block 504). The CPU will continue programming of the CPU 202 and chipset registers (block 506).

According to the illustrated example, in parallel with the BIOS execution, the GPU 208 receives a reset (e.g., RESET #) and starts executing CSC ROM (block 508). The example GPU 208 fetches the GPU firmware from the SPI flash 214 (e.g., Region 13) (block 510). The example GPU firmware will authenticate and load pCode patch from the SPI flash 214 (block 512). The GPI firmware executed by the GPU 208 will perform memory controller initialization (block 514). While initialization of the GPU 208 is illustrated in blocks 508-514, the process may additionally or alternatively perform initialization of any other processing units (e.g., initialization of another processing unit may begin after block 514).

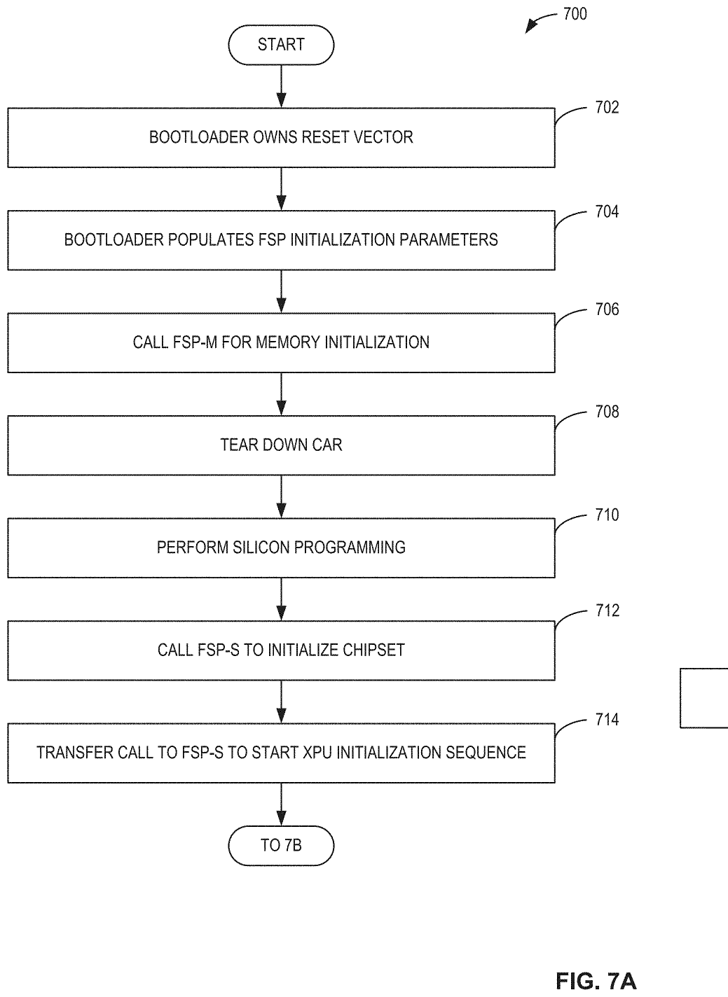

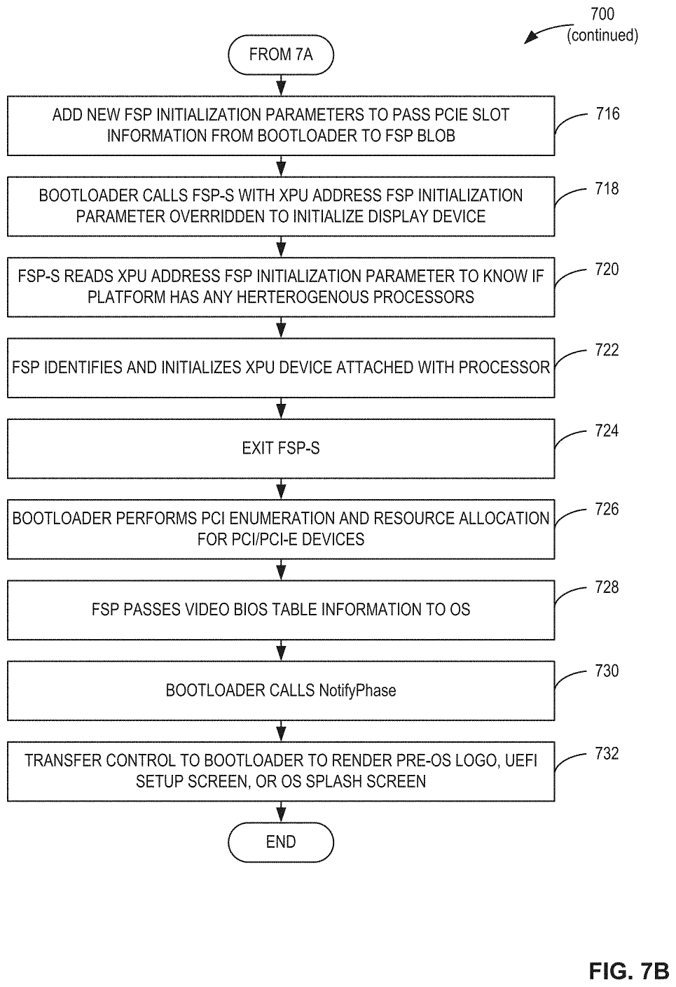

The GPU 208 will determine if memory controller initialization is complete (block 516). When memory controller initialization has completed, the BIOS will initiate GPU initialization (block 518). For example, an example process for performing GPU initialization is described in conjunction with FIGS. 7A and 7B. Once GPU initialization has been performed, any output device (e.g., high-definition multimedia interface (HDMI) or display port (DP)) over the GPU (e.g., Discrete Graphics) will be ready with resolution and allocated framebuffer for further display related usage (block 520). The CPU executing the BIOS or operating system (OS) loader will render the pre-OS splash screen using the framebuffer as the OS is booting (block 522). The process 500 of FIG. 5 is then completed.

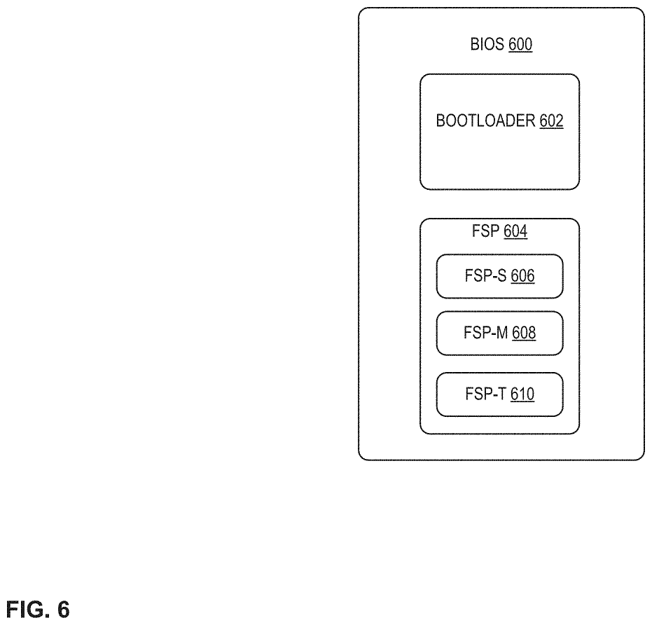

FIG. 6 is a block diagram of an example layout of BIOS 600 (e.g., the BIOS stored in Region 2 of the IFWI layout 400 of FIG. 4). The example BIOS 600 includes a bootloader 602 and a silicon initialization code 604 (e.g., referred to as firmware support packages (FSP) herein). For example, the silicon initialization code may be the INTEL® FSP including support for shared SPI flash. The example FSP 604 includes an example FSP silicon (FSP-S) 606, an example FSP memory (FSP-M) 608, and FSP Temp RAM (FSP-T) 610.

Modern System BIOS typically consists of 2 key elements as SoC vendor provided silicon initialization code in a binary format (e.g., the INTEL® Firmware Support Package (FSP)), which is getting consumed by various open and/or closed source bootloader implementations (e.g., tianocore.org, coreboot.org, slim bootloader, etc.) to distinguish as Production BIOS for original design manufacturing (ODM)/original equipment manufacturer (OEM) platform. But while working on platform with multiple heterogenous processors where every other heterogenous processor has its own SPI flash consisting of dedicated firmware blobs which are executed outside a silicon initialization code (e.g., FSP) boundary might poses redundancies. Having dedicated firmware blobs for each heterogenous processor would necessitate a discrete hardware block, which results in higher BoM. Furthermore, allowing DG initialization code that runs at bootloader context wouldn't qualified as SoC verified boot and executing Option ROM for each processor results in higher boot times due to dependency over PCI enumeration and dynamic resource allocation before initializing the controller or device.

According to the illustrated example, the FSP 604 is extended to bring all XPU initialization within the scope of the FSP to create a hardware abstraction layer that ensures all SoC vendor recommended chipset programming is performing using a unified block. By utilizing the FSP 604 and its components for initialization of processing units (e.g., the GPU), dedicated Option ROM may be eliminated reducing redundant components

A flowchart representative of example hardware logic circuitry, machine readable instructions, hardware implemented state machines, and/or any combination thereof for implementing unified firmware for the example architecture 200 and/or the example architecture 300 of FIG. 3 is shown in FIGS. 7A-7B. The machine readable instructions may be one or more executable programs or portion(s) of an executable program for execution by processor circuitry, such as the processor circuitry 1612 shown in the example processor platform 1600 discussed below in connection with FIG. 16 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 7A-7B, many other methods of implementing the example architectures 200 and/or 300 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIGS. 7A and 7B are a flowchart representative of example machine readable instructions and/or example operations 700 that may be executed and/or instantiated by processor circuitry to perform unified initialization of processing units using silicon initialization code (FSP 604).

The machine readable instructions and/or the operations 700 of FIGS. 7A-7B begin at block 702, at which the bootloader 602 owns the reset vector (block 702). For example, the bootloader 602 contains the real mode reset vector handler code. In some examples, the bootloader 602 can call FSP-T 610 for cache as RAM (CAR) setup and initializing a stack. The CPU 202 executing the bootloader 602 populates FSP initialization parameters (block 704). For example, the bootloader 602 may populate updateable product data (UPD).

The example bootloader 602 calls FSP-M 608 for memory initialization (block 706). On exit from FSP-M 608, the bootloader tears down CAR (block 708). The bootloader 602 performs silicon programming (block 710). For example, the silicon programming may include filling UPDs for FSP-S 606). The bootloader 602 then calls FSP-S 606 to initialize a chipset (block 712).

According to the illustrated example, the heterogeneous processors (e.g., the GPU 208) are soldered down on motherboard using dedicated PCI-E slots and, thus, the bootloader 602 does not need to perform PCI enumeration. Instead, the bootloader 602 may rely on mainboard-specific configuration information to provide such PCI-E slot information to the FSP 604. Alternatively, the bootloader 602 may perform PCI enumeration to identify the hardware.

The bootloader then transfers the call to FSP-S 606 to start XPU initialization sequence (block 714). For example, control reaches an XPU initialization sequence inside the FSP-S 606).

Continuing to FIG. 7B, the FSP 604 adds new FSP initialization parameters (e.g., UPDs) to pass PCIE slot information (e.g., information about heterogenous processors attached via PCIE) from the bootloader 602 to an FSP blob (block 716). For example, UPDs may include IAXPUAddress, which is an array of 32-bit UPD parameters filled by bootloader to tell the FSP 604 about an address format of the XPU being attached with PCIE slot in form of bus, device, and function. For example, a default value would be 0x0, which identifies as invalid address. The format of IAXPUAddress may be: Bus<<16|Device<<11|Function<<8|Offset (assume 0). For example, for the Bus number as 0xFE and device/function as 0, IAdGPUAddress UPD value would be 0x00FE0000. Another UPD may be XPUConfigPtr, which is a 32-bit UPD parameter filled by the bootloader 602 to tell the FSP 604 about a location of additional configuration data such as Video BIOS Table (VBT) for the GPU 208. For example, a default value would be NULL, which identifies an invalid address.

Example UPD variable definitions inside the FSP 604 may include:

```
  # !BSF NAME:{XPU PCI-E address format for FSP
usage } TYPE:{EditNum, HEX, (0x00,0xFFFFFFFF)}
  # !BSF HELP:{ bootloader to tell FSP about address
format of attached PCIE slot for FSP usage, Default value would be
0, identify as no device attached.}
  gPlatformFspPkgTokenSpaceGuid. IAXPUAddress | * |
0x20 | {0x00FE0000, 0x00, 0x00}
  # !BSF NAME:{XPU Configuration Ptr}
  # !BSF TYPE:{EditNum, HEX, (0x0,0xFFFFFFFF)}
  # !BSF HELP:{Points to configuration data file like
VBT}
  gPlatformFspPkgTokenSpaceGuid.XPUConfigPtr | * |
0x04 | 0x00000000
```

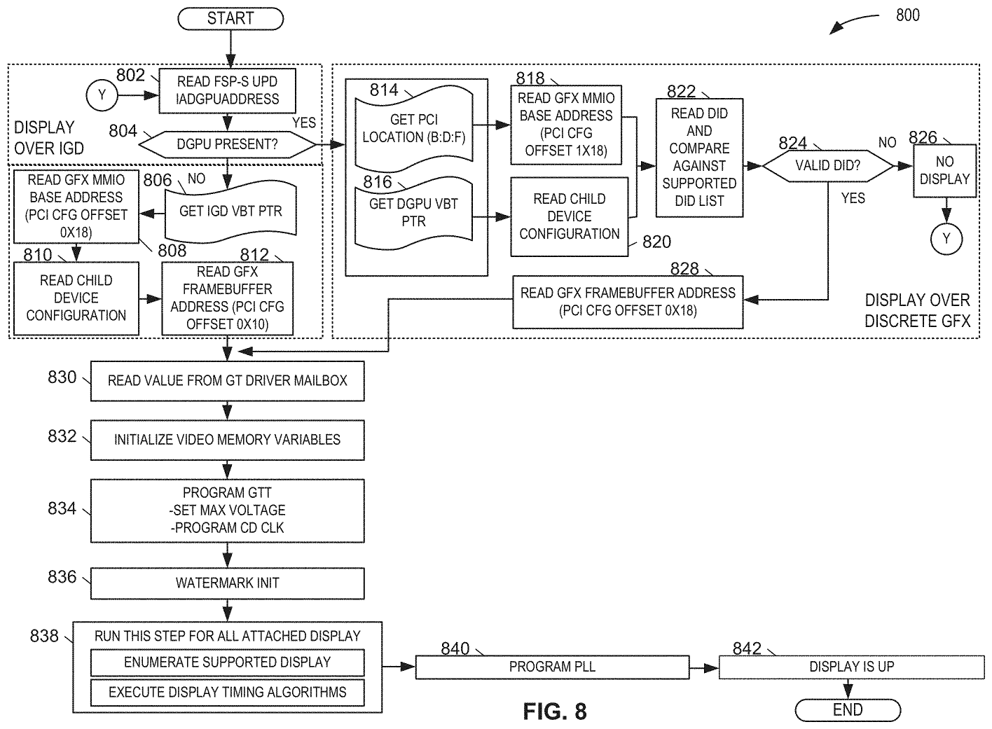

Returning to the process 700, the example bootloader 602 calls FSP-S 606 with XPU address FSP initialization parameter overridden to initialize the display device (e.g., over discrete DGPU) (block 718). The example FSP-S 606 reads the XPU address FSP initialization parameter to know if the platform has any heterogenous processors attached (block 720). For example, if “IAXPUAddress” UPD value>0, Dash-G is present, then Get B:D: F information from UPD and read XPU data configuration pointer to know the configuration table presence such as VBT. The FSP 604 identifies and initializes any XPU devices attached with the processor (block 722). For example, the FSP 604 may identify the type of XPU that is associate with a PCIE port and perform the respective call in order to initialize the device attached with processor (e.g., display attached with GPU). An example detailed process is illustrated in FIG. 8.

Control exists FSP-S 606 operation (block 724). Upon the exist, the display will be initialized for a device attached with the GPU (e.g., the DGPU). The example bootloader 602 performs PCI enumeration and resource allocation for PCI/PCI-E devices (block 726). For example, except for Dash-G device, the resource allocation may be based on looking at Base Address Registers (BAR) that are already implemented and mmio/io address space that is enabled. The FSP 604 then passes the VBT information to the OS (block 728). For example, the FSP 604 may create DGPU GFX ACPI opregion to pass the VBT information for the GPU driver to the OS.

The bootloader 602 then calls NotifyPhase (block 730). For example, the bootloader 602 may call NotifyPhase before handing over to payload. Control is transferred to the bootloader 602 to render pre-OS logo, UEFI setup screen, or OS splash screen (block 732). The process 700 then ends as the OS boots.

As FSP is designated to perform the initialization of XPU devices, the initialization sequence may be divided into two parts: 1. Static DG initialization process as part of boot services inside the FSP 604 and 2. Create a oneAPI library function for accessing XPU hardware resources: A set of library functions for communicating with XPU hardware is available as part of an FSP runtime service so that different OS stacks do not need dedicated OS drivers for communicating with XPU hardware. For example, the APIs 108 of FIG. 1 may include the oneAPI library for accessing XPU hardware resources.

FIG. 8 is a flowchart illustrating an example detailed Unified FSP initialization flow with integrated graphics device (IGD) and GPU.

The machine readable instructions and/or the operations 800 of FIG. 8 begin at block 802, at which the FSP-S reads the UPD IADGpuAddress. The FSP-S determines if a discrete graphic processing unit (DGPU) is present (block 804). If a DGPU is not present, initialization of an integrated graphics processing unit (IGPU) is performed by getting an IGD VBT PTR (block 806), reading a RGX MMIO base address (block 808), reading a child device configuration (block 810), and reading a GFX framebuffer address (block 812). Control then proceeds to block 830, which is described below.

If the FSP-S determines that a DGPU is present (block 804), the FSP-S performs initialization of the DGPU as follows. The FSP-S gets a PCI location (block 814) and gets a DGPU VBT PTR (block 816). The FSP-S reads the GFX MMIO base address (block 818) and reads a child device configuration (block 820). The FSP-S reads a device identifier (DID) and compares it against a supported DID list (block 822). If the DID is not valid (e.g., not supported) (block 824), no display is presented (block 826), and control returns to block 802. If the DID is valid, the FSP-S reads the GFX framebuffer address (block 828) and control proceeds to block 830.

After beginning initialization of the IGD (blocks 806-812) or DGPU (blocks 814-828), the FSP-S reads a value from a GT driver mailbox (block 830). Then the FSP-S initializes video memory variables (block 832) and programs the GTT (e.g., sets max voltage, programs CD CLK, etc.) (block 834). The FSP-S performs watermark initialization (block 836). Then, for reach attached display, the FSP-S enumerates the supported displays and executes display timing algorithms (block 838). Finally, the FSP-S programs the phase locked loops (PLL) (block 840) and the display is then up (block 842). The process of FIG. 8 then ends.

From the foregoing, it will be appreciated that example systems, methods, apparatus, and articles of manufacture have been disclosed for symbiotic boot among heterogenous processors. Disclosed systems, methods, apparatus, and articles of manufacture improve the efficiency of using a computing device by sharing memory resources such as SPI flash to reduce BoM costs and reduce boot times. By moving XPU initialization to the FSP, encapsulation of the XPU silicon initialization protects intellectual property and maintains security of the boot process while allowing for the shared utilization of memory (e.g., memory storing IFWI). Utilizing unified firmware and software modules for heterogenous processor results in smaller footprint and optimized verified boot. The disclosed examples also support a unified firmware flash layout between the CPU and other processing unit to allow having in-field firmware updates (e.g., for a DG motherboard-down solution).

### Infrastructure Processing Unit Resource Director Technology

Apparatus, articles of manufacture, and methods to implement an infrastructure processing unit resource directory technology (IPURMS) are disclosed. The example IPURMS provides decentralized peer-to-peer IPU resource negotiation and management without CPU centric involvement to facilitate low latency micro-services and workloads such as VRAN, etc. In addition, the IPURMS provides application aware resource management wherein IPUs can dynamically renegotiate RMS SLAs for variety of micro-services at run-time. Furthermore, the IPURMS may facilitate IPUs P2P negotiations and resource management that may be tracked via decentralized distributed public ledger like blockchain with revocation capabilities (e.g., revocation management) to track/record telemetry with auditability. In addition, the IPURMS may facilitate an IPU that is divided into two portions, namely i) data plane, and ii) control plane, wherein the control plane handles resource allocation, monitoring and policy enforcement, and the data plane handles the data flow between IPUs and the logical units associated with the IPU.

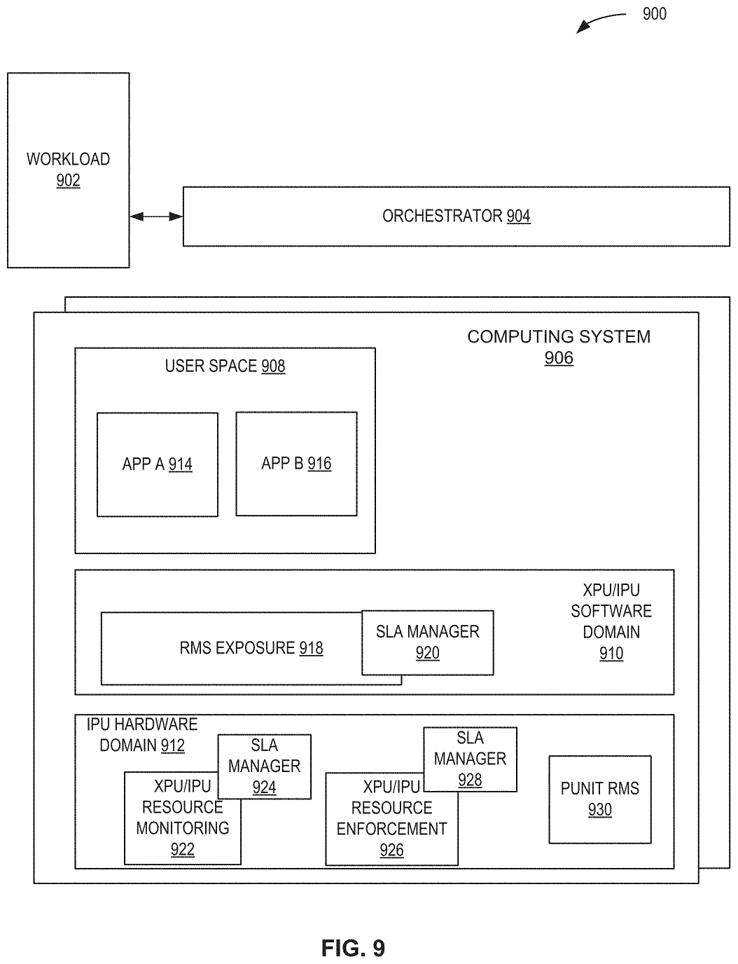

FIG. 9 is a block diagram of an example architecture 900 for IPURMS. According to the illustrated example of FIG. 9, a new workload (or VM) 902 communicates with an example orchestrator 904 to request a system with a specific SLA. The example architecture 900 includes the orchestrator 904, an example user space 908, an example XPU/IPU software domain 908, and an example IPU hardware domain 910.

The example orchestrator 904 is server circuitry that negotiates with existing workloads for placement of the workloads on computing resources based on SLAs. The example orchestrator 904 communicates with one or more computing system(s) 906 to manage the assignment of workloads to computing resources.

The example computing resources 906 are represented by several abstractions including a user space 908, an XPU/IPU software domain 910, and an IPU hardware domain 912. The example user space 908 includes an application A 914 and an application B 916, though any number or type of application may be included. The example user space 908 is monitored by the orchestrator 904.

The example XPU/IPU software domain 910 includes an example RMS exposure 918 that is monitored by an example SLA manager 920. The example RMS exposure 918 facilitates the communication of application level information with the orchestrator 904.

The example IPU hardware domain 912 includes an example XPU/IPU resource monitoring 922 monitored by an example SLA manager 924, an example XPU/IPU resource enforcement 926 monitored by an example SLA manager 928, and a Punit RMS 930.

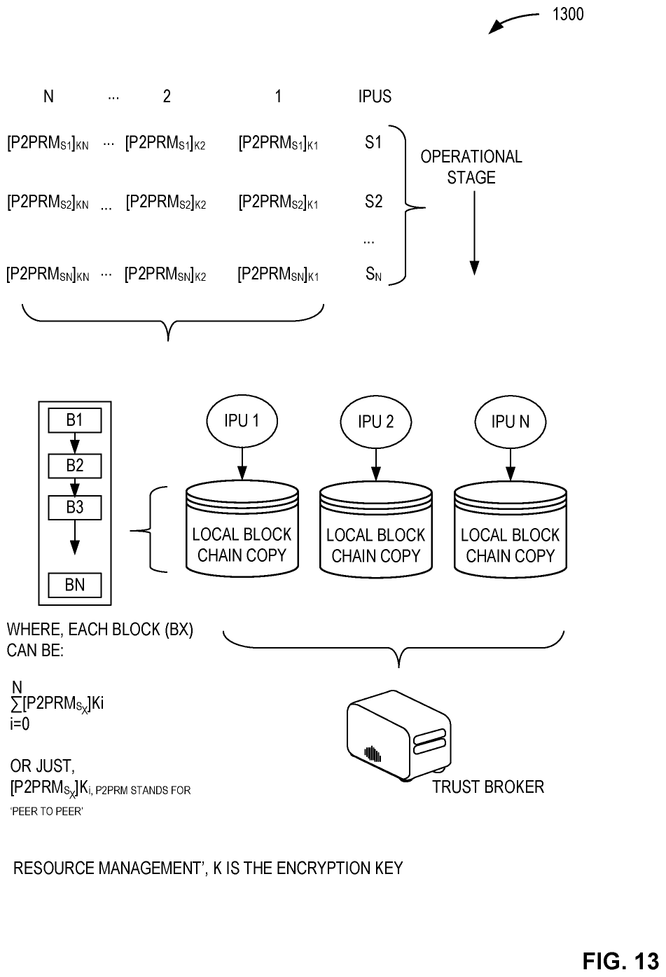

The example XPU/IPU resource monitoring 922 provides resource feedback to the example RMS exposure 918 while the example XPU/IPU resource monitoring 922 and the example XPU/IPU resource enforcement 926 communicate regarding hardware policies. The example RMS exposure 918 communicates QoS hints to the example XPU/IPU resource enforcement 926 and the example XPU/IPU resource enforcement 926 communicates with the Punit RMS 930 regarding QoS hardware features. The example architecture 900 facilitates a transition from CPU-centric, single node resource management to a scalable self-manageable XPU/IPU that can work in peer-to-peer collaboration. Consensus in such collaborative resource management may be accomplished via a centralized trust broker, a decentralized public ledger like block chain as illustrated in FIG. 13, etc.

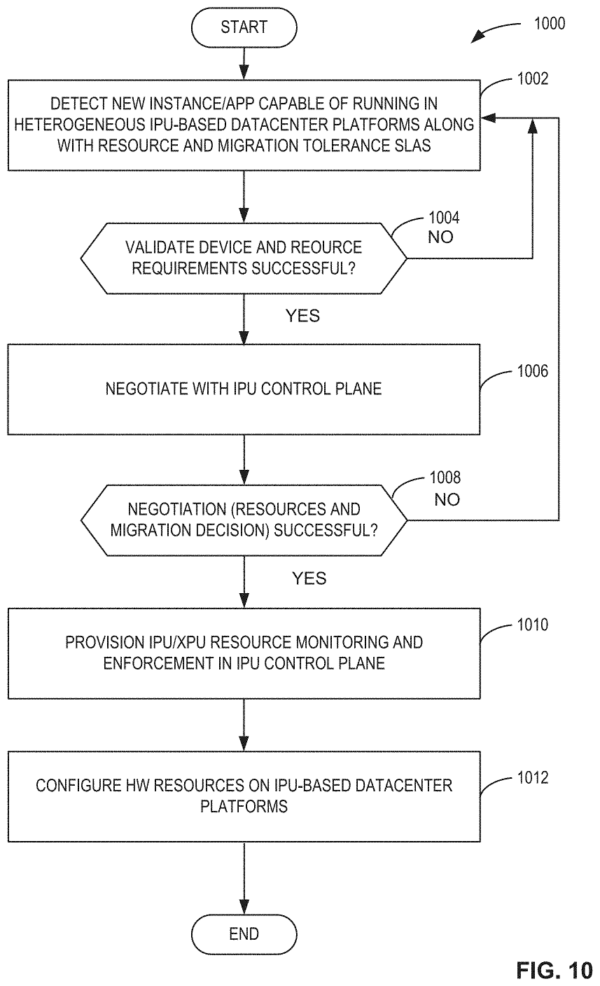

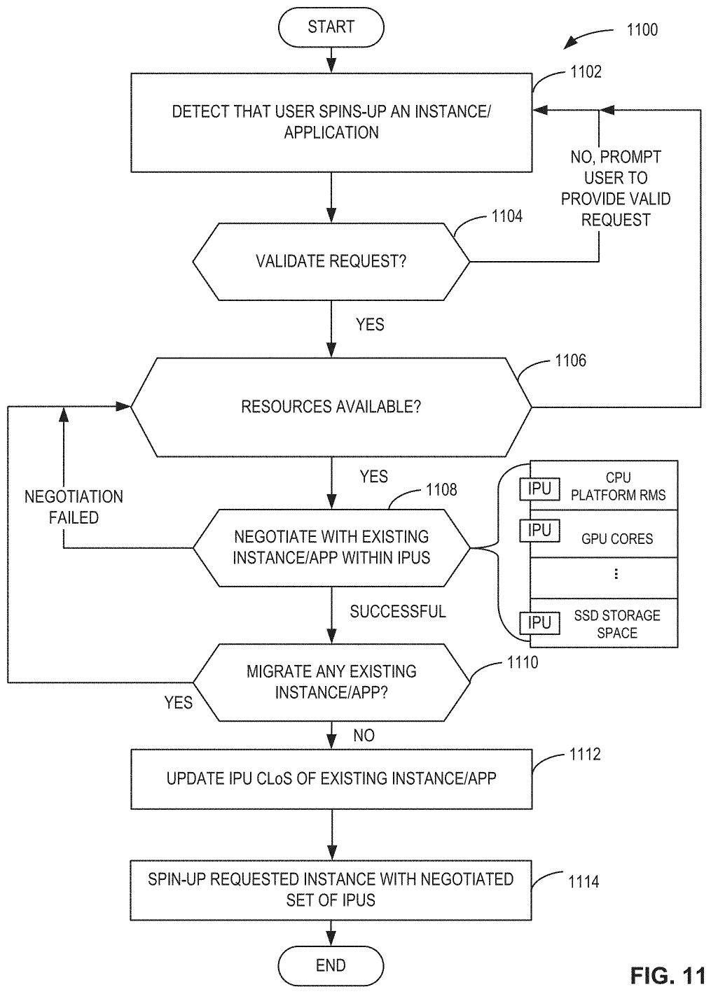

Flowcharts representative of example hardware logic circuitry, machine readable instructions, hardware implemented state machines, and/or any combination thereof for implementing unified firmware for the example architecture 900 is shown in FIG. 10 and FIG. 11. The machine readable instructions may be one or more executable programs or portion(s) of an executable program for execution by processor circuitry, such as the processor circuitry 1612 shown in the example processor platform 1600 discussed below in connection with FIG. 16 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 10 and FIG. 11, many other methods of implementing the example architecture 900 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 10 is a flowchart representative of example machine readable instructions and/or example operations 1000 that may be executed and/or instantiated by processor circuitry to perform configuring using IPURMS.

The machine readable instructions and/or the operations 1000 of FIG. 10 begin at block 1002, at which the example orchestrator 904 detects a new instance/application (e.g., workload 902) capable of running in a heterogenous IPU-based datacenter platform along with resource and migration tolerance SLAs. For example, the resource requirements and tolerance may be established by a user/administrator when creating the new instance/application (e.g., using an SLA template). The orchestrator 904 determines if validation of the device and resource requirements is successful (block 1004). For example, the resource requirements may be analyzed to determine if they are feasible without the constraints of the computing system. If the resource requirements are not valid and/or not feasibly met by the computing system, the orchestrator 904 returns control to block 1002.

If the resource requirements are valid (block 1004), the orchestrator 904 negotiates with the IPU control plane to identify resource for performing the new instance/application (block 1006). For example, based on the type of hardware resources specified in the request (e.g., CPU, GPU, FPGA and SSD), a set of IPUs corresponding to the specified resources are selected. Then, the negotiation between the new request and the existing Apps in the IPUs is started. For example, the negotiation may include making policy-based decisions using the identified resource tolerance thresholds and dynamically migrating existing workloads between IPUs to utilize all resources efficiently. Each IPU may include two portions, i) a data plane, and ii) a control plane. The control plane handles resource allocation, monitoring and policy enforcement, and the data plane handles the data flow between IPUs and the logical units associated with the IPU. An example process for negotiation is described in conjunction with FIG. 11.

The orchestrator 904 determines if negotiation was successful (block 1008). For example, the negotiation may be determined to be successful if the orchestrator is able to find the necessary resources within the set of IPUs. For example, in one scenario, existing applications continue to run on the given IPUs, but there are additional resources free for the new application to be spun. In another scenario, the orchestrator 904 negotiates with an existing application and arranges for the application to be migrated to a different set of IPUs to free resources for the new instance/application.

If the negotiation is not successful (block 1008), control returns to block 1002 for the orchestrator 904 look for a different set of IPUs that satisfy the resource requirements.

If the negotiation is successful (block 1008), the orchestrator 904 provisions the IPU/XPU resource monitoring and enforcement in the IPU control plane (block 1010). Then, the orchestrator 904 configures the hardware resources on the IPU-based datacenter platform(s) for the new instance/application (block 1012). Thus, the negotiation process among IPUs may enable cross-domain coordinated resource management at the datacenter level.

FIG. 11 is a flowchart representative of example machine readable instructions and/or example operations 1100 that may be executed and/or instantiated by processor circuitry to conduct negotiation to dynamically allocate resources based on tolerances prescribed by an application and available IPU resources.

The machine readable instructions and/or the operations 1100 of FIG. 11 begin at block 1102, at which the orchestrator 904 detects that a user has spun up a new instance/application (e.g., a VM, an application, etc.). For example, the request may identify QoS parameters, SLA requirements, etc. For example, the QoS parameters may be set as QOS=FUNC(DEVICE REQS, FREQUENCY, CACHE, MEM-BW, POWER, IPC, CORES, STORAGE, MIGRATION-TOLERANCE). Specifying the SLA parameters enables the specification of hardware resources (e.g., CPU, GPU, FPGA, SSD and respective IPUs) within the datacenter. An example SLA template is specified as:

1. CPU:
A. FREQUENCY RANGE
B. MEMORY BANDWIDTH RANGE
C. CACHE SIZE RANGE
D. TDP RANGE
E. CORE COUNT RANGE
F. MIGRATION TOLERANCE
G. XEON IPC RANGE

2. SSD STORAGE SPACE RANGE

3. GPU CORES RANGE

4. FPGA

5. PCIE GENERATION REQUIREMENT

6. IPU control plane management
h. Network bandwidth range
i. Queue prioritization

The orchestrator 904 validates the request for validity (block 1104). If the request is not valid, the user is prompted to provide a valid request and control returns to block 1102. If the request is valid (block 1104), the orchestrator 904 determines availability of computing resources (block 1106). If available computing resources (e.g., IPU resources) that are willing to negotiate are not available, control returns to block 1102.

If available computing resources are determined that are willing to negotiate (block 1106), the orchestrator 904 begins negotiating with existing instances/applications that are executing on the IPUs and determines if negotiation is successful (block 1108). For example, negotiation may involve determining existing applications on an IPU that may tolerate lower resources to free resources for the new instance/application. Alternatively, negotiation may identify applications that may be migrated to other resources to free the selected resources for the new instance/application. If negotiation fails to free resources for the new instance/application, control returns to block 1106 to identify different resources.

If negotiation succeeds in identifying available resources for execution of the new instance/application (block 1108), the orchestrator 904 determines if there are existing instances/applications to be migrated off the resources (block 1110). If there are existing instances/applications to be migrated, control returns to block 1106 to manage negotiation and allocation of the existing instances/applications.

If existing application/instances are not to be migrated (block 1110), the orchestrator 904 updates a resource allocator (e.g., Class of Service (CloS) of the existing instance/application (block 1112). The orchestrator 904 spins-up the requested instance/application (e.g., workload 902) with the negotiated set of IPUs (block 1114).

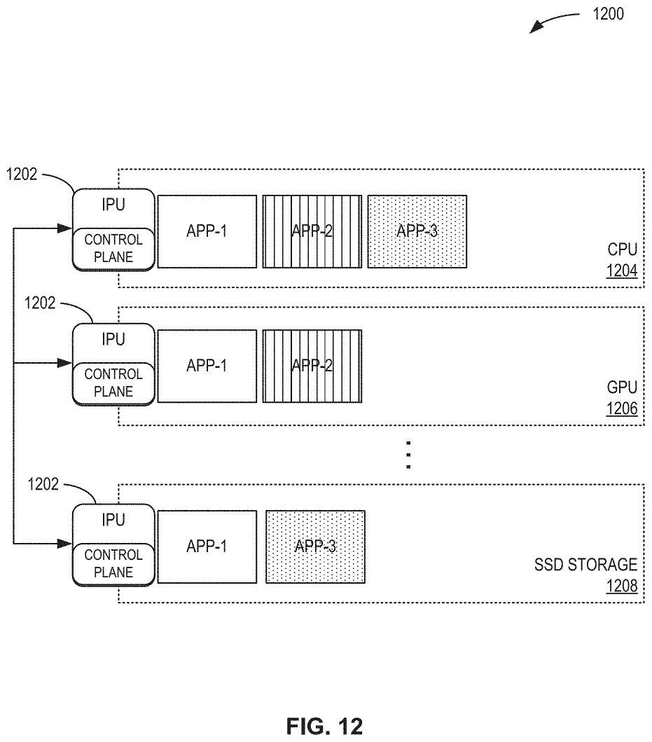

FIG. 12 illustrates an example environment 1200 in which resources managed by IPUs 1202 (or any type of processing unit such as XPU, GPU, etc.) have various states of free and busy resources among CPU 1204, GPU 1206, SSD 1208, etc. According to the illustrated example, APP-1 is utilizing a portion of the CPU 1204, the GPU 1206, and the SSD Store 1208, APP-2 is utilizing a portion of the CPU 1204 and the GPU 1206, and APP-3 is utilizing a portion of the CPU 1204 and the SSD Storage 1208.

FIG. 13 illustrates an example environment 1300 in which consensus in collaborative resource management is accomplished via a decentralized public block chain ledger. As illustrated in FIG. 13, the operational states (e.g., state S₁, state S₂, state S_{N}) of several IPUs 1 to N. Thus, each block in a blockchain (e.g., blocks B₁ to B_{N}) can store state information that may be utilized for peer-to-peer resource negotiation. Utilizing such a blockchain facilitates a distributed collection of information that is trustable to effectively operate as a trust broker. While FIG. 9 illustrates a single centralized orchestrator 904, blockchain or other decentralized techniques may be utilized to facilitate a decentralized orchestrator that manages resources suing the control plane portion of the IPUs. In such a decentralized approach, the resource management can be tracked via the decentralized public ledger with revocation capabilities to track/record telemetry with auditability. Thus, the IPUs 1202 can be considered to have computer resources as well as the management Intellectual Property (Ips) for the device associated with the IPU. The control plane of the IPU hosts the decentralized orchestrator that handles resource allocation, monitoring, and policy enforcement.

From the foregoing, it will be appreciated that example systems, methods, apparatus, and articles of manufacture have been disclosed for managing the assignment of resources in systems utilizing IPUs. Disclosed systems, methods, apparatus, and articles of manufacture improve the efficiency of using a computing device by improving IPU and ingredient resource utilization, manageability with auditability, secure metering towards improved total cost of ownership savings. Disclosed examples facilitate fine granular resource monitoring and manageability across IPUs in hyper scale data centers. Providing application-negotiable resource monitoring and management allows for dynamic prioritization to provide deterministic performance for at-scale microservices.

### Dynamic Negotiable Deep Neural Networks

Some neural network systems attempt to detect underlying target hardware capabilities to accelerate inference/training performance. For example, JIT code generation may be utilized to try to choose an instruction set architecture (ISA) or a mix of ISA based on detected target hardware features of a computing environment. Even though such an abstraction provides the capabilities to take advantage of the underlying hardware capability, it has shortcomings.

Apparatus, articles of manufacture, and apparatus disclosed herein provide a dynamic negotiable deep neural network solution. This approach facilitates the utilization of hardware resources, particularly in instances where there are a significant number of possible features (e.g., single instruction stream, multiple data stream (SIMD) features, learning boost features (e.g., INTEL® Deep Learning Boost), etc. A disclosed dynamic negotiable deep neural network stack involves a configurable and negotiable interface implemented in the APIs 108 of FIG. 1 to specify an SLA. A candidate set of features may be filtered from an available implementation set and a JIT kernel may be dynamically generated for the candidate set of hardware features. The disclosed dynamic negotiable deep neural network stack may dry run the kernels one by one, to pick out the one with best performance and cache it for later usage.

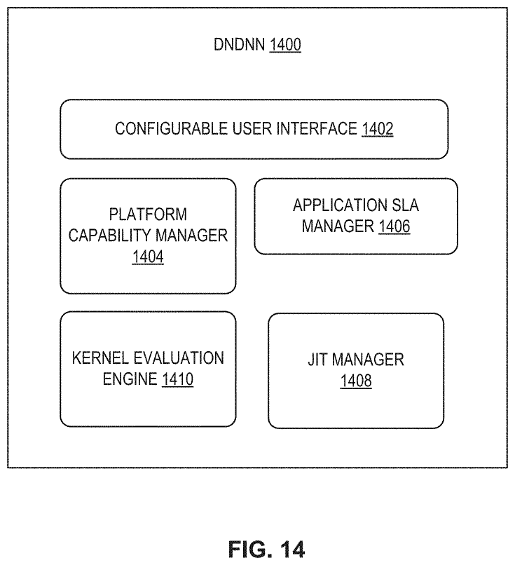

FIG. 14 is a block diagram of an example dynamic negotiable dynamic neural network library 1400. For example, the dynamic negotiable dynamic neural network library 1400 may be added to the APIs 108 of the architecture 100 of FIG. 1. The example dynamic negotiable dynamic neural network library 1400 includes an example configurable user interface 1402, an example platform capability manager 1404, an example application SLA manager 1406, an example JIT manager 1410, and an example kernel evaluation engine 1410.

The example configurable user interface 1402 provides a user interface (e.g., via the oneAPI stack of the architecture 100) for application middleware/frameworks to configure SLAs associated with operations. For example, the user interface 1402 may be a graphical user interface, a text interface, an API, etc.

The example platform compatibility manager 1404 identifies the target hardware capabilities. The platform compatibility manager 1404 also cooperates with the configurable user interface 1402 via for applications to configure JIT kernel configuration.

The example application SLA manager 1406 collects and enforces SLAs provided via the configurable user interface 1402.

The example JIT manager 1408 generates and manages dynamic JIT kernels based on specified SLA in conjunction with bare-metal/VM heuristics observed in the past.

The example kernel evaluation engine 1410 provides the capability to do sandbox evaluations of a newly generated kernels/operation that are fused before large scale deployment.

A flowchart representative of example hardware logic circuitry, machine readable instructions, hardware implemented state machines, and/or any combination thereof for implementing the dynamic negotiable deep neural network 1400 of FIG. 14 is shown in FIG. 14. The machine readable instructions may be one or more executable programs or portion(s) of an executable program for execution by processor circuitry, such as the processor circuitry 1612 shown in the example processor platform 1600 discussed below in connection with FIG. 16 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 14, many other methods of implementing the example dynamic negotiable deep neural network 1400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

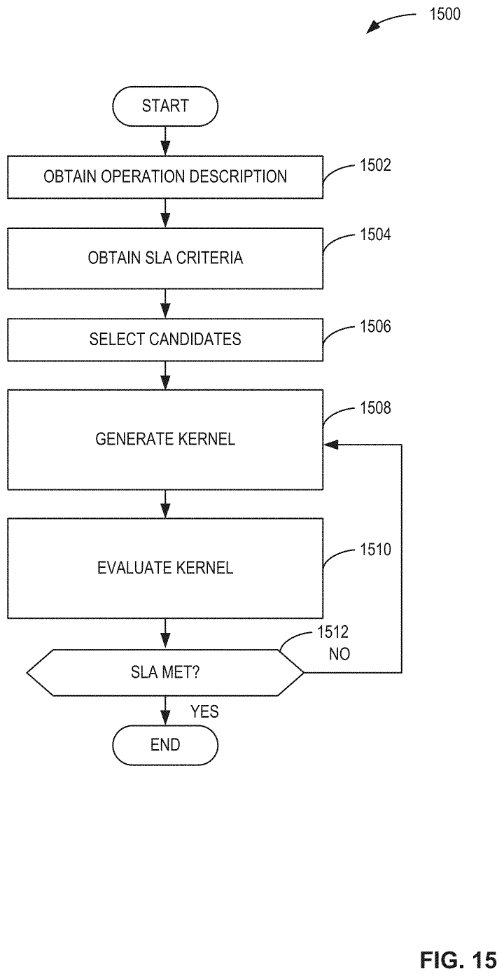

FIG. 15 is a flowchart representative of example machine readable instructions and/or example operations 1500 that may be executed and/or instantiated by processor circuitry to select features for deep neural network learning based on hardware capabilities.

The machine readable instructions and/or the operations 1500 of FIG. 15 begin at block 1502, at which the example configurable user interface 1402 obtains an operation description (e.g., instructions and SLA information input by a user). The example SLA manager 1406 obtains SLA criteria for a current configuration (block 1504). The example platform capability manager 1404 selects candidate configurations (e.g., primitive descriptors) based on the target hardware capabilities (block 1506). For example, the platform capability manager 1404 may select candidates which are successfully created from an implementation set based on the platform information SLA criteria.

The example JIT manager 1408 generates kernels corresponding to the selected candidates (block 1508). For example, the JIT manager 1408 may generate kernels one-by-one for each of the candidates in the candidate set. The example kernel evaluation engine 1410 then executes a dry run/test run of the kernel and collects performance information (block 1510). For example, where multiple kernels are generated one-by-one by the JIT manager 1408, the example kernel evaluation engine 1410 may perform a test run of each kernel and collect the performance results to facilitate selection of a kernel based on the performance (e.g., selecting the kernel with the best performance). For example, the kernel evaluation engine 1410 may cache the kernel with the best performance.

The example application SLA manager 1406 then determines if the selected kernel meets the requested SLA (block 1512) in a sandbox configuration based on configured policies. If the SLA is not met, control returns to block 1508 to attempt to generate another kernel that may meet the SLA. If the application SLA manager 1406 determines that the SLA is met, the process 1500 ends having selected a suitable kernel for operation.

In some implementations, the process 1500 may detect ISA capabilities of the CPU or other processing units and generate a queue for all the implementations in one operation. For example, the following is an example queue for the data type of FP32 and convolution operation:

```
{{forward, f32, f32, f32}, {
  CPU_INSTANCE_X64(jit_avx512_common_dw_convolution_fwd_t
  CPU_INSTANCE_X64(jit_avx512_common_1x1_convolution_fwd_f
  32_t)
  CPU_INSTANCE_X64(jit_avx512_core_f32_wino_conv_2x3_fwd_t)
  CPU_INSTANCE_X64(jit_avx512_core_f32_wino_conv_4x3_fwd_t)
  CPU_INSTANCE_X64(jit_avx512_common_convolution_winograd_f
  wd_t)
  CPU_INSTANCE_X64(jit_avx512_common_convolution_fwd_t<f32
  >)
  CPU_INSTANCE_X64(jit_avx2_dw_convolution_fwd_t)
  CPU_INSTANCE_X64(jit_avx2_1x1_convolution_fwd_t)
  CPU_INSTANCE_X64(jit_sse41_dw_convolution_fwd_t)
  CPU_INSTANCE_X64(jit_sse41_1x1_convolution_fwd_t)
  CPU_INSTANCE_X64(jit_avx2_convolution_fwd_t)
  CPU_INSTANCE_X64(jit_sse41_convolution_fwd_t)
  CPU_INSTANCE(gemm_convolution_fwd_t)
  CPU_INSTANCE(ref_convolution_fwd_t<f32>)
  CPU_INSTANCE(ref_fused_convolution_fwd_t)
  nullptr,
  }},
```

The example process 1500 may try to instantiate each primitive descriptor in the implementation queue. The platform capability manager 1404 may select all the successfully instantiated primitive descriptors out as the candidates for a next layer based on the application/middleware SLA and target hardware platform capabilities. Then, the JIT manager 1408 may generate a JIT kernel corresponding to each primitive descriptor candidate and save it into a JIT kernel candidate queue. The example kernel evaluation engine 1410 will dry run each kernel from JIT kernel candidate queue in the current platform, report out the performance data, and select a JIT kernel based on the performance (e.g., select a JIT kernel with the best throughput) and cache it for late usage.

In some examples, the proposed approach provides approximately 10% performance improvement over existing approaches (e.g., approaches that select a first JIT kernel that meets SLA requirements).

FIG. 16 is a block diagram of an example processor platform 1600 structured to execute and/or instantiate the machine readable instructions and/or the operations of one or more of FIGS. 5, 7A, 7B, 8, 10, 11, and/or 15 to implement the architectures 100, 200, 300, the BIOS 600, and/or the dynamic negotiable deep neural network 1400. The processor platform 1600 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, or any other type of computing device.

The processor platform 1600 of the illustrated example includes processor circuitry 1612. The processor circuitry 1612 of the illustrated example is hardware. For example, the processor circuitry 1612 can be implemented by one or more integrated circuits, logic circuits, FPGAs, microprocessors, CPUs, GPUs, DSPs, and/or microcontrollers from any desired family or manufacturer. The processor circuitry 1612 may be implemented by one or more semiconductor based (e.g., silicon based) devices.

The processor circuitry 1612 of the illustrated example includes a local memory 1613 (e.g., a cache, registers, etc.). The processor circuitry 1612 of the illustrated example is in communication with a main memory including a volatile memory 1614 and a non-volatile memory 1616 by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617.

The processor platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user to enter data and/or commands into the processor circuitry 1612. The input device(s) 1622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1600 of the illustrated example also includes one or more mass storage devices 1628 to store software and/or data. Examples of such mass storage devices 1628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1632, which may be implemented by the machine readable instructions of FIGS. 5, 7A, 7B, 8, 10, 11, and/or 15, may be stored in the mass storage device 1628, in the volatile memory 1614, in the non-volatile memory 1616, and/or on a removable non-transitory computer readable storage medium such as a CD or DVD.

The processor platform 1600 of the illustrated example of FIG. 16 includes example acceleration circuitry 1634, which includes an example GPU 1640, an example vision processing unit (VPU) 1642, and an example neural network processor 1644. Additionally and/or alternatively, the acceleration circuitry 1634 may include any other type of hardware such as a CPU, an FPGA, an ASIC, etc. In this example, the GPU 1640, the VPU 1642, and the neural network processor 1644 are in communication with different hardware of the processor platform 1600, such as the volatile memory 1614, the non-volatile memory 1616, etc., via the bus 1618. In this example, the neural network processor 1644 may be implemented by one or more integrated circuits, logic circuits, microprocessors, GPUs, DSPs, or controllers from any desired family or manufacturer that can be used to execute an AI model, such as a neural network.

### Methods and Apparatus for Dynamic XPU Hardware-Aware Deep Learning Model Management

Compute workloads for a computing device may be carried out through use of Deep Learning (DL) models. Deep Learning (DL) models, such as neural networks (NNs), are useful tools that have demonstrated their value solving complex problems regarding pattern recognition, object classification, natural language processing, automatic speech recognition, etc. Identifying an optimal combination of hardware (HW) and/or software (SW) (e.g., a Deep Learning model) to execute a compute workload is complex due to the vast range of available types of hardware and/or Deep Learning (DL) models and customization(s) thereof.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations when processing input data such that other input(s) result in output(s) consistent with the recognized patterns and/or associations.

Many different types of machine learning models and/or machine learning architectures exist. In some examples disclosed herein, a decision tree model is used. Using a decision tree model enables the interpretation of data that is simple and explainable. In general, machine learning models/architectures that are suitable to use in the example approaches disclosed herein will be Convolutional Neural Network (CNN) and/or Deep Neural Network (DNN), wherein interconnections are not visible outside of the model. However, other types of machine learning models could additionally or alternatively be used such as Recurrent Neural Network (RNN), Support Vector Machine (SVM), Gated Recurrent Unit (GRU), Long Short Term Memory (LSTM), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using known software samples (e.g., malicious and/or clean). However, any other training algorithm may additionally or alternatively be used. In examples disclosed herein, training is performed on a set of models optimized for a selected objective (e.g., performance, accuracy, cost, etc.).

Training is performed using hyperparameters that control how the learning is performed (e.g., a learning rate, a number of layers to be used in the machine learning model, etc.).

Training is performed using training data. In examples disclosed herein, the training data may be any type of dataset of features (e.g., AI features).

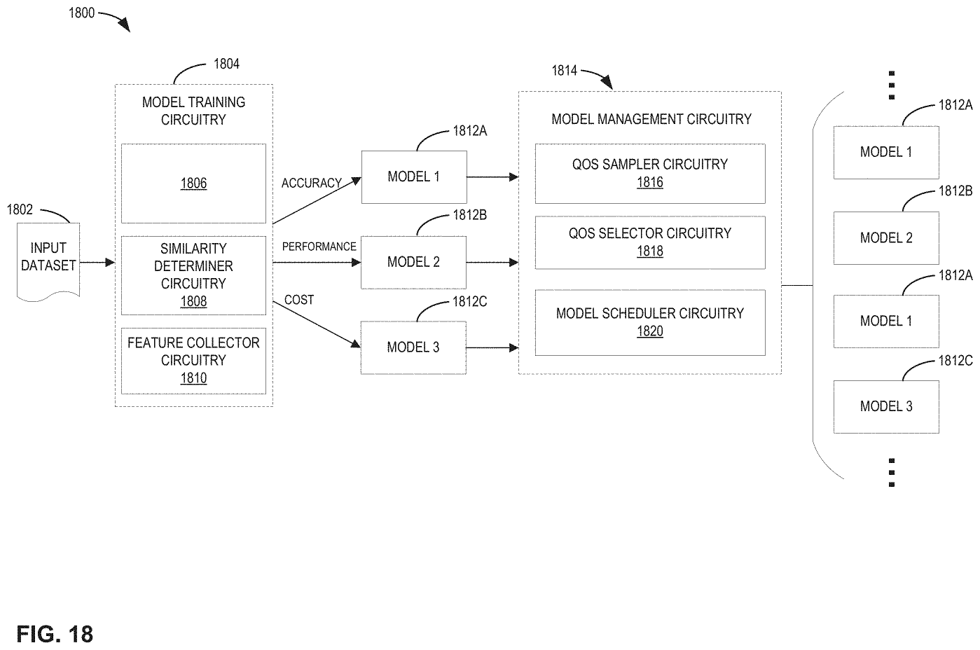

Once training is complete, the model is deployed for use as an executable construct that processes an input and provides an output based on the network of nodes and connections defined in the model. The model is stored in a memory. The model may then be executed by the model management circuitry 1808 of FIG. 18.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Exploration and discovery of new Artificial Intelligence (AI) features is a time-consuming problem. The rapid discovery of new hardware features will accelerate the time-to-market for new AI products and/or features.

Currently, training and inference stages in DL model management systems are focused on a single DL model. Some of these single DL models are decomposed into multiple smaller models, however, the focus of these DL model management systems is on single abstract entities. These current DL model management systems do not analyze differences between alternative models to gain insights and to propose new features for AI feature development and/or exploration.

Neural Architecture Search (NAS) refers to approaches for Deep Learning (DL) model management that focus on finding the right network topology for a particular set of requirements. Hardware-aware NAS approaches consider information from the target hardware (HW) when searching for an optimal neural network topology. The primary focus of hardware-aware NAS approaches is to find a single DL model that fits the listed criteria.

Current NAS approaches to DL model management treat each discovered model in isolation. That is, they do not further consider the existence of differences between models (e.g., candidate features optimized for different objectives by the NAS algorithm) to discover new features and/or gain further insights.

Most current NAS solutions fail to consider how, where, and in what conditions the optimized models will be deployed. For instance, the target hardware might have other processes affecting the availability of the device's resources while the model was optimized, creating an assumption that all available resources would be allocated to that model during inference. This proves to be a significant disadvantage during deployment, however, since if the target hardware undergoes a change in resource utilization during runtime, the hardware will most likely require a model replacement to another model that is better suited for the new conditions.

Model duality must be leveraged in order to explore two or more different architectural options optimized for multiple objectives (e.g., accuracy, latency, performance, cost, etc.). A delta between these architectural options is identified and explored to establish new features and/or gaps in the software (SW) or hardware (HW) to aid in model design/management and/or hardware co-optimization.

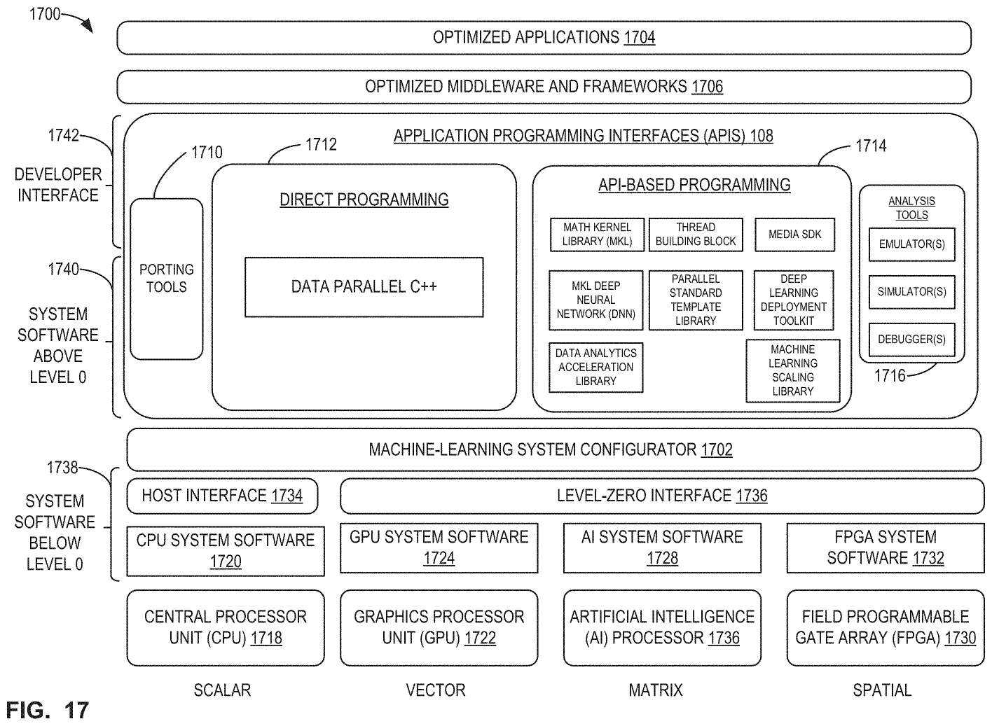

FIG. 17 is an illustration of an example AutoML architecture 1700, which includes an example machine-learning (ML) system configurator 1702 to identify and/or generate a composable ML compute node. The AutoML architecture 1700 includes the ML system configurator 1702 to generate a hardware search space and/or a software search space based on a compute task or workload (e.g., an Artificial Intelligence/Machine Learning (AI/ML) compute task or workload). The ML system configurator 1702 can identify hardware, or portion(s) thereof, from the hardware search space. The ML system configurator 1702 can also discover and/or otherwise identify software (e.g., an AI/ML model), or portion(s) thereof, from the software search space. In some examples, the ML system configurator 1702 can individually and/or simultaneously evolve a composable ML compute node by iterating (i) an architecture and/or type of the hardware and/or the software and/or (ii) configuration(s) of the hardware and/or the software. For example, the ML system configurator 1702 can evolve the composable ML compute node by evaluating the hardware and/or the software when executing a workload and/or based on a simulation of the hardware and/or software executing the workload. In some such examples, the composable ML compute node can be composable because hardware and/or software components can be selected and assembled in various combinations to satisfy specific or pre-defined requirements (e.g., an accuracy requirement, a latency requirement, a throughput requirement, etc.). In some such examples, in response to an identification of a particular combination of hardware and/or software that satisfies the specific or pre-defined requirements, the ML system configurator 1702 can output the combination as a composable ML compute node to execute a workload of interest.

In some examples, a composable ML compute node can be implemented by a single homogeneous computing or electronic system that may be configured and/or otherwise utilized to execute an AI/ML model. For example, the composable ML compute node can be implemented by a single Central Processor Unit (CPU), Graphics Processor Unit (GPU), Artificial Intelligence Processor (AI Processor), Field Programmable Gate Array (FPGA), Digital Signal Processor (DSP), XPU, etc. In some examples, the composable ML compute node can be implemented by portion(s) of a single homogeneous computing or electronic system, such as portion(s) (e.g., kernel(s)) of a single CPU, GPU, AI Processor, FPGA, DSP, XPU, etc. In some such examples, the portion(s) can include a kernel (e.g., a hardware kernel) and/or corresponding interconnect(s) to which different kernel(s), hardware, etc., can be coupled (e.g., physically coupled, communicatively coupled, coupled via a computing or electrical bus, etc.). In some examples, a composable ML compute node can be implemented by multiple ones of the same type of homogeneous computing or electronic system, or portion(s) thereof. For example, the composable ML compute node can be implemented by two or more CPUs (or portion(s) thereof), two or more GPUs (or portion(s) thereof), two or more AI Processors (or portion(s) thereof), two or more FPGAs (or portion(s) thereof), two or more DSPs (or portion(s) thereof), two or more XPUs (or portion(s) thereof), etc.

In some examples, a composable ML compute node can be implemented by a single heterogeneous computing or electronic system that may be configured and/or otherwise utilized to execute an AI/ML model. For example, the composable ML compute node can be implemented by a CPU, a GPU, an AI Processor, an FPGA, a DSP, XPU, etc., and/or any combination(s) thereof. In some such examples, the composable ML compute node can be implemented by one or more CPUs, one or more GPUs, one or more AI Processors, one or more FPGAs, one or more DSPs, one or more XPUs, etc., and/or any combination(s) thereof. In some examples, the composable ML compute node can be implemented by portion(s) of a single heterogeneous computing or electronic system, such as portion(s) of a CPU, GPU, AI Processor, FPGA, DSP, XPU, etc., and/or any combination(s) thereof. In some examples, a composable ML compute node can be implemented by multiple ones of the same heterogeneous computing or electronic system, or portion(s) thereof. For example, the composable ML compute node can be implemented by two or more instances of a heterogeneous computing system, which includes one or more CPUs (or portion(s) thereof), one or more GPUs (or portion(s) thereof), one or more AI Processors (or portion(s) thereof), one or more FPGAs (or portion(s) thereof), one or more DSPs (or portion(s) thereof), one or more XPUs (or portion(s) thereof), etc., and/or combination(s) thereof. In some examples, the composable ML compute node can be implemented by two or more different heterogeneous computing or electronic systems. For example, the composable ML compute node can be implemented by a first heterogeneous computing system and a second heterogeneous computing system. In some such examples, portion(s) of the first heterogeneous computing system and the second heterogeneous computing system can be different.

In some examples, the composable ML compute node can include, store, and/or otherwise access an executable construct to execute an AI/ML model to complete a workload, or portion(s) thereof. For example, the executable construct can be implemented by a configuration image, an executable binary, executable code (e.g., executable machine-readable code), an executable file (e.g., an executable binary file), an executable program, executable instructions (e.g., executable machine-readable instructions), etc., that, when executed, can implement an AI/ML model to effectuate completion of AI/ML workloads.

The AutoML architecture 1700 of the illustrated example includes example optimized applications 1704, example optimized middleware and frameworks 1706, and example application programming interfaces (APIs) 1708. In some examples, the optimized applications 1704 can be implemented by applications (e.g., software applications, web- or browser-based applications, etc.) that are customized, tailored, and/or otherwise optimized to effectuate the identification and/or generation of a composable ML compute node. For example, the optimized applications 1704 can be accessed, utilized, etc., by a developer (e.g., a software developer, a researcher, etc.), Information Technology (IT) personnel, etc. In some such examples, the optimized applications 1704 can be accessed, utilized, etc., to co-design a hardware/software (HW/SW) solution for a technical problem that can benefit from AI/ML techniques. In some examples, the optimized middleware and frameworks 1706 can be implemented by middleware and frameworks that are customized, tailored, and/or otherwise optimized to effectuate the identification and/or generation of a composable ML compute node. For example, the optimized middleware and frameworks 1706 can implement an interface (e.g., communication, connectivity, etc.) between the optimized applications 1704 and the APIs 1708.

The APIs 1708 of the illustrated example can be invoked to program, develop, and/or otherwise generate an AI/ML application by at least one of direct programming or API-based programming. The APIs 1708 of the illustrated example include example porting tools 1710, example direct programming APIs 1712, example API-based programming APIs 1714, and example analysis tools 1716.

In some examples, the porting tools 1710 can be implemented by software (e.g., a software application) that can adapt a program for the purpose of achieving some form of execution in a first computing or electronic environment that is different from a second computing or electronic environment for which the program was originally designed. For example, the porting tools 1710 can convert and/or otherwise adapt a first program developed for a first type of hardware, operating system (OS), library, etc., into a second program for a second type of hardware, OS, library, etc.

In some examples, the direct programming APIs 1712 can be invoked to effectuate direct programming tasks, which may include developing and/or compiling data parallel C++ applications. In some examples, the API-based programming APIs 1714 can be invoked to effectuate API-based programming, which may include developing and/or compiling applications that call (or invoke, instantiate, etc.) a Math Kernel Library (MKL), an MKL Deep Neural Network (DNN) library, a data analytics acceleration library, a thread building block library, a parallel standard template library, a media software development kit (SDK), a deep learning deployment toolkit, a machine learning scaling library, etc., and/or any combination(s) thereof.

In some examples, the analysis tools 1716 can be called, instantiated, and/or otherwise invoked to analyze hardware, software, and/or configuration(s) thereof of a composable ML compute node. For example, the analysis tools 1716 can instantiate emulator(s) to emulate all of the hardware and/or software features of the composable ML compute node to generate and/or otherwise output one or more evaluation parameters. In some such examples, the evaluation parameters can include parameters representative and/or otherwise indicative of accuracy, latency, a number of cycles to complete a workload, or throughput of the composable ML compute node. In some examples, the evaluation parameters can include parameters representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof. For example, the analysis tools 1716 can execute an emulator based on the composable ML compute node. In some such examples, the analysis tools 1716 can execute the emulator to determine a throughput of the composable ML compute node when the composable ML compute node executes a particular AI/ML model having a particular configuration.

In some examples, the analysis tools 1716 can instantiate simulator(s) to simulate the behavior, the configuration, etc., of a composable ML compute node to generate and/or otherwise output one or more evaluation parameters. For example, the analysis tools 1716 can execute a model (e.g., a simulation model, an AI/ML model, etc.) based on the composable ML compute node. In some such examples, the analysis tools 1716 can execute the model to estimate, predict, and/or otherwise determine a throughput of the composable ML compute node when the composable ML compute node executes a particular AI/ML model having a particular configuration.

The AutoML architecture 1700 of the illustrated example includes different types of hardware and/or software from which a composable ML compute node can be generated. In the illustrated example, the AutoML architecture 1700 includes interfaces and target system software for scalar, vector, matrix, and spatial hardware. Additionally and/or alternatively, any other type of hardware may be used. In this example, the scalar hardware is implemented by an example CPU 1718 and example CPU system software 1720. For example, the CPU system software 1720 can include instructions corresponding to a CPU Instruction Set Architecture (ISA). In this example, the vector hardware is implemented by an example GPU 1722 and example GPU system software 1724. For example, the GPU system software 1724 can include kernels, portion(s) of code, etc., such as kernels, compute kernels, and/or shaders. In some examples, the kernels, the portion(s) of code), etc., can be represented in a high-level programming language such as, for example, a High-Level Shader Language (HLSL), OpenCL, etc.

In this example, the matrix hardware is implemented by an example AI processor 1726 and example AI system software 1728. For example, the AI system software 1728 can include one or more AI/ML algorithms, models, etc., such as neural networks (e.g., convolution neural networks (CNNs), deep neural networks (DNNs), recurrent neural networks (RNNs), etc.), Linear Regression models, Logistic Regression Models, Decision Tree Models, Learning Vector Quantization Models, etc., and/or combination(s) thereof. In this example, the spatial hardware is implemented by an example FPGA 1730 and example FPGA system software 1732. For example, the FPGA system software 1732 can include kernels, portion(s) of code, etc., based on a hardware description language (HDL) such as Verilog.

The ML system configurator 1702 of the illustrated example can interface with the CPU 1718 and/or the CPU system software 1720 via an example host interface 1734. The ML system configurator 1702 of the illustrated example can interface with the GPU 1722, the GPU system software 1724, the AI processor 1726, the AI system software 1728, the FPGA 1730, and/or the FPGA system software 1732 via an example level-zero interface 1736.

In the illustrated example, the CPU system software 1720, the GPU system software 1724, the AI system software 1728, the FPGA system software 1732, the host interface 1734, and/or the level-zero interface 1736 can correspond to and/or otherwise implement example system software below level zero 1738. For example, system software below level zero 1738 can correspond to and/or otherwise implement low-level direct-to-metal interfaces that are tailored to hardware, such as the CPU 1718, the GPU 1722, etc.

In the illustrated example, the APIs 1708 can implement example system software above level zero 1740 and an example developer interface 1742. For example, a developer, a user, etc., can access and/or otherwise utilize the AutoML architecture 1700 by way of the APIs 1708. In some examples, a developer, a user, etc., can access and/or otherwise utilize system software at a higher level than low-level direct-to-metal interfaces by way of the APIs 1708. In some examples, a developer, a user, etc., can access and/or otherwise utilize the system software below level zero 1738 via the host interface 1734 and/or the level-zero interface 1736.

FIG. 18 is a block diagram of an example configuration of a dynamic XPU hardware-aware deep learning (DL) model management system implemented in accordance with the teachings of this disclosure. The example DL model management system 1800 includes an example input dataset 1802, example model training circuitry 1804, including example difference determiner circuitry 1806, example similarity determiner circuitry 1808, and example feature collector circuitry 1810, an example first, second, and third model 1812A, 1812B, and 1812C, and example model management circuitry 1814, including example QoS selector circuitry 1816, example QoS sampler circuitry 1818, and example model scheduler circuitry 1820.

In examples disclosed herein, the example input dataset 1802 may contain candidate features, objectives with which models are to be optimized, etc. The example input dataset 1802 is transmit to the model training circuitry 1804 for use in the training and/or optimization of models by the DL model management system 1800.

The example model training circuitry 1804, including the example difference determiner circuitry 1806, the example similarity determiner circuitry 1808, and the example feature collector circuitry 1810, receives the example input dataset 1802 and generates a set of models (e.g., first model 1812A, second model 1812B, and third model 1812C) based on a chosen objective. For example, in the DL model management system 1800 disclosed herein, the first model, 1812A, is trained to optimize accuracy as the key objective, the second model, 1812B, is trained to optimize performance as the key objective, and the third model, 1812C, is trained to optimize cost as the key objective.

The example difference determiner circuitry 1806 analyzes the feature lists of models optimized for different selected objectives (e.g., accuracy, performance, cost, etc.) to identify feature differences between the various models. In examples disclosed herein, the difference determiner circuitry 1806 identifies these differences by associating features that are present when a first objective was selected for a first model (e.g., features from the first model 1812A with a selected objective of accuracy) but are not present when a second objective was selected for a second model (e.g., features from the second model 1812B with a selected objective of performance). In determining these differences, further insight is gained into why a model might have improved its overall performance at the cost of another objective (e.g., cost).

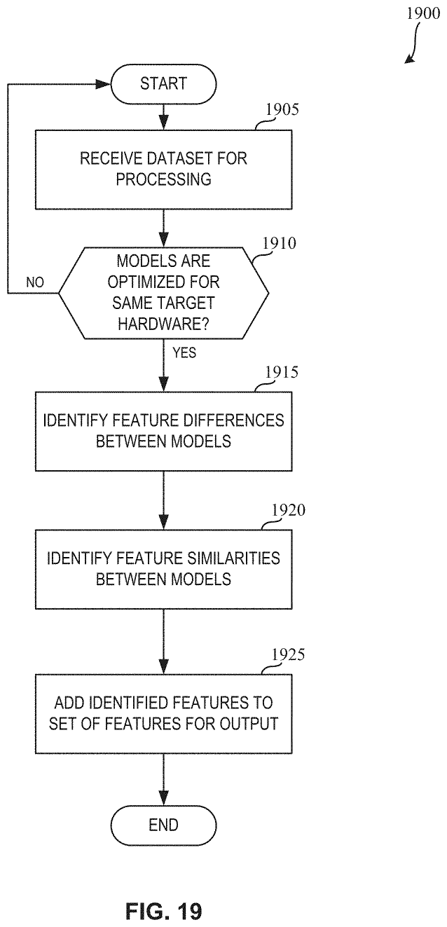

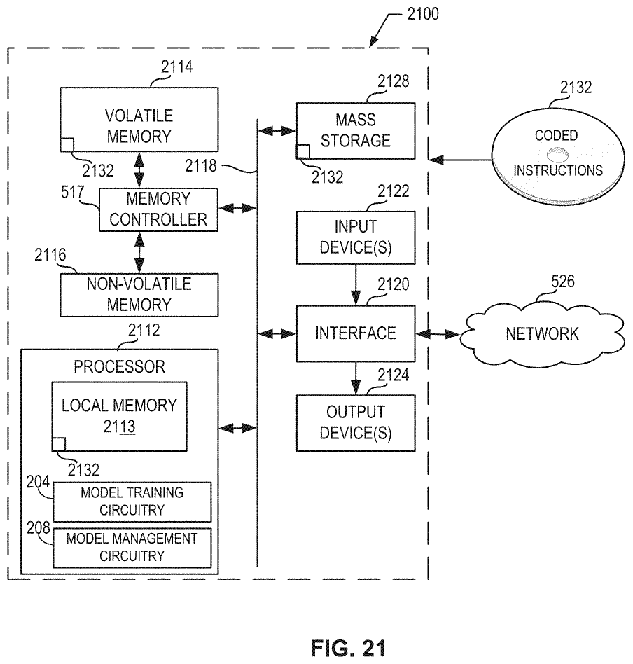

In some examples, the model training circuitry 1804 includes means for identifying candidate differences between models optimized for different selected objectives (e.g., accuracy, performance, cost, etc.). For example, the means for identifying differences may be implemented by the example difference determiner circuitry 1806. In some examples, the example difference determiner circuitry 1806 may be instantiated by processor circuitry such as the example processor circuitry 2112 of FIG. 21. For instance, the example difference determiner circuitry 1806 may be instantiated by the example general purpose processor circuitry 2100 of FIG. 21 executing machine executable instructions such as that implemented by at least blocks 1905, 1910, and 1915 of FIG. 19. In some examples, the example difference determiner circuitry 1806 may be instantiated by hardware logic circuitry, which may be implemented by an ASIC or the FPGA circuitry 700 of FIG. 7 structured to perform operations corresponding to the machine readable instructions. Additionally or alternatively, the example difference determiner circuitry 1806 may be instantiated by any other combination of hardware, software, and/or firmware. For example, the example difference determiner circuitry 1806 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example similarity determiner circuitry 1808 analyzes the feature lists of models optimized for different selected objectives (e.g., accuracy, performance, cost, etc.) to identify feature similarities between the various models. In examples disclosed herein, the similarity determiner circuitry 1808 identifies these similarities by associating features that are present when a first objective was selected for a first model (e.g., features from the first model 1812A with a selected objective of accuracy) and are still present when a second objective was selected for a second model (e.g., features from the second model 1812B with a selected objective of performance). In determining these similarities, further insight is gained into which features are important for overall model performance (e.g., it can be concluded that some layers are very important when performing object detection).

In some examples, the model training circuitry 1804 includes means for identifying similarities between models optimized for different selected objectives (e.g., accuracy, performance, cost, etc.). For example, the means for identifying similarities may be implemented by the example similarity determiner circuitry 1808. In some examples, the example similarity determiner circuitry 1808 may be instantiated by processor circuitry such as the example processor circuitry 2112 of FIG. 21. For instance, the example similarity determiner circuitry 1808 may be instantiated by the example general purpose processor circuitry 2112 of FIG. 21 executing machine executable instructions such as that implemented by at least block 1920 of FIG. 19. In some examples, the example similarity determiner circuitry 1808 may be instantiated by hardware logic circuitry, which may be implemented by an ASIC or the FPGA circuitry 700 of FIG. 7 structured to perform operations corresponding to the machine readable instructions. Additionally or alternatively, the example similarity determiner circuitry 1808 may be instantiated by any other combination of hardware, software, and/or firmware. For example, the example similarity determiner circuitry 1808 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example feature collector circuitry 1810 collects the list of features identified by both the difference determiner circuitry 1806 and the similarity determiner circuitry 120. In some examples, the feature collector circuitry 1810 may then perform further analysis on the list of collected features, however in examples disclosed herein, the list may be retained for output.

In some examples, the model training circuitry 1804 includes means for collecting features identified by the example difference determiner circuitry 1806 and the example similarity determiner circuitry 1808. For example, the means for collecting features may be implemented by the example feature collector circuitry 1810. In some examples, the example feature collector circuitry 1810 may be instantiated by processor circuitry such as the example processor circuitry 2112 of FIG. 21. For instance, the example feature collector circuitry 1810 may be instantiated by the example general purpose processor circuitry 2112 of FIG. 21 executing machine executable instructions such as that implemented by at least block 1925 of FIG. 19. In some examples, the example feature collector circuitry 1810 may be instantiated by hardware logic circuitry, which may be implemented by an ASIC or the FPGA circuitry 700 of FIG. 7 structured to perform operations corresponding to the machine readable instructions. Additionally or alternatively, the example feature collector circuitry 1810 may be instantiated by any other combination of hardware, software, and/or firmware. For example, the example feature collector circuitry 1810 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The first, second, and third models (1812A, 1812B, and 1812C) obtained from the input dataset 1802 are input into the example model management circuitry 1814 for further processing after use by the model training circuitry 1804. In examples disclosed herein, the first model 1812A is optimized to maximize the selected objective of accuracy, the second model 1812B is optimized to maximize the selected objective of performance, and the third model 1812C is optimized to maximize the selected objective of cost.

In examples disclosed herein, the example model management circuitry 1814 includes example Quality of Service (QoS) sampling circuitry 1816, example QoS selector circuitry 1818, and example model scheduler circuitry 1820.

The example Quality of Service (QoS) sampler circuitry 1816 samples a current state of the target hardware platform. For example, the Quality of Service (QoS) sampler circuitry 1816 may determine that the target hardware platform is currently responding to a high priority request from an application.

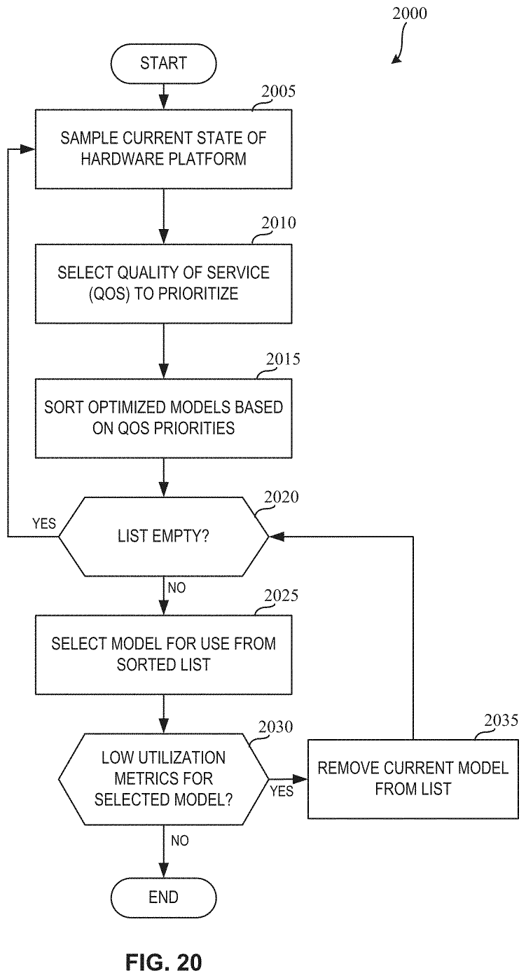

In some examples, the model management circuitry 1814 includes means for determining a current state of a target hardware platform. For example, the means for determining may be implemented by the example QoS sampler circuitry 1816. In some examples, the example QoS sampler circuitry 1816 may be instantiated by processor circuitry such as the example processor circuitry 2112 of FIG. 21. For instance, the example QoS sampler circuitry 1816 may be instantiated by the example general purpose processor circuitry 2112 of FIG. 21 executing machine executable instructions such as that implemented by at least block 2005 of FIG. 20. In some examples, the example QoS sampler circuitry 1816 may be instantiated by hardware logic circuitry, which may be implemented by an ASIC or the FPGA circuitry 700 of FIG. 7 structured to perform operations corresponding to the machine readable instructions. Additionally or alternatively, the example QoS sampler circuitry 1816 may be instantiated by any other combination of hardware, software, and/or firmware. For example, the example QoS sampler circuitry 1816 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example QoS selector circuitry 1818 selects a quality of service (QoS) to be prioritized based on the current state of the target hardware platform, as determined by the QoS sampler circuitry 1816. For example, the QoS selector circuitry 1818 may choose accuracy as the QoS objective of top priority if the QoS sampler circuitry 1816 establishes prior that the target hardware platform is currently responding to a high priority request from an application.

In some examples, the model management circuitry 1814 includes means for selecting a quality of service (QoS) objective. For example, the means for selecting a QoS objective may be implemented by the example QoS selector circuitry 1818. In some examples, the example QoS selector circuitry 1818 may be instantiated by processor circuitry such as the example processor circuitry 2112 of FIG. 21. For instance, the example QoS selector circuitry 1818 may be instantiated by the example general purpose processor circuitry 2100 of FIG. 21 executing machine executable instructions such as that implemented by at least blocks 2010, 2015, and 2020 of FIG. 20. In some examples, the example QoS selector circuitry 1818 may be instantiated by hardware logic circuitry, which may be implemented by an ASIC or the FPGA circuitry 700 of FIG. 7 structured to perform operations corresponding to the machine readable instructions. Additionally or alternatively, the example QoS selector circuitry 1818 may be instantiated by any other combination of hardware, software, and/or firmware. For example, the example QoS selector circuitry 1818 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example model scheduler circuitry 1820 selects the model that will best satisfy the requirements of the selected quality of service (QoS) objective for prioritization, for use by the target hardware platform. Additionally, the model scheduler circuitry 1820 also monitors utilization metrics of the target hardware platform. If any of the utilization metrics is established to be lower than a pre-determined threshold value, the model scheduler circuitry 1820 then adjusts the model selection to produce another model for use by the target hardware platform. For example, if the first model 1812A begins to produce low utilization metrics on the hardware platform, the model scheduler circuitry 1820 selects the second model 1812B as the new model for use. If the second model 1812B begins to yield low utilization metrics after some time, the model scheduler circuitry 1820 may determine that the first model 1812A is better for use by the hardware platform.

In some examples, the model management circuitry 1814 includes means for selecting a model. For example, the means for selecting may be implemented by the example model scheduler circuitry 1820. In some examples, the example model scheduler circuitry 1820 may be instantiated by processor circuitry such as the example processor circuitry 2112 of FIG. 21. For instance, the example model scheduler circuitry 1820 may be instantiated by the example general purpose processor circuitry 2100 of FIG. 21 executing machine executable instructions such as that implemented by at least blocks 2025, 2030, and 2035 of FIG. 20. In some examples, the example model scheduler circuitry 1820 may be instantiated by hardware logic circuitry, which may be implemented by an ASIC or the FPGA circuitry 700 of FIG. 7 structured to perform operations corresponding to the machine readable instructions. Additionally or alternatively, the example model scheduler circuitry 1820 may be instantiated by any other combination of hardware, software, and/or firmware. For example, the example model scheduler circuitry 1820 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model training circuitry 1804 of FIG. 18 is illustrated in FIG. 18, one or more of the elements, processes, and/or devices illustrated in FIG. 18 may be combined, divided, re-arranged, omitted, eliminated, and/or implemented in any other way. Further, the example difference determiner circuitry 1806, the example similarity determiner circuitry 1808, the example feature collector circuitry 1810, and/or, more generally, the example model training circuitry 1804 of FIG. 18, may be implemented by hardware alone or by hardware in combination with software and/or firmware. Thus, for example, any of the example difference determiner circuitry 1806, the example similarity determiner circuitry 1808, the example feature collector circuitry 1810, and/or, more generally, the example model training circuitry 1804, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model training circuitry 1804 of FIG. 18 may include one or more elements, processes, and/or devices in addition to, or instead of, those illustrated in FIG. 18, and/or may include more than one of any or all of the illustrated elements, processes and devices.

While an example manner of implementing the model management circuitry 1814 of FIG. 18 is illustrated in FIG. 18, one or more of the elements, processes, and/or devices illustrated in FIG. 18 may be combined, divided, re-arranged, omitted, eliminated, and/or implemented in any other way. Further, the example Quality of Service (QoS) sampler circuitry 1816, the example QoS selector circuitry 1818, the example model scheduler circuitry 1820, and/or, more generally, the example model management circuitry 1814 of FIG. 18, may be implemented by hardware alone or by hardware in combination with software and/or firmware. Thus, for example, any of the example Quality of Service (QoS) sampler circuitry 1816, the example QoS selector circuitry 1818, the example model scheduler circuitry 1820, and/or, more generally, the example model management circuitry 1814, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model management circuitry 1814 of FIG. 18 may include one or more elements, processes, and/or devices in addition to, or instead of, those illustrated in FIG. 18, and/or may include more than one of any or all of the illustrated elements, processes and devices.

A flowchart representative of example hardware logic circuitry, machine readable instructions, hardware implemented state machines, and/or any combination thereof for implementing the model training circuitry 1804 of FIG. 18 is shown in FIG. 19. A flowchart representative of example hardware logic circuitry, machine readable instructions, hardware implemented state machines, and/or any combination thereof for implementing the model management circuitry 1814 of FIG. 18 is shown in FIG. 20. The machine readable instructions may be one or more executable programs or portion(s) of an executable program for execution by processor circuitry, such as the processor circuitry 2112 shown in the example processor platform 2100 discussed below in connection with FIG. 21 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 19 and/or 20, many other methods of implementing the example model training circuitry 1804 and/or the example model management circuitry 1814 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 19 and/or 20 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 19 is a flowchart representative of example machine readable instructions and/or example operations 1900 that may be executed and/or instantiated by processor circuitry to identify and collect similar and/or different features between the collection of models optimized for various target platform objectives. The machine readable instructions and/or the operations 1900 of FIG. 19 begin at block 1905, at which the difference determiner circuitry 1806 receives the input dataset 1802 of FIG. 18 for processing.

As illustrated in FIG. 19, at block 1905, the difference determiner circuitry 1806 receives a dataset (e.g., input dataset 1802 from FIG. 18) for processing. In examples disclosed herein, the dataset includes optimized models, however, in other examples, the dataset may be configured to include candidate features, platform metrics, etc.

At block 1910, the difference determiner circuitry 1806 checks whether the models contained within the example dataset received in block 1905 (e.g., input dataset 1802 from FIG. 18) are optimized for the same target hardware. Before the variety of models are to be compared against one another, the difference determiner circuitry 1806 is to check for target hardware matches for the models. If the difference determiner circuitry 1806 establishes that the models are optimized for the same target hardware, the process moves forward to block 1915. However, if the difference determiner circuitry 1806 determines that the models are not all optimized for the same target hardware, the process moves back to the start.

At block 1915, the difference determiner circuitry 1806 identifies feature differences between each of the models received for processing in block 1905. In examples disclosed herein, the example dataset received for processing in block 1905 includes a variety of models, each model optimized for a different objective on the same target hardware platform. Accordingly, the difference determining circuitry 1806 identifies feature differences between each of the models by comparing lists of features present in each of the models and selecting those which are not present in all models. For example, certain features that are present for a model with a selected objective of accuracy but are not present for a model with a selected objective of performance are identified by the difference determiner circuitry 1806.

At block 1920, the example similarity determiner circuitry 1808 performs a similar process as the example difference determiner circuitry 1806, however, feature similarities between each of the models are identified. For example, certain features that are present for a model with a selected objective of accuracy and are also present for a model with a selected objective of performance are identified by the similarity determiner circuitry 1808.

At block 1925, the example feature collector circuitry 1810 aggregates the features identified by the example difference determiner circuitry 1806 and the example similarity determiner circuitry 1808 into a single set. In example disclosed herein, the feature collector circuitry 1810 may output the aggregated feature set.

FIG. 20 is a flowchart representative of example machine readable instructions and/or example operations 2000 that may be executed and/or instantiated by processor circuitry to dynamically select and/or adjust an optimized model for use based on a current state and/or model utilization metrics of the target hardware platform. The machine readable instructions and/or the operations 2000 of FIG. 20 begin at block 2002, at which the Quality of Service (QoS) sampler circuitry 1816 samples the current state of the hardware platform.

As illustrated in FIG. 20, at block 2005, the QoS sampler circuitry 1816 samples the current state of the hardware platform. For example, the QoS sampler circuitry 1816 may determine that the hardware platform is currently responding to a high priority request from an application.

At block 2010, the QoS selector circuitry 1818 chooses a quality of service (QoS) objective (e.g., cost, accuracy, performance, etc.) to prioritize based on the current state of the hardware platform determined in block 2005 (e.g., currently responding to a high priority request from an application) by the QoS sampler circuitry 1816. For example, the QoS selector circuitry 1818 may choose accuracy as the QoS objective of top priority if the QoS sampler circuitry 1816 establishes that the hardware platform is currently responding to a high priority request from an application.

At block 2015, the QoS selector circuitry 1818 sorts the collection of models, each optimized for a different QoS objective, based on the selected QoS priority objective in block 2010. In examples disclosed herein, the QoS selector circuitry 1818 may sort the collection of models in descending order, based on ability to maximize the selected QoS objective for prioritization.

At block 2020, the QoS selector circuitry 1818 checks to see if the list of sorted models (e.g., sorted based on ability to maximize the selected QoS objective for prioritization) is empty. If the QoS selector circuitry 1818 determines that the list is empty, the process moves back to block 2005. However, if the QoS selector circuitry 1818 determines that the list is not empty, the process moves forward to block 2025.

At block 2025, the model scheduler circuitry 1820 selects the model that will satisfy the requirements of the selected QoS objective for prioritization, for use by the target hardware platform. In examples disclosed herein, since the list of optimized models is sorted in descending order based on ability to satisfy the selected QoS priority objective, the first model in the list is selected for use.

At block 2030, the model scheduler circuitry 1820 determines whether the selected model is yielding low utilization metrics on the target hardware platform. If the model scheduler circuitry 1820 determines that the model does indeed have low utilization metrics, the process moves to block 2035. However, if the model scheduler circuitry 1820 determines that the selected model is not yielding low utilization metrics on the target platform, the process is ended.

At block 2035, the model scheduler circuitry 1820, after determining that the selected model is yielding low utilization metrics on the target hardware platform, removes the model in current use from the list of sorted models. Then, the process moves back to block 2020 where the QoS selector circuitry 1818 checks to see if the list of sorted models is empty.

FIG. 21 is a block diagram of an example processor platform 2100 structured to execute and/or instantiate the machine readable instructions and/or the operations of FIGS. 19-20 to implement the model training circuitry 1804, model management circuitry 1814, and/or more generally, the Deep Learning (DL) model management system 1800 of FIG. 18. The processor platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2100 of the illustrated example includes processor circuitry 2112. The processor circuitry 2112 of the illustrated example is hardware. For example, the processor circuitry 2112 can be implemented by one or more integrated circuits, logic circuits, FPGAs, microprocessors, CPUs, GPUs, DSPs, and/or microcontrollers from any desired family or manufacturer. The processor circuitry 2112 may be implemented by one or more semiconductor based (e.g., silicon based) devices. In this example, the processor circuitry 2112 implements the example model training circuitry 1804, including the example difference determiner circuitry 1806, the example similarity determiner circuitry 1808, and the example feature collector circuitry 1810 and the example model management circuitry 1814, including the example quality of service (QoS) sampler circuitry 1816, the example QoS selector circuitry 1818, and the example model scheduler circuitry.

The processor circuitry 2112 of the illustrated example includes a local memory 2113 (e.g., a cache, registers, etc.). The processor circuitry 2112 of the illustrated example is in communication with a main memory including a volatile memory 2114 and a non-volatile memory 2116 by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117.

The processor platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2122 are connected to the interface circuitry 2120. The input device(s) 2122 permit(s) a user to enter data and/or commands into the processor circuitry 2112. The input device(s) 2122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2124 are also connected to the interface circuitry 2120 of the illustrated example. The output device(s) 2124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2100 of the illustrated example also includes one or more mass storage devices 2128 to store software and/or data. Examples of such mass storage devices 2128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 2132, which may be implemented by the machine readable instructions of FIGS. 19-20, may be stored in the mass storage device 2128, in the volatile memory 2114, in the non-volatile memory 2116, and/or on a removable non-transitory computer readable storage medium such as a CD or DVD.

From the foregoing, it will be appreciated that example systems, methods, apparatus, and articles of manufacture have been disclosed for dynamic XPU hardware-aware deep learning (DL) model management. Disclosed systems, methods, apparatus, and articles of manufacture improve the efficiency of using a computing device by allowing for the rapid discovery of new hardware features, which accelerates the time-to-market for new Artificial Intelligence (AI) products and/or features and enhances performance improvement measures for computing devices through application of the newly-discovered features. Disclosed systems, methods, apparatus, and articles of manufacture are accordingly directed to one or more improvement(s) in the operation of a machine such as a computer or other electronic and/or mechanical device. METHODS AND APPARATUS FOR DATA ENHANCED AUTOMATED MODEL GENERATION

Machine learning is an important enabling technology for the revolution currently underway in artificial intelligence, driving truly remarkable advances in fields such as object detection, image classification, speech recognition, natural language processing, and many more. Models are created using machine learning that, when utilized, enable an output to be generated based on an input. Neural architecture search enables various architectures to be searched when creating a machine learning model.

Neural Architecture Search (NAS) is an approach for exploring different machine learning algorithms for solving machine learning tasks. NAS algorithms take significant amount resources (e.g., compute resources, temporal resources, energy resources, etc.) to identify acceptable architectures. Most of these resources are expended by examining non-optimal architecture configurations during an exploration stage. Existing NAS algorithms do not provide clear explanations of the decisions for selecting a particular architecture, and such algorithms do not benefit from collected data regarding previous findings (e.g., sequence of operations, FLOPs, etc.) or target hardware capabilities. This information is typically discarded and does not benefit future applications of the NAS algorithm.

Due to the complexity of the task, NAS solutions tend to forget any insights from one run to the next. The initial conditions/configurations in previous solutions are independent of any other configurations used previously.

Existing NAS approaches do not reuse prior execution data related to models identified via NAS. That is, existing approaches do not benefit from collected knowledge about the task that the model will perform (e.g., detection, segmentation, etc.). When performing NAS, existing approaches start from scratch every time, when looking for better models. Many existing NAS approaches also require significant reconfiguration when moving to different tasks, and such approaches do not generalize the neural network architecture search process.

Example approaches disclosed herein analyze state-of-the-art and emerging workloads and collect historical information about the models including performance, sequence of operations, size, floating point operations per second (FLOPS), etc. for each operation.

In examples disclosed herein, a user provides a task (object recognition, segmentation, etc.) and objective (accuracy, latency, mix, etc.), and the NAS system selects starting hyperparameters/configuration information which include the best configuration for the task, objective, and, in some examples, the target hardware on which the model is to be executed.

Collected execution and/or performance information provides insights and guides the initial conditions on the search for an architecture that satisfies the requirements. The system also collects target hardware information, making the system hardware-aware and allowing the system to refine for the specific target hardware(s). For example, the system can avoid dilated 7 x7 convolution kernels if kernel does not perform well (e.g., latency on the selected target hardware exceeds a threshold amount of latency).

Example approaches disclosed herein provide the user with the generated model and the reasoning behind the choices made when selecting operations. The decisions are based on the collected historical data and the task knowledge obtained from the knowledge builder (KB). Providing the reasoning for decisions can result in insights for future HW improvements (e.g., optimize specific kernels, memory BW, etc.)

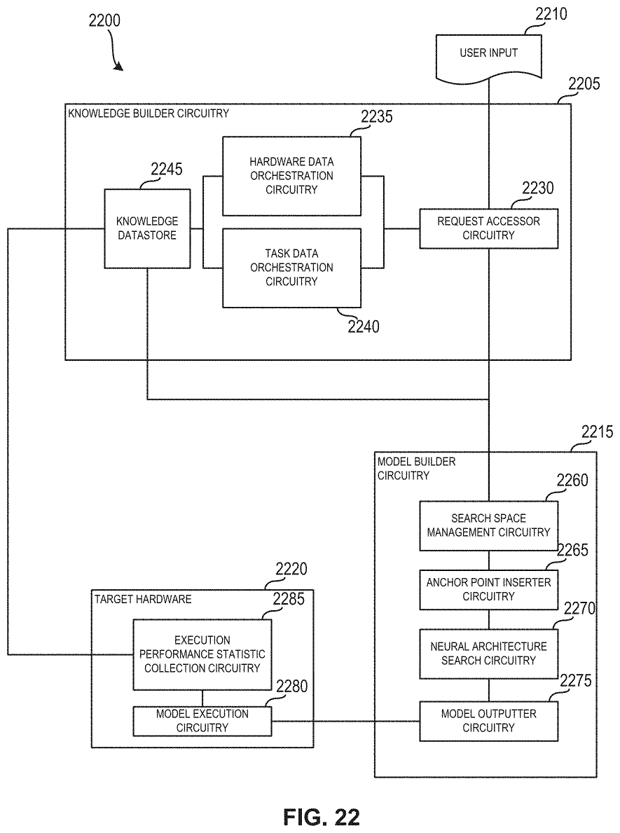

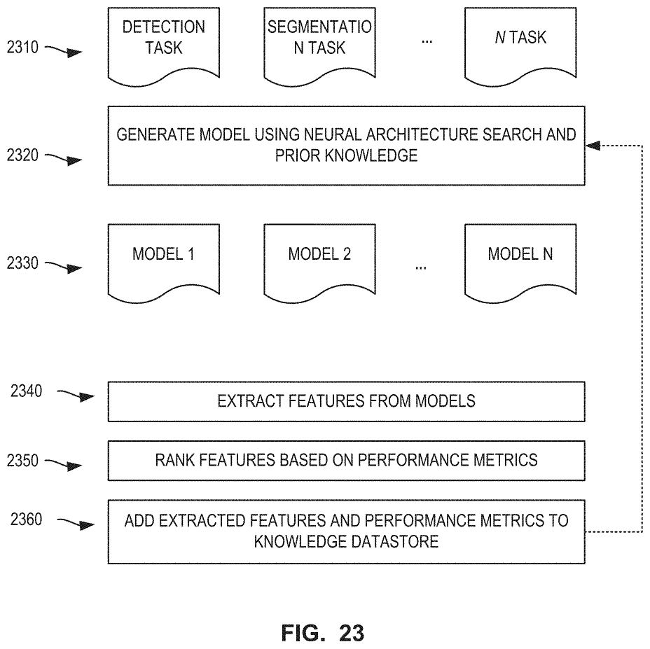

FIG. 22 is a block diagram of an example system implemented in accordance with the teachings of this disclosure for data enhanced automated model generation. The example system 2200 of FIG. 22 includes knowledge builder circuitry 2205 that receives a user input 2210, and model builder circuitry 2215 that builds and provides a model to target hardware 2220.

The example system of FIG. 22 presents an end-to-end solution that receives information from the user (objective, task, target HW), analyzes this information using a knowledge base and builds suggestions for the search space and initial configuration for the NAS approach. The approach is agnostic to the NAS approach to be used, enabling a user to decide on the state-of-the-art approach that will receive the suggested configuration.

The example user input 2210 includes information including, for example, an objective of a machine learning model, a task to be performed by the machine learning model, and, optionally, one or more characteristics of a target hardware on which the machine learning model is to be executed. The task (object recognition, segmentation, etc.) will include input layer requirements, output layer requirements, and data requirements. The system of FIG. 22 is flexible enough that the user can provide information used to influence the model generation (e.g., by specifying whether the current task is similar to another task, and/or by specifying additional layers (not yet in the knowledge base, or associated with a different task) to include in the search space).

The knowledge builder circuitry 2205 of FIG. 22 may be instantiated (e.g., creating an instance of, bring into being for any length of time, materialize, implement, etc.) by processor circuitry such as a central processing unit executing instructions. Additionally or alternatively, the knowledge builder circuitry 2205 of FIG. 22 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 22 may, thus, be instantiated at the same or different times (and/or by different hardware circuitry). Some or all of the circuitry may be instantiated, for example, in one or more threads executing concurrently on hardware and/or in series on hardware. Moreover, in some examples, some or all of the circuitry of FIG. 22 may be implemented by one or more virtual machines and/or containers executing on the microprocessor.

The example knowledge builder circuitry 2205 of the illustrated example of FIG. 22 includes request accessor circuitry 2230, hardware data orchestration circuitry 2235, task data orchestration circuitry 2240, and a knowledge datastore 2245. The example knowledge builder circuitry 2205 archives information for models and hardware into the knowledge datastore 2245. If the hardware is not known in the knowledge datastore 2245, the user is able to cause the system to execute on the target hardware 2220 to extract performance metrics. A report of such performance metrics is obtained and added to the knowledge datastore 2245 to build task knowledge. If the task is not in the knowledge datastore 2245, the task data orchestration circuitry 2240 creates task knowledge for the new tasks. FIG. 2 illustrates the process for creating or updating the knowledge datastore 2245.

In examples disclosed herein, the knowledge datastore 2245 of the knowledge builder circuitry 2205 can be pre-populated with state-of-the-art (SOTA) or custom models and hardware configurations. In addition, the knowledge datastore 2245 can be updated at any time based on, for example, statistics collected by the target hardware 2220. In examples disclosed herein, the knowledge datastore 2245 separates the models by tasks. To build the task knowledge, model information is retrieved from the knowledge datastore 2245 the specific task and features are extracted from the models. In cases of a new or custom task, similar tasks/models are retrieved based on the user input. These features include, but are not limited to, the framework used to train the model, the HW specs and any information for mapping model (latencies, etc.) including HW telemetry, the performance objective, sequence of operations, number of FLOPs, dataset used, number of layers, etc. These features are then ranked by hardware features, objective, etc. The extracted and ranked features are then considered task knowledge which is then archived in the knowledge datastore 2245 for future use.

The example request accessor circuitry 2230 of the illustrated example of FIG. 22 receives a request for generation of a model to perform a selected task. In examples disclosed herein, the user input 2210 received by the request accessor circuitry 2230 includes information including, for example, an objective of a machine learning model, a task to be performed by the machine learning model, and, in some examples, one or more characteristics of a target hardware on which the machine learning model is to be executed. The request may be formatted as, for example, a request received at a web server, a request formatted in a structured data format (e.g., a JavaScript object notation (JSON) format, an extensible markup language (XML) format, etc.). The example request accessor circuitry 2230 accesses hardware data orchestration information via the hardware data orchestration circuitry 2235 and task data orchestration information via the task data orchestration circuitry 2240. The accessed information (if available) and the request are provided to the search space management circuitry 2260 of the model builder circuitry 2215.

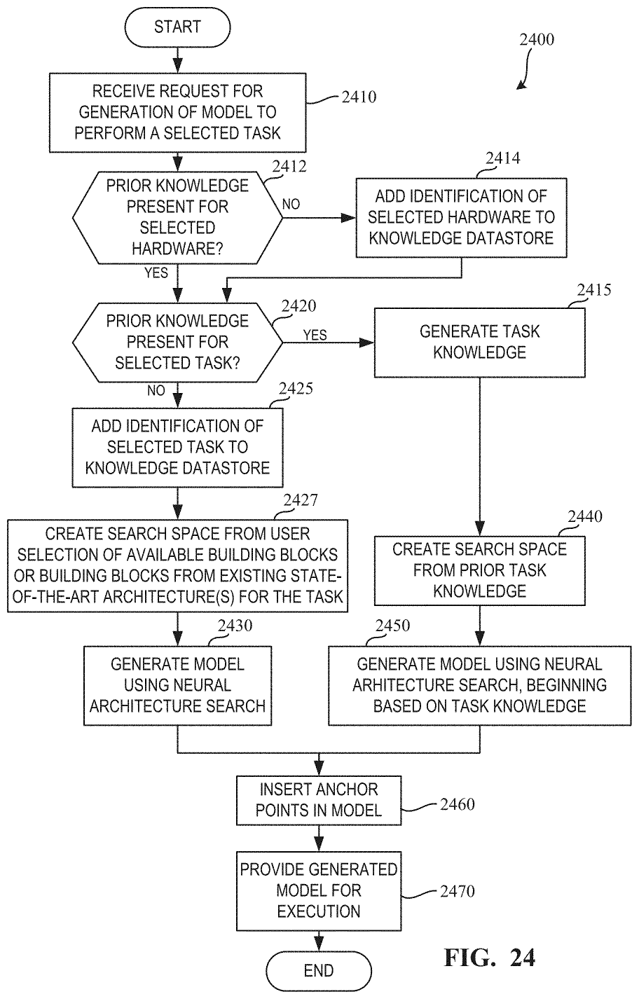

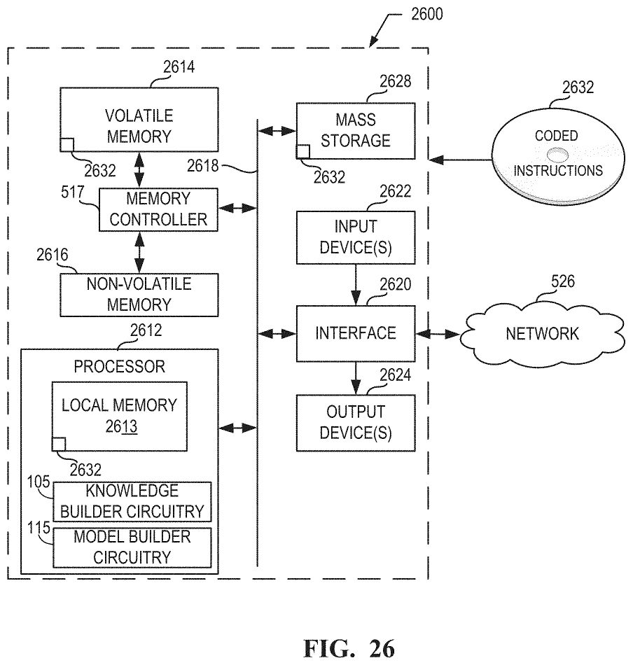

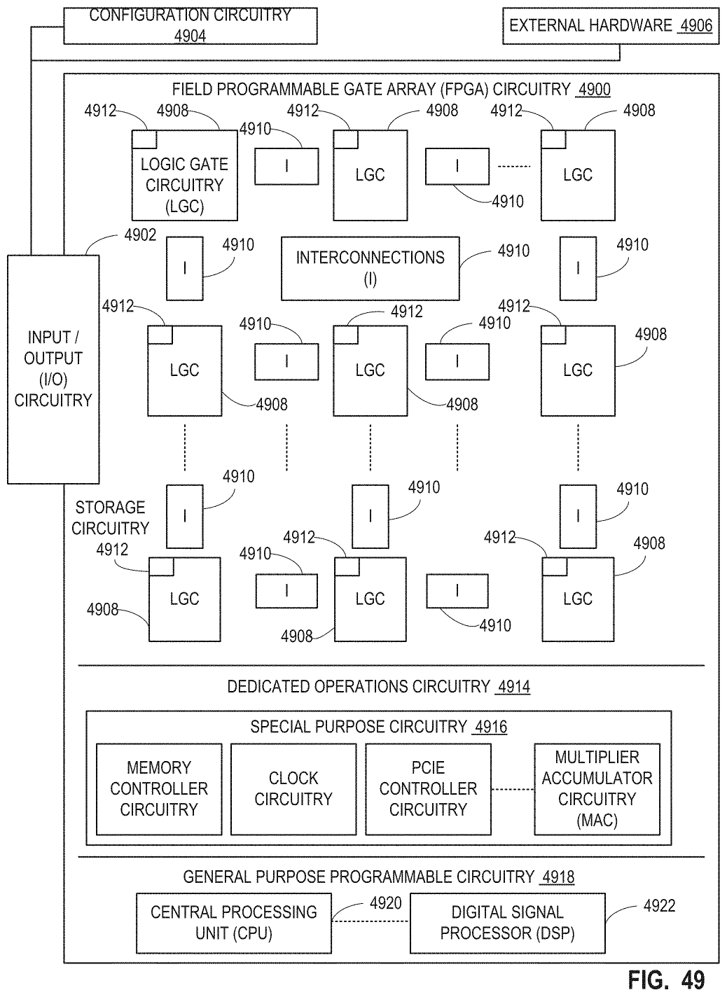

In some examples, the apparatus includes means for accessing a request. For example, the means for accessing may be implemented by the request accessor circuitry 2230. In some examples, the request accessor circuitry 2230 may be instantiated by processor circuitry such as the example processor circuitry 2612 of FIG. 26. For instance, the request accessor circuitry 2230 may be instantiated by the example general purpose processor circuitry 4800 of FIG. 48 executing machine executable instructions such as that implemented by at least block 2410 of FIG. 24. In some examples, the request accessor circuitry 2230 may be instantiated by hardware logic circuitry, which may be implemented by an ASIC or the FPGA circuitry 4900 of FIG. 49 structured to perform operations corresponding to the machine readable instructions. Additionally or alternatively, the request accessor circuitry 2230 may be instantiated by any other combination of hardware, software, and/or firmware. For example, the request accessor circuitry 2230 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example hardware data orchestration circuitry 2235 of the illustrated example of FIG. 22 determines whether any prior knowledge is present in the knowledge datastore 2245 for the selected hardware (e.g., the selected hardware identified in a request accessed by the request accessor circuitry 2230). If no prior knowledge is known for the selected hardware, the example hardware data orchestration circuitry 2235 adds an identification of the selected hardware to the knowledge datastore 2245. The identification of the hardware enables subsequent performance metrics associated with the selected hardware to be stored in the knowledge datastore 2245 in an organized fashion. In some examples, the identification of the selected hardware may be omitted prior to model creation and may, instead, be performed when performance metrics are provided to the knowledge datastore by the execution performance statistic collection circuitry 2285.

The example task data orchestration circuitry 2240 of the illustrated example of FIG. 22 determines whether any task information is available for the selected task. If no prior knowledge is available for the selected task, the example task data orchestration circuitry 2240 adds an identification of the selected task to the knowledge datastore 2245. The identification of the selected task enables subsequent performance metrics associated with the selected task to be stored in the knowledge datastore 2245 in an organized fashion. In some examples, the identification of the selected task may be omitted prior to model creation and may, instead, be performed when performance metrics are provided to the knowledge datastore by the execution performance statistic collection circuitry 2285.

In some examples, the apparatus includes means for generating task knowledge. For example, the means for generating task knowledge may be implemented by the example task data orchestration circuitry 2240. In some examples, the example task data orchestration circuitry 2240 may be instantiated by processor circuitry such as the example processor circuitry 2612 of FIG. 26. For instance, the example task data orchestration circuitry 2240 may be instantiated by the example general purpose processor circuitry 4800 of FIG. 48 executing machine executable instructions such as that implemented by at least blocks 2420, 2435, 2425 of FIG. 24. In some examples, the example task data orchestration circuitry 2240 may be instantiated by hardware logic circuitry, which may be implemented by an ASIC or the FPGA circuitry 4900 of FIG. 49 structured to perform operations corresponding to the machine readable instructions. Additionally or alternatively, the example task data orchestration circuitry 2240 may be instantiated by any other combination of hardware, software, and/or firmware. For example, the example task data orchestration circuitry 2240 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example knowledge datastore 2245 of the illustrated example of FIG. 22 is implemented by any memory, storage device and/or storage disc for storing data such as, for example, flash memory, magnetic media, optical media, solid state memory, hard drive(s), thumb drive(s), etc. Furthermore, the data stored in the example knowledge datastore 2245 may be in any data format such as, for example, binary data, comma delimited data, tab delimited data, structured query language (SQL) structures, etc. While, in the illustrated example, the knowledge datastore 2245 is illustrated as a single device, the example knowledge datastore 2245 and/or any other data storage devices described herein may be implemented by any number and/or type(s) of memories. In the illustrated example of FIG. 22, the example knowledge datastore 2245 stores hardware and/or task knowledge.

The model builder circuitry 2215 of FIG. 22 may be instantiated (e.g., creating an instance of, bring into being for any length of time, materialize, implement, etc.) by processor circuitry such as a central processing unit executing instructions. Additionally or alternatively, the model builder circuitry 2215 of FIG. 22 may be instantiated (e.g., creating an instance of, bring into being for any length of time, materialize, implement, etc.) by an ASIC or an FPGA structured to perform operations corresponding to the instructions. As noted above, it should be understood that some or all of the circuitry of FIG. 22 may, thus, be instantiated at the same or different times (and/or by different hardware circuitry). Some or all of the circuitry may be instantiated, for example, in one or more threads executing concurrently on hardware and/or in series on hardware. Moreover, in some examples, some or all of the circuitry of FIG. 22 may be implemented by one or more virtual machines and/or containers executing on the microprocessor.

The example model builder circuitry 2215 of the illustrated example of FIG. 22 includes search space management circuitry 2260, anchor point inserter circuitry 2265, neural architecture search circuitry 2270, and model outputter circuitry 2275. The model builder circuitry 2215 is responsible for extracting the insights in the knowledge datastore and executing neural architecture search to identify an optimal model. First, the example search space management circuitry 2260 creates a search space. This search space includes the operations provided by the task knowledge from the knowledge datastore, variants of those operations, and additional layers if the user specifies. The neural architecture search circuitry 2270 performs a search that is initiated with the configuration identified by the search space management circuitry 2260 for the objective, task, HW, etc. Anchor points are inserted in the chosen NAS algorithm by the anchor point inserter circuitry 2265 to capture the decisions made during this process. The task knowledge is incorporated in the training loop of the neural architecture search circuitry 2270 to inform decisions and guide the search. During training, historical decisions, confidence levels, and the knowledge datastore-based recommendations obtained from the task knowledge are used to guide the neural architecture search.

In some examples, the apparatus includes means for creating a search space. For example, the means for creating may be implemented by the example search space management circuitry 2260. In some examples, the example search space management circuitry 2260 may be instantiated by processor circuitry such as the example processor circuitry 2612 of FIG. 26. For instance, the example search space management circuitry 2260 may be instantiated by the example general purpose processor circuitry 2600 of FIG. 26 executing machine executable instructions such as that implemented by at least blocks 2427, 2440 of FIG. 24. In some examples, the example search space management circuitry 2260 may be instantiated by hardware logic circuitry, which may be implemented by an ASIC or the FPGA circuitry 4900 of FIG. 49 structured to perform operations corresponding to the machine readable instructions. Additionally or alternatively, the example search space management circuitry 2260 may be instantiated by any other combination of hardware, software, and/or firmware. For example, the example search space management circuitry 2260 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a machine learning model. For example, the means for generating may be implemented by the example neural architecture search circuitry 2270. In some examples, the example neural architecture search circuitry 2270 may be instantiated by processor circuitry such as the example processor circuitry 2612 of FIG. 26. For instance, the example neural architecture search circuitry 2270 may be instantiated by the example general purpose processor circuitry 4800 of FIG. 48 executing machine executable instructions such as that implemented by at least blocks 2430, 2450 of FIG. 24. In some examples, the example neural architecture search circuitry 2270 may be instantiated by hardware logic circuitry, which may be implemented by an ASIC or the FPGA circuitry 4900 of FIG. 49 structured to perform operations corresponding to the machine readable instructions. Additionally or alternatively, the example neural architecture search circuitry 2270 may be instantiated by any other combination of hardware, software, and/or firmware. For example, the example neural architecture search circuitry 2270 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for inserting. For example, the means for inserting may be implemented by the example anchor point inserter circuitry 2265. In some examples, the example anchor point inserter circuitry 2265 may be instantiated by processor circuitry such as the example processor circuitry 2612 of FIG. 26. For instance, the example anchor point inserter circuitry 2265 may be instantiated by the example general purpose processor circuitry 4800 of FIG. 48 executing machine executable instructions such as that implemented by at least block 2460 of FIG. 24. In some examples, the example anchor point inserter circuitry 2265 may be instantiated by hardware logic circuitry, which may be implemented by an ASIC or the FPGA circuitry 4900 of FIG. 49 structured to perform operations corresponding to the machine readable instructions. Additionally or alternatively, the example anchor point inserter circuitry 2265 may be instantiated by any other combination of hardware, software, and/or firmware. For example, the example anchor point inserter circuitry 2265 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

After generation of the model, the example model outputter circuitry 2275 provides a model for execution. In some examples, the decisions and/or rationales selected during the neural architecture search are made available in association with the generated model.

The target hardware 2220 of FIG. 22 may be instantiated (e.g., creating an instance of, bring into being for any length of time, materialize, implement, etc.) by processor circuitry such as a central processing unit executing instructions. Additionally or alternatively, the target hardware 2220 of FIG. 22 may be instantiated (e.g., creating an instance of, bring into being for any length of time, materialize, implement, etc.) by an ASIC or an FPGA structured to perform operations corresponding to the instructions. As noted above, it should be understood that some or all of the circuitry of FIG. 22 may, thus, be instantiated at the same or different times (and/or by different hardware circuitry). Some or all of the circuitry may be instantiated, for example, in one or more threads executing concurrently on hardware and/or in series on hardware. Moreover, in some examples, some or all of the circuitry of FIG. 22 may be implemented by one or more virtual machines and/or containers executing on the microprocessor.

The example target hardware 2220 of the illustrated example of FIG. 22 includes model execution circuitry 2280 and execution performance statistic collection circuitry 2285. The example model execution circuitry 2280 of the illustrated example of FIG. 22 executes the model provided by the model outputter circuitry 2275.

The example execution performance statistic collection circuitry 2285 of the illustrated example of FIG. 22, during execution of the model by the model execution circuitry 2280, collects model execution statistics using the inserted anchor points. The collected execution statistics are provided to the knowledge datastore 2245. In examples disclosed herein, the collected execution statistics include information about the anchor points. Including information about the anchor points enables statistics specific to particular features to be utilized when generating task knowledge.

FIG. 2 is a block diagram of an example process flow utilizing the example system of FIG. 22. The example process begins when a user submits a request for generation of a model to perform a selected task. (Blocks 2310). The requested model is generated using neural architecture search and prior knowledge of models associated with the selected task. (Block 220). The generated models are provided to the target hardware for execution and collection of performance statistics. (Blocks 230). Execution features are extracted from the models. (Block 240). The extracted features are ranked based on collected performance metrics. (Block 250). The extracted features and their associated performance metrics are added to the knowledge datastore 2245. (Block 260). This added knowledge may then subsequently be used for future generation of models. (Block 220).

While an example manner of implementing the example knowledge builder circuitry 2205 and/or the example model builder circuitry 2215 is illustrated in FIG. 22, one or more of the elements, processes, and/or devices illustrated in FIG. 22 may be combined, divided, re-arranged, omitted, eliminated, and/or implemented in any other way. Further, the example request accessor circuitry 2230, the example hardware data orchestration circuitry 2235, the example task data orchestration circuitry 2240, and/or more, generally, example knowledge builder circuitry 2205 of FIG. 22, and/or the example search space management circuitry 2260, the example anchor point inserter circuitry 2265, the example neural architecture search circuitry 2270, the example model outputter circuitry 2275, and/or, more generally, the example model builder circuitry 2215 of FIG. 22, may be implemented by hardware alone or by hardware in combination with software and/or firmware. Thus, for example, any of the example request accessor circuitry 2230, the example hardware data orchestration circuitry 2235, the example task data orchestration circuitry 2240, and/or more, generally, example knowledge builder circuitry 2205 of FIG. 22, and/or the example search space management circuitry 2260, the example anchor point inserter circuitry 2265, the example neural architecture search circuitry 2270, the example model outputter circuitry 2275, and/or, more generally, the example model builder circuitry 2215 of FIG. 22, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example request accessor circuitry 2230, the example hardware data orchestration circuitry 2235, the example task data orchestration circuitry 2240, and/or more, generally, example knowledge builder circuitry 2205 of FIG. 22, and/or the example search space management circuitry 2260, the example anchor point inserter circuitry 2265, the example neural architecture search circuitry 2270, the example model outputter circuitry 2275, and/or, more generally, the example model builder circuitry 2215 of FIG. 22 may include one or more elements, processes, and/or devices in addition to, or instead of, those illustrated in FIG. 22, and/or may include more than one of any or all of the illustrated elements, processes and devices.

A flowchart representative of example hardware logic circuitry, machine readable instructions, hardware implemented state machines, and/or any combination thereof for implementing the knowledge builder circuitry 2205 and/or the example model builder circuitry 2215 of FIG. 22 is shown in FIG. 24. The machine readable instructions may be one or more executable programs or portion(s) of an executable program for execution by processor circuitry, such as the processor circuitry 2612 shown in the example processor platform 2600 discussed below in connection with FIG. 26 and/or the example processor circuitry discussed below in connection with FIGS. 48 and/or 49.

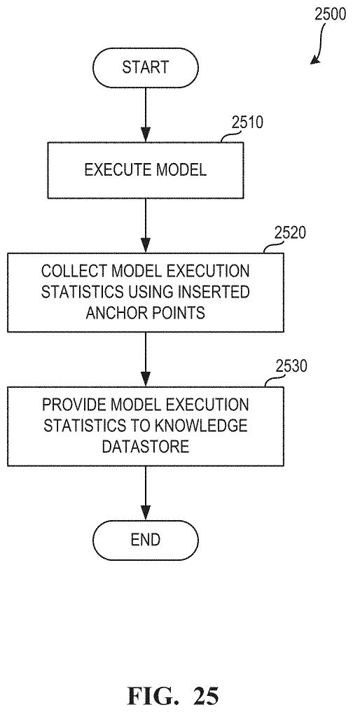

A flowchart representative of example hardware logic circuitry, machine readable instructions, hardware implemented state machines, and/or any combination thereof for implementing the target hardware 2220 of FIG. 22 is shown in FIG. 25. The machine readable instructions may be one or more executable programs or portion(s) of an executable program for execution by processor circuitry, such as the processor circuitry 2612 shown in the example processor platform 2600 discussed below in connection with FIG. 26 and/or the example processor circuitry discussed below in connection with FIGS. 48 and/or 49.

The programs of FIGS. 24 and/or 25 may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 24, many other methods of implementing the example knowledge builder circuitry 2205 and/or the example model builder circuitry 2215 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 24 and/or 25 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 24 is a flowchart representative of example machine readable instructions and/or example operations 2400 that may be executed and/or instantiated by processor circuitry to implement the example knowledge builder circuitry and the example model builder circuitry of FIG. 22. The machine readable instructions and/or the operations 2400 of FIG. 24 begin at block 2410, at which the request accessor circuitry 2230 receives a request for generation of a model to perform a selected task. (Block 2410). In examples disclosed herein, the user input 2210 received by the request accessor circuitry 2230 includes information including, for example, an objective of a machine learning model, a task to be performed by the machine learning model, and, in some examples, one or more characteristics of a target hardware on which the machine learning model is to be executed. The request may be formatted as, for example, a request received at a web server, a request formatted in a structured data format (e.g., a JavaScript object notation (JSON) format, an extensible markup language (XML) format, etc.). The example request accessor circuitry 2230 accesses hardware data orchestration information via the hardware data orchestration circuitry 2235 and task data orchestration information via the task data orchestration circuitry 2240. The accessed information (if available) and the request are provided to the search space management circuitry 2260 of the model builder circuitry 2215.

The example hardware data orchestration circuitry 2235 determines whether any prior knowledge is present in the knowledge datastore 2245 for the selected hardware. (Block 2412). If no prior knowledge is known for the selected hardware (e.g., block 2412 returns a result of NO), the example hardware data orchestration circuitry 2235 adds an identification of the selected hardware to the knowledge datastore 2245. (Block 2414). The identification of the hardware enables subsequent performance metrics associated with the selected hardware to be stored in the knowledge datastore 2245 in an organized fashion. In some examples, the identification of the selected hardware may be omitted prior to model creation and may, instead, be performed when performance metrics are provided to the knowledge datastore by the execution performance statistic collection circuitry 2285.

The example task data orchestration circuitry 2240 determines whether any task information is available for the selected task. (Block 2420). If no prior knowledge is available for the selected task (e.g., block 2420 returns a result of NO), the example task data orchestration circuitry 2240 adds an identification of the selected task to the knowledge datastore 2245. (Block 2425). The identification of the selected task enables subsequent performance metrics associated with the selected task to be stored in the knowledge datastore 2245 in an organized fashion. In some examples, the identification of the selected task may be omitted prior to model creation and may, instead, be performed when performance metrics are provided to the knowledge datastore by the execution performance statistic collection circuitry 2285. The example search space management circuitry 2260 creates a search space based on user selection of available building blocks or building blocks from existing state-of-the-art architecture(s) for the task. (Block 2427). In this manner, the search space is created, but is not based on specific prior task knowledge (as is described in connection with block 2440, below). In some examples, the ability to perform user selection of available building blocks (and/or whether to use state-of-the-art architecture(s) for the task) may be configurable by policy.

The example NAS search circuitry 2270 performs neural architecture search to generate a model using the search space. (Block 2430). In the illustrated example of FIG. 24, the NAS search circuitry 2270 starts from an uninitialized state. That is, no prior knowledge of performance of various tasks and/or hardware on which the tasks are to be executed is used when performing the neural architecture search of block 2430.

Returning to block 2420, if the task data orchestration circuitry 2240 determines that prior knowledge is present for the selected task (e.g., block 2420 returns a result of YES), the example task data orchestration circuitry 2240 builds task knowledge. (Block 2435). To build the task knowledge, model information is retrieved by the task data orchestration circuitry 2240 from the knowledge datastore 2245 for the specific task and features are extracted from the models. In cases of a new or custom task, similar tasks/models are retrieved based on the user input. These features include, but are not limited to, the framework used to train the model, the hardware specification and/or any information for mapping model (latencies, etc.) including hardware telemetry, the performance objective, sequence of operations, number of FLOPs, dataset used, number of layers, etc. These features are then ranked by hardware, objective, etc. The respective features extracted and ranked from the model(s) is collectively identified as the task knowledge which is then used to create the search space. In some examples, such task knowledge is archived in the knowledge datastore 2245 to allow for efficient retrieval should a same task be later requested.

The example search space management circuitry 2260 creates a search space from the prior task knowledge. (Block 2440). The search space may be created by, for example, ranking and selecting a prior architecture that had an acceptable level of performance on the target hardware (and/or hardware similar to the target hardware). In some examples, performance statistics stored in the knowledge datastore 2245 associated with different architectures and tasks are compared to select an architecture meeting a threshold performance statistic. In some examples, the performance statistic upon which the selection is based may be dependent upon the user input 2210 which may indicate, for example, whether power consumption statistics are to be prioritized over processing speed statistics.

In some examples, the selection of the prioritization (e.g., prioritization of functionality, performance, power optimization, etc.) may be guided by a policy. For example, a policy may be provided by a policy-providing entity to control behavior of the training operations and/or search space management. In some examples, the policy controls other details about the creation and/or training of the model including, for example, different levels of neural network sparsity (e.g., 260%, 90%, etc.), different levels of precision (e.g., thirty-two bit floating point values, sixteen-bit floating point values, eight bit integer values, etc.)

In some examples, the policy-providing entity may be a user of the system of FIG. 22. However, the policy-providing entity may be any other entity that guides functionality of the system of FIG. 22 including, for example, a system administrator, a manufacturer, a device provider, etc. In some examples, the policy-providing entity may be separate from the user. In this manner, the user is able to input requests for training and/or creation of a machine learning model, while allowing the parameters under which the training and/or creation of the machine learning model to be based on the policy created by the policy-providing entity.

In some examples the policy is provisioned to the system of FIG. 22 by the policy-providing entity via a platform Trusted Execution Environment (TEE). However, the policy may be provided to the system of FIG. 22 in any other manner.

The example NAS search circuitry 2270 generates a model using neural architecture search, based on the search space created by the search space management circuitry 2260. (Block 2450). In this manner, the neural architecture search performed by the NAS search circuitry 2270 at block 2450 starts from an initialized state based on the prior task knowledge (e.g., starting from an architecture which previously met a performance threshold).

The example anchor point inserter circuitry 2265 then inserts anchor points into the generated model. (Block 2460). Anchor points provide locations at which performance statistics are to be measured by the execution performance statistic collection circuitry 2285. Moreover, the anchor points provide locations by which additional information about the model and/or the objectives/tasks of the model may be captured. In examples disclosed herein, anchor points are inserted intermediate respective layers of the generated model. In some examples, anchor points are added to the model prior to the first layer and after the last layer of the model. In some other examples, anchor points are added adjacent (e.g., before and after) particular types of layers (e.g., a convolution layer).

The example model outputter circuitry 2275 provides the generated model to the target hardware 2220 for execution by the model execution circuitry 2280. (Block 2470). In examples disclosed herein, the model may first be stored at a storage location (e.g., a server) before being provided to the model execution circuitry 2280. In some examples, the model execution circuitry 2280 may retrieve the model from the storage location or directly from the model outputter circuitry 2275. The process of the illustrated example of FIG. 24 then terminates, but by may be re-executed upon, for example, receipt of subsequent user input 2210.

FIG. 25 is a flowchart representative of example machine readable instructions and/or example operations 2500 that may be executed and/or instantiated by processor circuitry to implement the example target hardware 2220 of FIG. 22. The machine readable instructions and/or the operations 2500 of FIG. 25 begin at block 2510, at which the model execution circuitry 2280 begin execution of a model received from the model outputter circuitry 2275. (Block 2510). During execution of the model, the example execution performance statistic collection circuitry 2285 collects model execution statistics using the inserted anchor points. (Block 2520). The collected execution statistics are provided to the knowledge datastore 2245. (Block 2530). In examples disclosed herein, the collected execution statistics include information about the anchor points. Including information about the anchor points enables statistics specific to particular features to be utilized when generating task knowledge.

FIG. 26 is a block diagram of an example processor platform 2600 structured to execute and/or instantiate the machine readable instructions and/or the operations of FIGS. 24 and/or 25 to implement the system 2200 of FIG. 22. The processor platform 2600 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2600 of the illustrated example includes processor circuitry 2612. The processor circuitry 2612 of the illustrated example is hardware. For example, the processor circuitry 2612 can be implemented by one or more integrated circuits, logic circuits, FPGAs, microprocessors, CPUs, GPUs, DSPs, and/or microcontrollers from any desired family or manufacturer. The processor circuitry 2612 may be implemented by one or more semiconductor based (e.g., silicon based) devices. In this example, the processor circuitry 2612 implements the knowledge builder circuitry 2205 and the model builder circuitry 2215. In some examples, the knowledge builder circuitry 2205 and the model builder circuitry 2215 may be implemented on separate processor platforms.

The processor circuitry 2612 of the illustrated example includes a local memory 2613 (e.g., a cache, registers, etc.). The processor circuitry 2612 of the illustrated example is in communication with a main memory including a volatile memory 2614 and a non-volatile memory 2616 by a bus 2618. The volatile memory 2614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2616 may be implemented by flash memory and/or any other desired type of memory device. Access to the main memory 2614, 2616 of the illustrated example is controlled by a memory controller 2617.

The processor platform 2600 of the illustrated example also includes interface circuitry 2620. The interface circuitry 2620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2622 are connected to the interface circuitry 2620. The input device(s) 2622 permit(s) a user to enter data and/or commands into the processor circuitry 2612. The input device(s) 2622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2624 are also connected to the interface circuitry 2620 of the illustrated example. The output device(s) 2624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2620 of the illustrated example, thus, typically includes a graphics driver card, a graphics driver chip, and/or graphics processor circuitry such as a GPU.

The interface circuitry 2620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2600 of the illustrated example also includes one or more mass storage devices 2628 to store software and/or data. Examples of such mass storage devices 2628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 2632, which may be implemented by the machine readable instructions of FIGS. 24 and/or 25, may be stored in the mass storage device 2628, in the volatile memory 2614, in the non-volatile memory 2616, and/or on a removable non-transitory computer readable storage medium such as a CD or DVD.

From the foregoing, it will be appreciated that example systems, methods, apparatus, and articles of manufacture have been disclosed that enable neural architecture search to be performed based on prior knowledge of models created to perform particular tasks. Disclosed systems, methods, apparatus, and articles of manufacture improve the efficiency of using a computing device by avoiding re-discovery of models that would otherwise be initially discovered by neural architecture search, but that do not function well for the intended task. By starting from based on prior knowledge, higher performing models can be identified more quickly. This reduces resource consumption not only on the target hardware (e.g., more efficient models can be developed), but also reduces resource consumption on systems that generate models (e.g., higher performing models can be discovered more quickly/efficiently). Disclosed systems, methods, apparatus, and articles of manufacture are accordingly directed to one or more improvement(s) in the operation of a machine such as a computer or other electronic and/or mechanical device.

### Methods and Apparatus to Conditionally Activate a Big Core in a Computing System

Some computing systems include one or more big device processors (e.g., cores) and/or one or more small device processors (e.g., atoms) to perform operations. A big device processor may include one or more cores and/or processing units while a small device processor may have one or two cores. Additionally, the big device processor is more powerful and/or consumes more space than a small device processor. A big device processor can handle high performance applications while a small device processor offers lower power, a smaller footprint, and more modest performance compared to big device processors. Examples of small device processors include Intel® Atom®, Intel® Quark® SoC, LITTLE cores, etc.

Hardware-based microcode (also referred to as hardware level instructions) can be implemented in the hardware of a computing system (e.g., a computer, a laptop, a mobile phone, a server, an edge device, a cloud-based device, etc.) to configure the hardware of the computing system. In some examples, such hardware level instructions (e.g., uCode, XuCode, etc.) can control operation of the hardware, including processing devices. If a computing device includes multiple processing devices (e.g., big cores, little cores, atoms, central processing unit (CPU) sockets, CPU, slots, etc.), the microcode can facilitate the operation and/or configuration of the multiple processing devices.

As the number and/or types of architectures increase, the difficulty in programming instructions increases because there may need to be a separate configuration of instructions for each type of architecture. For example, instructions may be 2724 bit instructions structured to be executed by hardware that can handle the 2724 bit instructions. Similarly, a system with multiple smaller processing units that handle 64 bit instructions will not be able execute instructions above 64 bits.

Examples disclosed herein provide a software and/or firmware based application programming interface (API) to process instructions from an application running on an operating system, virtual machine manager (VMM), etc., and instruct microcode to configure the processing units to be able to execute the instructions, regardless of how the instructions are structured. For example, if a 512-bit instruction is obtained from an application, examples disclosed herein can configure eight 64-bit processing units to break up the 512-bit instruction into eight 64-bit instructions, execute the 64-bit instructions in parallel, and combine the results, thereby operating as a conditionally activated big core (e.g., a big core capable of handing the 512 bit instruction). In this manner, the application can generate one instruction and examples disclosed herein can determine if and/or how to execute the instruction given the constraints of the computing system via which it is to be executed.

The example disclosed API obtains ISA instructions from the OS/VMM. An ISA instruction is an instruction that calls for multiple processing devices to operate as a single big processing device capable of handing the ISA instruction. When the disclosed API obtains an ISA request to execute ISA instructions from an application (e.g., as an interrupt), the API first determines if the processing units are capable and/or available to execute the instructions while meeting the service level agreements (SLAs), latency requirements, tolerance requirements, etc. corresponding to the instructions. If the API determines that the processing units are capable and available to execute the instructions while meeting the requirements, the API instructs the microcode to cause the processing units to execute the instructions according to the requirements. If the API determines that the processing units are capable but not available to execute the instruction, the API may indicate (1) (e.g., to the application) when the processing units will be available (e.g., an approximation of when a currently implemented workload will be complete) and/or (2) that the big core can be emulated, but the requirements may not be met. In this manner, the application can determine whether to wait to execute the instruction to meet the requirements, proceed with emulation while not meeting one or more of the requirements, or not to execute the instruction with the corresponding processing elements. If the API determines that the processing units are not capable of executing the instruction, the API indicates (e.g., to the application), that the instruction cannot be executed.

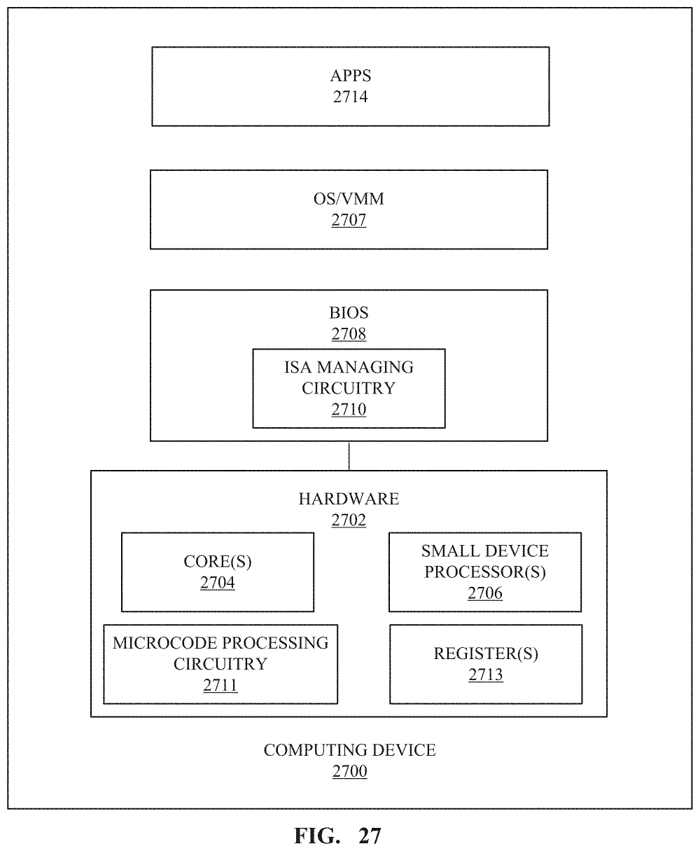

FIG. 27 is a block diagram of an example computing device 2700. The example computing device 2700 includes example hardware 2702, which includes one or more example cores 2704, one or more example small device processors 2706, example microcode processing circuitry 2711, and example register(s) 2713. The example computing device 2700 further includes example BIOS 2708 that includes example ISA managing circuitry 2710. The example computing device 2700 further includes an example operating system (OS)/virtual machine manager (VMM) 2707 and example applications (APPS) 2714.

The example hardware 2702 of FIG. 27 performs tasks corresponding to instructions from the applications 2714, OS/VMM 2722 and/or BIOS 2708. The example hardware 2702 may include processor resources (e.g., memory, register(s) and/or logic circuitry of the example processor core(s) 2704 and/or small device processor(s) 2706) to execute instructions to implement the instructions of the example applications 2714 and/or access data from memory.

The example processor core(s) 2704 and/or the example small device processor(s) 2706 of FIG. 27 execute(s) instructions (e.g., a workload) from an application (e.g., by reading and/or writing data). Tasks executed on one or more core(s) 2704 may result in a different amount of time to complete and/or a different efficiency than the same tasks being executed on the one or more small device processors 2706. For example, the one or more cores 2704 may be more efficient with respect to iterations per cycle (IPC) ratios when executing compute-bound tasks. Additionally, the one or more cores 2704 may have a larger cache than the small device processors 2706 for executing cache bound tasks. The one or more small device processors 2706 may be more efficient for memory-bound tasks that correspond to more time in pipe stall waiting for memory and/or may be more efficient for I/O bound tasks, as IO bound tasks do not depend on processing operating speed. Although the example hardware 2702 includes the core(s) 2704 and the small device processor(s) 2706, the hardware 2702 can include any number and/or type of processing components (e.g., little core, big core, threads, etc.). Examples of small device processors 2706 include Intel® Atom®, Intel® Quark® SoC, LITTLE cores, etc. As further described above, two or more of the core(s) 2704 and/or the small device processor(s) 2706 may work together (e.g., based on instructions from the ISA managing circuitry 2710 and/or the microcode processing circuitry 2711) to split a large instruction into sub-instructions and execute on corresponding processing devices. In this manner, the application 2714 and/or OS/VMM 2707 can transmit a single instruction that a single core or small device processor cannot execute alone and the core(s) 2704 and/or small device processors(s) 2706 can work together as a bigger computing device to execute the single instruction.

The example OS/VMM 2707 of FIG. 27 is a software system managing the example hardware 2702 of the computing device 2700, software resources, and/or provides servers for computer programs and/or applications. The OS/VMM 2707 of FIG. 27 transmits instructions and/or an ISA execution request to the ISA managing circuitry 2710 to cause the ISA managing circuitry 2710 to control the processing resources (e.g., the core(s) 2704 and/or the small device processor(s) 2706) to operate as a big core. In some examples, the OS/VMM 2707 stores the instructions and/or ISA execution request in the example register(s) 2713 that the ISA managing circuitry 2710 monitors. In this manner, the OS/VMM 2707 can cause an interrupt to occur for facilitation of the ISA execution when new data is placed in the register 2713.

The example BIOS 2708 of FIG. 27 provides low-level control over the hardware 2702 of the computing device 2700. For example, the BIOS 2712 to may use the example core(s) 2704 and/or small device processor(s) 2706 to execute instructions and/or perform operations to operate as a big core. The BIOS 2708 can perform hardware initialization and/or provide runtime services for the OS/VMM 2707 and/or other programs. Although the example computing device 2700 of FIG. 27 includes the BIOS 2708, the BIOS 2708 can be replaced with EFI, UEFI, and/or any other type of firmware that is capable of interfacing between hardware and the OS/VMM 2707. The example BIOS 2708 includes the example ISA managing circuitry 2710.

The example ISA managing circuitry 2710 of FIG. 27 obtains instructions (e.g., to perform an ISA execution with processor resources operating as a big core) from the application via the OS/VMM 2707. In some examples, the ISA managing circuitry 2710 determines that the OS/VMM 2707 has requested the processing components of the hardware 2702 to operate as a big core by monitoring a change in data in one or more registers 2713 of the hardware 2702. For example, the OS/VMM 2707 may, when it requires or requests big core operation, place data in the one or more registers 2713 to indicate the big core operation (e.g., as an interrupt). Thus, the ISA managing circuitry 2710 may monitor the register 2713 (e.g., like an interrupt) to determine when to facilitate the big core operation.

When the example ISA managing circuitry 2710 of FIG. 27 determines that big core operation is to occur, the ISA managing circuitry 2710 determines the ISA requirements (SLAs, latency requirements, tolerance requirements, etc.) of the instructions that are to be executed by the big core structure. For example, if the instructions are stored in one or more of the register(s) 2713, the ISA managing circuitry 2710 processes the ISA instructions to identify the requirements. The ISA managing circuitry 2710 evaluates whether the processing resources (e.g. one or more of the core(s) 2704 and/or the small device processing components 2706) are capable and/or available to handle ISA execution as a big core according to the determined requirements. In some examples, because the processing resources may be executing other workloads, one or more of the processing resources may be capable of handing the ISA execution but not currently available to execute the instructions. In some examples, the processing resources may not be capable of handling the ISA execution. For example, the processing resources may be structured to handle integer based instructions. In such an example, if the OS/VMM 2707 transmit instructions to handle a floating point number, the processing resources may not be capable of handling such a resource. Accordingly, the example ISA managing circuitry 2710 determines whether the processing resources are available and/or capable of executing instructions from the OS/VMM 2707 corresponding to the ISA execution.

If the example ISA managing circuitry 2710 of FIG. 27 determines that the processing resources are capable and available to execute the ISA execution by combining operation of multiple ones of the core(s) 2704 and/or the smaller processing components 2706 to operate as a big core, the example ISA managing circuitry 2710 instructs the microcode processing circuitry 2711 of the hardware 2702 to cause the core(s) 2704 and/or the smaller processing components 2706 to operate as a big core. If the example ISA managing circuitry 2710 of FIG. 27 determines that the processing resources are capable but not available to execute the instructions (e.g., only a portion of the processing resources is available), the example ISA managing circuitry 2710 can (a) determine when sufficient processor resources will be available to operate as a big core (e.g., based on when a current workload and/or scheduled workload(s) will be complete) and/or (b) whether emulation of the big core is possible. The combination of small devices processors that are capable of acting as a bigger processing device is policy configurable and may be enforced via a platform trusted execution environment (TEE). Emulation is possible when the available processor resources are capable of executing as a big core but the execution will not satisfy all of the requirements. For example, the ISA managing circuitry 2710 may determine that a 512 bits per cycle is not possible, but a 256 bits per cycle is possible. In such an example, the 512 bit instruction could be performed in two 256 bit cycles as opposed to one 512 bit cycle. Accordingly, although the instruction can be complete, it will be complete at half the 512 bit cycle requirement. The example ISA managing circuitry 2710 may transmit the information regarding emulation and/or when additional resources will be available to the example OS/VMM 2707. In this manner, the OS/VMM 2707 can determine whether to wait, proceed with emulation, and/or not move forward based on the information from the ISA managing circuitry 2710. In some examples, the OS/VMM 2707 and the ISA managing circuitry 2710 can negotiate terms for emulation. If the example ISA managing circuitry 2710 determines that the processor resources are not capable of operating as a big core and/or not capable of executing the instruction, the ISA managing circuitry 2710 can generate an exception (e.g., also referred to as a trap and/or block) for the ISA execution and inform that OS/VMM 2707 that it will not execute the instruction because it is not capable. The example ISA managing circuitry 2710 is further described below in conjunction with FIG. 27.

The example microcode processing circuitry 2711 of FIG. 27 is hardware that executes microcode (e.g., Xucode, etc.) to control operation of the example core(s) and/or small device processor(s) 2706. For example, if the small device processor(s) 2706 are 64 bit per cycle processors and the ISA managing circuitry 2710 instructs the microcode processing circuitry 2711 to operate as a big core executing a 512 bit per cycle instruction, the microcode processing circuitry 2711 will split the 512 bit instruction into eight 64 bit instructions, cause eight of the 64 bit cycle small device processors 2706 to execute a corresponding 64 bit instruction and combine the results to output a result. For example, the microcode processing circuitry 2711 can divide and/or group the instruction into smaller parts or sub-instructions. The smaller sub-instruction are loaded into the smaller device processors 2706 and the microcode processing circuitry 2711 does a combination of accumulation in the larger register space of a temporary storage (e.g., a virtual register). For example, if the small device processors 2706 only support 256-bit width, a 512 bit operation is obtained, and the small device processors 2706 have a 512 bit accumulation register, the small device processors 2706 can use the accumulation register and/or configure the accumulation register can be configured in SRAM for the operation Additional operations may include multiplication, additive encryption, etc. In this manner, the 512 bit instruction can be executed by eight small device processors acting as a big core. If the microcode processing circuitry 2711 identifies an error during the execution, the microcode processing circuitry 2711 can return an error to the ISA managing circuitry 2710 to identify that the ISA execution failed and prevent a crash. The example microcode processing circuitry 2711 is further described below in conjunction with FIG. 27.

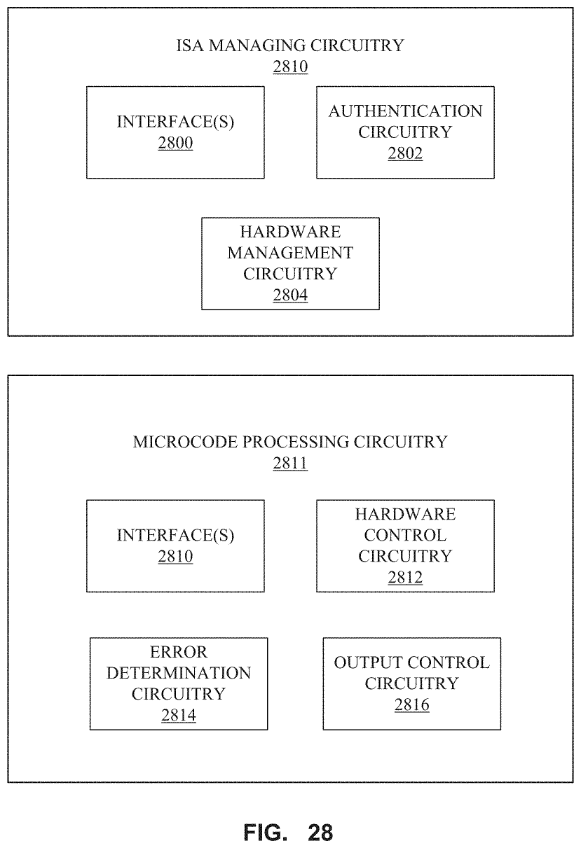

FIG. 28 is a block diagram of an example implementation of the example ISA managing circuitry 2710 and the microcode processing circuitry 2711 of FIG. 27. The example ISA managing circuitry 2710 includes one or more example interface(s) 200, example authentication circuitry 2802, and example hardware management circuitry 2804. The example microcode processing circuitry 2711 includes one or more example interface(s) 210, example hardware control circuitry 2812, example error determination circuitry 2814, and example output control circuitry 2816.

The example interface(s) 200 of the ISA managing circuitry 2710 of FIG. 28 obtain(s) instructions to perform an ISA execution by using multiple processing devices to operate as a big core. In some examples, the ISA managing circuitry 2710 obtains the instructions directly from the OS/VMM 2707 of FIG. 27. In some examples, the OS/VMM 2707 writes data into the register 2713 when ISA execution is desired. In such examples, the interface(s) 200 access the data in the register 2713 to allow the hardware management circuitry 2804 to determine whether ISA execution is possible. Additionally, the example interface 2800 transmits instructions to the microcode processing circuitry 2711 to cause the processing resources to operate according to the ISA execution request from the OS/VMM 2707.

The example authentication circuitry 2802 of FIG. 28 authenticates ISA execution requests and/or instructions to verify that a request is valid and/or authentic. To verify an ISA execution request, the example authentication circuitry 2802 may (a) match the CPU in the platform, (b) check the header, loader version, and/or checksum of the ISA execution request, (c) perform the authenticity and/or signature check pass, and/or (d) utilize any validation technique. The example authentication circuitry 2802 can match the CPU in the platform with provisioned CPU ID/Manifest via factory provisioning during manufacturing (e.g., fuse settings) or field provisioning via a firmware/microcode patch. The CPU matching can be controlled dynamically post deployment in the filed via policies and/or out-of-the-band manageability via platform trusted execution environment (TEE). If the ISA execution request is not valid and/or authentic, the authentication circuitry 2802 may inform the OS/VMM 2707 that the ISA execution request could not be validated and/or return control to the OS/VMM 2707.

The example hardware management circuitry 2804 of FIG. 28 obtains validated ISA execution requests and determines how to execute the ISA execution requests based on the requirements of the ISA execution request, the availability and/or capability of the processing resources (e.g., the core(s) 2704 and/or the small device processor(s) 2706), and any policies. A policy may be a user and/or manufacturer designed policy that identifies whether an ISA execution should be executed, should be emulated, and/or should be blocked based on various factors. The hardware management circuitry 2804 monitors the capability and/or the availability of the processor resources (e.g., the core(s) 2704 and/or the small device processor(s) 2706). If an ISA request corresponds to executing an X bits per cycle instruction that includes a floating point operation, the hardware management circuitry 2804 determines whether the processing resources are available and capable of handing the ISA execution request at X bits per cycle for a floating point operation. For example, if the total bits per cycle provided by two or more available processor resources capable are equal to or exceed the X bits per cycle, the hardware management circuitry 2804 may determine that ISA execution is available and instruct the microcode processing circuitry 2711 to coordinate the execution of the ISA execution as a big core using the two or more processor resources (e.g., the core(s) 2704 and/or the small device processor(s) 2706).

Additionally, the example hardware management circuitry 2804 of FIG. 28 may determine that two or more processor resources are capable of performing the floating point operation, but not according to the requirements of the ISA execution. If the hardware management circuitry 2804 determines that the ISA execution requirements cannot be met, the hardware management circuitry 2804 can identify when the requirements can be met and/or may generate an emulation protocol to execute the ISA request but not according to the requirements. In this manner, the hardware management circuitry 2804 can negotiate with the OS/VMM 2707 to determine whether to proceed with emulation, not proceed, and/or wait until additional resources are available. If the hardware management circuitry 2804 determines that the ISA execution is not possible and/or may not be possible in the future, the hardware management circuitry 2804 transmits a response (e.g., via the interface(s) 200) to the OS/VMM 2707 to indicate that the ISA execution is not possible. If the example hardware management circuitry 2804 determines that the processing resources are not able to handle the ISA execution request (e.g., regardless of the availability), the example hardware management circuitry 2804 generates an exception of ISA execution block to prevent execution of the ISA execution and indicates that the processing resources are not capable of executing the ISA execution to the example OS/VMM 2707. After the hardware management circuitry 2804 determines how to handle the ISA execution request, the hardware management circuitry 2804 instructs the microcode processing circuitry 2711 to control the processing resources accordingly.

The example interface 2810 of the microcode processing circuitry 2711 of FIG. 28 obtains instructions regarding the execution of ISA execution request from the ISA managing circuitry 2710. Additionally, the example interface(s) 210 obtains ISA-based instructions for ISA execution. After the ISA instructions are complete, the interface(s) 210 transmit the output to the OS/VMM 2707 (e.g., directly or via the BIOS 2708).

The example hardware control circuitry 2812 of FIG. 28 determines how to structure the processing resources (e.g., the example core(s) 2704 and/or the example small device processor(s) 2706) to execute the ISA execution based on the instructions from the ISA managing circuitry 2710. For example, the hardware control circuitry 2812 may break an ISA instruction into sub-instructions that can be executed by the available processing resources and provide the sub-instructions to the corresponding processing resources (e.g., via the interface(s) 210). For example, if a 2728 bit instruction is obtained, the hardware control circuitry 2812 may break the 2728 bit instruction into two 64 bit sub-instructions to be executed by two 64-bit small device processors (e.g., the first sub-instruction to the first small device processor and the second sub-instruction to the second small device processor). In this manner, the processing resources can execute the larger instruction without the use of a larger processing resource.

The example error determination circuitry 2814 of FIG. 28 monitors the execution of the ISA execution for errors. For example, if an instruction results in a divide by zero, infinite loop, and/or other instruction error, the error determination circuitry 2814 can identify the error, stop execution, and return a message to the OS/VMM 2707 indicating that the instruction execution could not be completed. In this manner, the error determination circuitry 2814 can prevent crashes from occurring.

The example output control circuitry 2816 of FIG. 28 obtains the multiple outputs from the multiple processing resources and combines the outputs to generate a single output. For example, if the hardware control circuitry 2812 split a 2728 bit instruction into two 64 bit instructions for two 64-bit processing resources, the output control circuitry 2816 obtains the first output from the first processing resource and the second output from the second processing resource and combines the outputs to generate a 2728 bit output. The output control circuitry 2816 transmits the output to the OS/VMM 2707 via the interface(s) 2810.

While an example manner of implementing the ISA managing circuitry 2710 and/or the microcode processing circuitry 2711 of FIG. 27 is illustrated in FIG. 2, one or more of the elements, processes, and/or devices illustrated in FIG. 28 may be combined, divided, re-arranged, omitted, eliminated, and/or implemented in any other way. Further, the example interface(s) 200, the example authentication circuitry 2802, the example hardware management circuitry 2804, the example interface(s) 210, the example hardware control circuitry 2812, the example error determination circuitry 2814, the example output control circuitry 2816, and/or, more generally, the ISA managing circuitry 2710 and/or the microcode processing circuitry 2711 of FIGS. 27-2, may be implemented by hardware, software, firmware, and/or any combination of hardware, software, and/or firmware. Thus, for example, any of the example interface(s) 200, the example authentication circuitry 2802, the example hardware management circuitry 2804, the example interface(s) 210, the example hardware control circuitry 2812, the example error determination circuitry 2814, the example output control circuitry 2816, and/or, more generally, the ISA managing circuitry 2710 and/or the microcode processing circuitry 2711 of FIGS. 27-2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the ISA managing circuitry 2710 and/or the microcode processing circuitry 2711 of FIGS. 27-2 is/are hereby expressly defined to include a non-transitory computer readable storage device or storage disk such as a memory, a digital versatile disk (DVD), a compact disk (CD), a Blu-ray disk, etc., including the software and/or firmware. Further still, the ISA managing circuitry 2710 and/or the microcode processing circuitry 2711 of FIGS. 27-28 may include one or more elements, processes, and/or devices in addition to, or instead of, those illustrated in FIG. 27-28, and/or may include more than one of any or all of the illustrated elements, processes, and devices.

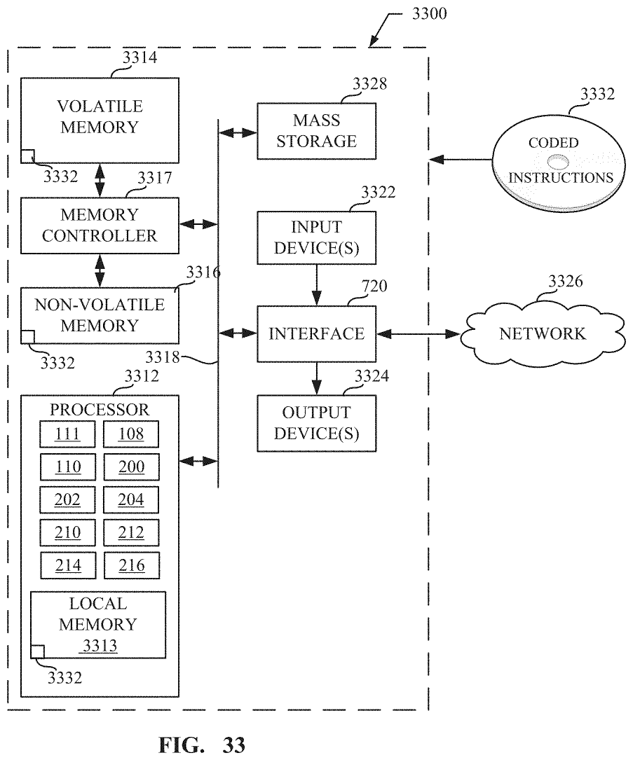

Flowcharts representative of example hardware logic circuitry, machine readable instructions, hardware implemented state machines, and/or any combination thereof for implementing the ISA managing circuitry 2710 and/or the microcode processing circuitry 2711 of FIGS. 27-2 are shown in FIGS. 3-5. The machine readable instructions may be one or more executable programs or portion(s) of an executable program for execution by processor circuitry, such as the processor circuitry 3312 shown in the example processor platform 3300 discussed below in connection with FIG. 33 and/or the example processor circuitry discussed below in connection with FIG. 48. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 2, many other methods of implementing the computing device 2700, the ISA managing circuitry 2710, and/or the microcode processing circuitry 2711 of FIGS. 27-2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

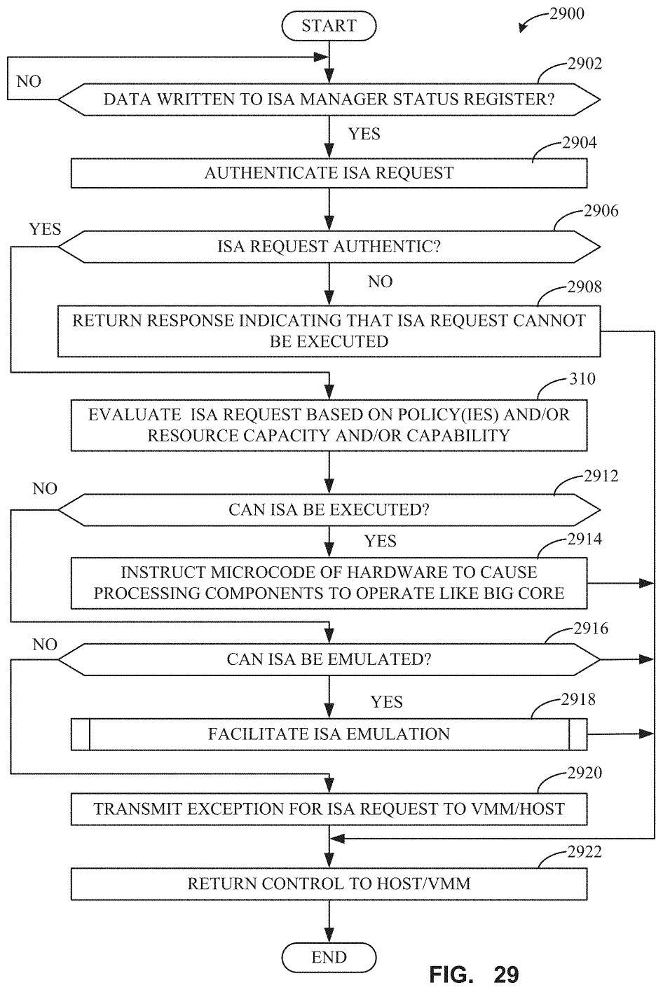

FIG. 29 is a flowchart representative of example machine readable instructions and/or example operations 2900 that may be executed and/or instantiated by processor circuitry (e.g., the example ISA managing circuitry 2710 of FIG. 2) to handle an ISA execution request. The instructions begin at block 2902 when the example hardware management circuitry 2804 determines if data has been written into the ISA manager status register (e.g., one or more of the registers 2713 of FIG. 27). As described above, the OS/VMM 2707 may write data into the register 2713 to set off an interrupt when an ISA execution is to occur. In some examples, the OS/VMM 2707 may transmit the instructions directly to the ISA managing circuitry 2710.

If the example hardware management circuitry 2804 determines that data has not been written to the ISA manager status register 2713 (block 2902: NO), control returns to block 2902. If the example hardware management circuitry 2804 determines that data has been written to the ISA manager status register 2713 (block 2902: YES), the example authentication circuitry 2802 authenticates the ISA execution request corresponding to the data in the ISA manager status register 2713 (block 2904). As described above in conjunction with FIG. 2, the example authentication circuitry 2802 can authenticate the ISA request using any authentication technique to determine that the ISA execution request is valid.

If the example authentication circuitry 2802 determines that the ISA request is not authentic (block 306: NO), the authentication circuitry 2802 returns a response to the OS/VMM 2707 indicating that the ISA request cannot be executed (block 2908) and control continues to block 2922. If the example authentication circuitry 2802 determines that the ISA request is authentic (block 306: YES), the example hardware management circuitry 2804 evaluates an ISA request based on one or more polarities, resource capacity, and/or resource capability (block 310). For example, the hardware management circuitry 2804 may process one or more policies to determine how to handle the request and/or may determine whether the available processor resources are capable of handing the request.

At block 2912, the example hardware management circuitry 2804 determines whether the ISA can be executed per the requirements corresponding the ISA execution (e.g., latency, bit rate, etc.) and/or per the one or more policies. For example, the hardware management circuitry 2804 determines whether the processor resources are capable and/or available to handle the ISA execution. If the hardware management circuitry 2804 determines that the ISA request can be executed by the processor resources (block 2912: YES), the example hardware management circuitry 2804 instructs the microcode of the hardware (e.g., the microcode ISA managing circuitry 2711) to cause the processing components to operate like a big core to handle the ISA execution (block 314). For example, the hardware management circuitry 2804 can provide the ISA execution instructions and/or requirements to the microcode to cause the microcode to facilitate the ISA execution with the corresponding processor resources.

If the hardware management circuitry 2804 determines that the ISA request cannot be executed by the processor resources (block 2912: NO), the example hardware management circuitry 2804 determines whether the processor resources can emulate the ISA execution and/or execute the ISA request at a later time (block 2916) (e.g., based on policy(ies), resource capability, and/or resource availability). If the example hardware management circuitry 2804 determines that emulation should occur (block 2916: YES), the example ISA managing circuitry 2710 facilitates execution of ISA emulation (block 2918), as further described below in conjunction with FIG. 29.

If the example hardware management circuitry 2804 determines that emulation should not occur (block 2916: NO), the example hardware management circuitry 2804 creates an exception for and/or blocks the ISA request to the VMM/host 2706 (e.g., via the interface(s) 200) to indicate that the ISA request cannot be executed (block 2920). At block 2922, the example hardware management circuitry 2804 returns control to the example OS/VMM 2707.

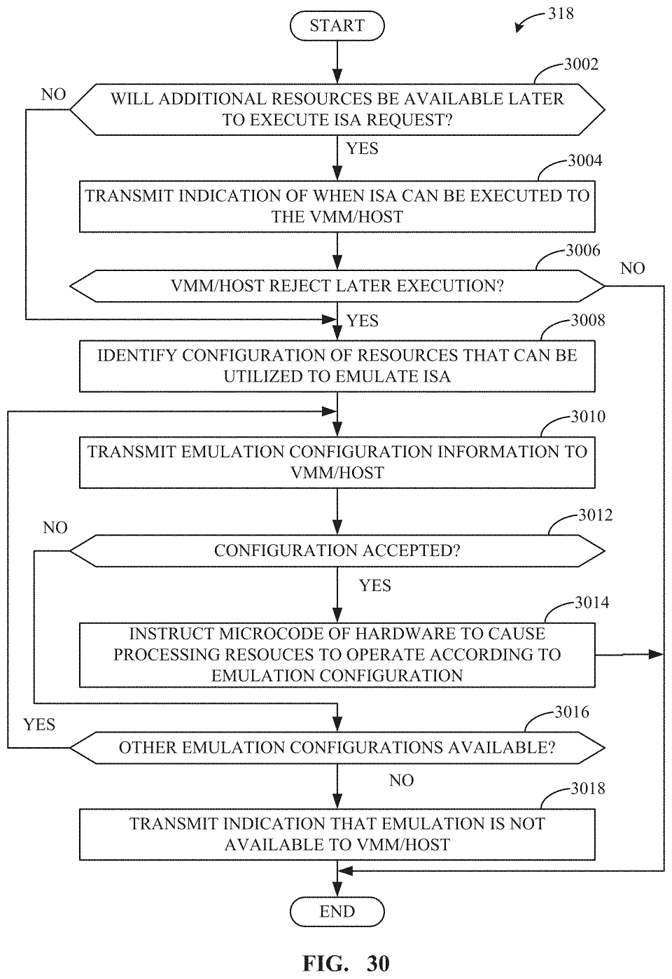

FIG. 30 is a flowchart representative of example machine readable instructions and/or example operations that may be executed and/or instantiated by processor circuitry (e.g., the ISA managing circuitry 2710 of FIG. 2) to facilitate ISA emulation, in conjunction with block 2918 of FIG. 29.

The machine readable instructions and/or operations corresponding to block 2918 of FIG. 30 begin at block 3002, when the example hardware management circuitry 2804 determines whether additional resources will be available later to execute the ISA execution corresponding to the ISA request. For example, the hardware management circuitry 2804 may determine whether additional hardware (e.g., sufficient resources to execute the ISA execution according to and/or more closely aligned with the policy(ies) and/or parameter(s)) are currently executing one or more workload(s), but will be free for the ISA execution after the one or more workloads are complete.

If the example hardware management circuitry 2804 determines that additional resources will not be available later to execute the ISA execution corresponding to the ISA request (block 3002: NO), control continues to block 3008. If the example hardware management circuitry 2804 determines that that additional resource will be available later to execute the ISA execution corresponding to the ISA request (block 3002: YES), the example hardware management circuitry 2804 instructs the interface(s) 200 to transmit an indication of when the ISA instructions can be executed by the processor resources to the example OS/VMM 2707 (block 3004). For example, the hardware management circuitry 2804 may determine and/or estimate when the currently unavailable processor resource will be available based on the speed of the currently unavailable resources and the amount of workload left to complete.

At block 3006, the example hardware management circuitry 2804 determines whether the OS/VMM 2707 has rejected the later execution based on a response from the OS/VMM 2707. For example, after the indication is sent to the OS/VMM 2707 regarding when the processing resources will be available, the OS/VMM 2707 can determine whether it wants to wait for full execution for the ISA instructions or move forward with immediate emulation. In some examples, if the OS/VMM 2707 determines to wait for the additional resources to become available (e.g., based on user and/or manufacturer preferences that indicate when to wait for the resources to be fully available if not currently avaiable), control can return to the OS/VMM 2707 and the OS/VMM 2707 can submit a subsequent request based on the identified time when the resources will be available. In some examples, if the OS/VMM 2707 decides to wait for the additional resources to become available, the hardware management circuitry 2804 can reserve and/or queue the ISA instruction for the currently unavailable resources to execute the ISA instructions after the workload is complete.

If the example hardware management circuitry 2804 determines that the OS/VMM 2707 did not reject the later execution (block 3006: NO), control returns to block 2922 of FIG. 29. If the example hardware management circuitry 2804 determines that the OS/VMM 2707 did reject the later execution (block 3006: YES), the example hardware management circuitry 2804 identifies a configuration of resources that can be utilized to emulate the ISA. For example, if there are two available small device processors with a 64 bit rate and the ISA instructions corresponds to a 256 bit instruction, the hardware management circuitry 2804 may identify a configuration using the two small device processors to execute the instructions at half the bit rate (e.g., 2728 bits per cycle*2 cycles=256 bits per 2 cycles). At block 3010, the example hardware management circuitry 2804 transmits the emulation configuration information to the OS/VMM 2707 via the interface(s) 200. The emulation configuration information may include information related to the processor resources that will be used to emulate the ISA execution, the policies and/or parameters that will be met, the policies and/or parameters that will not be met, and/or the parameters of the emulation configuration (e.g., bit rate, latency, etc.).

At block 3012, the example hardware management circuitry 2804 determines if the configuration was accepted by the OS/VMM 2707 (e.g., based on a response obtained from the OS/VMM 2707 via the interface(s) 200). If the example hardware management circuitry 2804 determines that the configuration was accepted (block 3012: YES), the example hardware management circuitry 2804 instructs the microcode of the hardware (e.g., the microcode processing circuitry 2711) to cause the processing resources to operate according to the emulation configuration (block 414) and control returns to block 2922 of FIG. 29. If the example hardware management circuitry 2804 determines that the configuration was not accepted (block 3012: NO), the example hardware management circuitry 2804 determines whether other emulation configurations are available (block 416). In this manner, the example OS/VMM 2707 and the ISA managing circuitry 2710 can negotiate an emulation configuration. In some examples, the OS/VMM 2707 may provide instructions and/or preferences that it would like to see in an emulation configuration and the ISA managing circuitry 2710 can attempt to satisfy the instructions and/or preferences and/or provide an emulation configuration that better suits the instructions and/or preferences.

If the example hardware managing circuitry 2804 determines that other emulation configurations are available (block 416: YES), control returns to block 3010. If the example hardware managing circuitry 2804 determines that other emulation configurations are not available (block 416: NO), the example hardware managing circuitry 2804 transmits (e.g., to the OS/VMM 2707 using the example interface(s) 200) an indication that the emulation is not available (block 418), and control returns to block 2922.

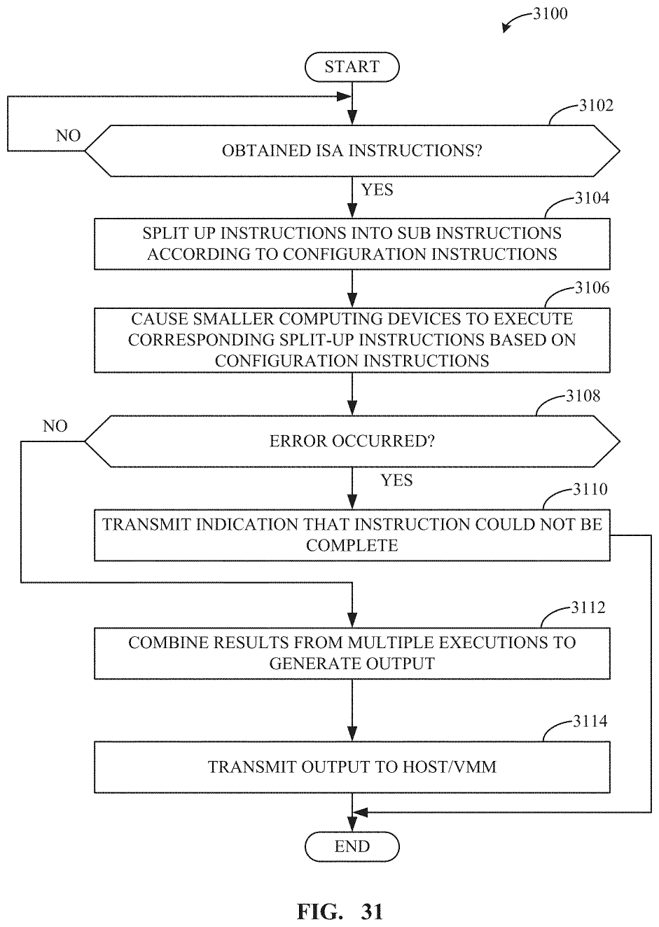

FIG. 31 is a flowchart representative of example machine readable instructions and/or example operations 3100 that may be executed and/or instantiated by processor circuitry (e.g., the microcode processing circuitry 2711) to control the processing resources to handle execution of ISA instructions. The instructions begin at block 3102 when the example hardware control circuitry 2812 determines if ISA instructions have been obtained (e.g., from the OS/VMM 2707 directly or via the BIOS 2708).

If the example hardware control circuitry 2812 determines that ISA instructions have not been obtained (block 3102: NO), control returns to block 3102 until ISA instructions are obtained. If the example hardware control circuitry 2812 determines that the ISA instructions have been obtained (block 3102: YES), the example hardware control circuitry 2812 splits up the instructions into sub-instructions according to the configuration instruction from the ISA managing circuitry 2710 (block 3104). For example, if the configuration corresponds to one 2728 bit processor and two 64 bit processors, the hardware control circuitry 2812 may split a 256 bit instruction into a 2728 bit instructions and two 64 bit instructions to correspond with the configuration, as further described above in conjunction with FIG. 27.

At block 3106, the example hardware control circuitry 2812 causes the processing resources to execute the split-up instructions based on the configuration instructions. Using the above example, the hardware control circuitry 2812 may provide the 2728 bit instruction to the processing resource that operates at 2728 bits per cycle for execution, the first 64 bit instruction to the first processing resource that operates at 64 bits per cycle for execution, and the second 64 bit instruction to the second processing resource that operates at 64 bits per cycle for execution. At block 3108, the example error determination circuitry 2814 determines if an error has occurred at any of the processing resources. For example, the error determination circuitry 2814 may identify operations that result in errors, infinite loops, etc.

If the example error determination circuitry 2814 determines that an error has occurred (block 3108: YES), the example error determination circuitry 2814 transmits (e.g., using the interface(s) 210) an indication that the ISA instruction could not be complete (block 510) and the instructions end. If the example error determination circuitry 2814 determines that an error has not occurred (block 3108: NO), the example output control circuitry 2816 combines the results (e.g., outputs) from the multiple executions at the multiple processor resources to generate the final output for the cycle (block 512), as further described above in conjunction with FIG. 27. For example, the output control circuitry 2816 may combine the results (e.g., outputs) by concatenating the outputs, adding the outputs, multiplying the outputs, etc. If the ISA instruction corresponds to multiple instructions over multiple cycles, the microcode processing circuitry 2711 may store the output for the cycle in memory (e.g., a register, cache, volatile memory, non-volatile memory, etc.) to use during a subsequent cycle and/or until all the instructions are complete and then combine some or all of the outputs of the cycles. At block 3114, the example output control circuitry 2816 uses the interface(s) 210 to transmit the outputs to the OA/VMM 2707 (e.g., directly or via the BIOS 2708).

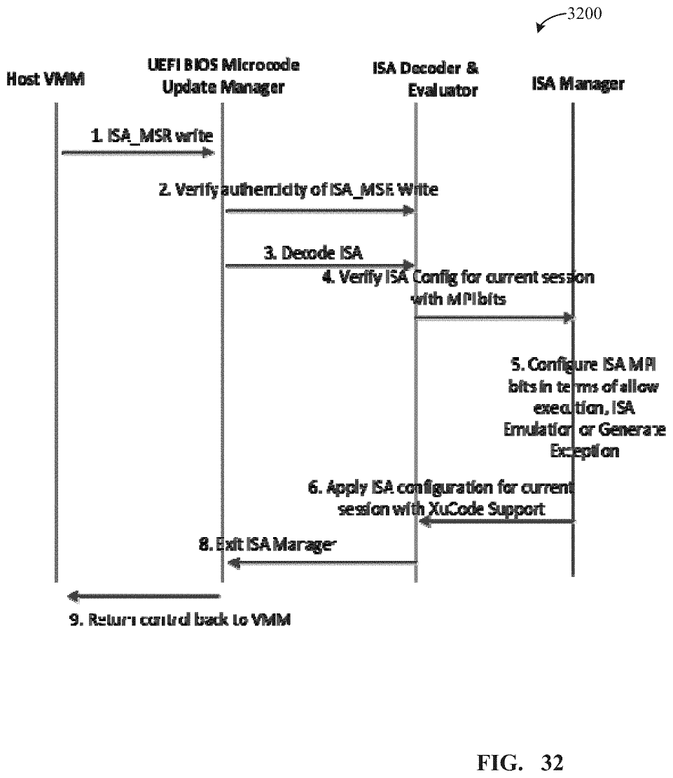

FIG. 32 illustrates an example diagram 3200 corresponding to operation of the ISA managing circuitry 2710 of FIG. 27. The example diagram 3200 of FIG. 32 beings when the OS/VMM 2707 writes data to the ISA manager status register (ISA_MSR) to initiate an interrupt for the ISA managing circuitry 2710 to determine if and/or how to execute the ISA instructions according to the ISA execution request. When the ISA managing circuiting (e.g., implementing the UEFI BIOS microcode update manager) identifies the ISA_MSR write, the authentication circuitry 2802 (e.g., implementing the ISA decoder and/or evaluator) decodes and verifies the authenticity of the ISA_MSR write. If authenticated, the hardware management circuitry 2804 (e.g., implementing the ISA Manager) verifies the ISA configuration for the current session with message passage interface (MPI) bits, configures the ISA MPI bits in terms of allow execution, emulation, or generate exception, and applies the ISA configuration for the current session by instructing the Xucode (e.g., the microcode processing circuitry 2711). In some examples, the hardware management circuitry 2804 may take policy-based actions including generating new micro-ops using a surplus Mapper for execution to configure the processing resources to execute the ISA instructions. After complete, the example ISA managing circuitry 2710 returns control back to the OS/VMM 2707. To return back to normal thin mode (e.g., where the processing resources are not operating as a big core but as separate smaller processor devices), a similar process occurs.

FIG. 33 is a block diagram of an example processor platform 3300 structured to execute and/or instantiate the machine readable instructions and/or operations of FIGS. 3-5 to implement the IA managing circuitry 2710 and/or the microcode processing circuitry 2711 of FIG. 27. The processor platform 3300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 3300 of the illustrated example includes processor circuitry 3312. The processor circuitry 3312 of the illustrated example is hardware. For example, the processor circuitry 3312 can be implemented by one or more integrated circuits, logic circuits, FPGAs microprocessors, CPUs, GPUs, DSPs, and/or microcontrollers from any desired family or manufacturer. The processor circuitry 3312 may be implemented by one or more semiconductor based (e.g., silicon based) devices. In this example, the processor circuitry 3312 implements the example interface(s) 200, the example authentication circuitry 2802, the example hardware management circuitry 2804, the example interface(s) 210, the example hardware control circuitry 2812, the example error determination circuitry 2814, and the example output control circuitry 2816.

The processor circuitry 3312 of the illustrated example includes a local memory 3313 (e.g., a cache, registers, etc.). The processor circuitry 3312 of the illustrated example is in communication with a main memory including a volatile memory 3314 and a non-volatile memory 3316 by a bus 3318. The volatile memory 3314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3316 may be implemented by flash memory and/or any other desired type of memory device. Access to the main memory 3314, 3316 of the illustrated example is controlled by a memory controller 3317.

The processor platform 3300 of the illustrated example also includes interface circuitry 3320. The interface circuitry 3320 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 3322 are connected to the interface circuitry 3320. The input device(s) 3322 permit(s) a user to enter data and/or commands into the processor circuitry 3312. The input device(s) 3322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 3324 are also connected to the interface circuitry 3320 of the illustrated example. The output devices 3324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3320 of the illustrated example, thus, typically includes a graphics driver card, a graphics driver chip, and/or graphics processor circuitry such as a GPU.

The interface circuitry 3320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 3300 of the illustrated example also includes one or more mass storage devices 3328 to store software and/or data. Examples of such mass storage devices 3328 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 3332, which may be implemented by the machine readable instructions of FIGS. 3-5, may be stored in the mass storage device 3328, in the volatile memory 3314, in the non-volatile memory 3316, and/or on a removable non-transitory computer readable storage medium such as a CD or DVD.

From the foregoing, it will be appreciated that example systems, methods, apparatus, and articles of manufacture have been disclosed that increases boot performance. The disclosed systems, methods, apparatus, and articles of manufacture provide a software and/or firmware based application programming interface (API) to process instructions from an application running on an operating system, virtual machine manager (VMM), etc., and instruct microcode to configure the processing units to be able to execute the instructions, regardless of how the instructions are structured. According, examples disclosed herein can combine smaller resources to execute code designed for larger resources without requiring the instructions to be structured for the smaller resources. In this manner, the application can generate one instruction and examples disclosed herein can determine if and/or how to execute the instruction given the constraints of the computing system. APPARATUS, ARTICLES OF MANUFACTURE, AND METHODS FOR COMPOSABLE MACHINE LEARNING COMPUTE NODES

Compute workloads may be carried out by using machine-learning models. Machine-learning models, such as neural networks, are useful tools that have demonstrated their value solving complex problems regarding pattern recognition, natural language processing, automatic speech recognition, etc. Identifying an optimal combination of hardware and/or software (e.g., a machine-learning model) to execute a compute workload is complex due to the vast range of available types of hardware and/or machine-learning models and customization(s) thereof.

Automated Machine Learning (AutoML) provides techniques to improve access and availability of Machine Learning (ML) to various applications and use cases. AutoML is the process of automating the operations of applying ML to tasks and workloads. For example, AutoML may be used to automate the selection, composition, and parameterization of ML models. In some such examples, AutoML may be used throughout the ML pipeline from receiving a raw dataset to generating a deployable machine-learning model.

Some AutoML approaches may select an ML model (e.g., an ML model to execute a workload) based on a hardware search space and/or a software search space. As used herein, a “hardware search space” is a space or set of feasible hardware, configurations of the hardware, etc., and/or combination(s) thereof, among which a desired hardware configuration resides to execute an ML model. For example, an AutoML system may evaluate various types of ML models based on configurations of hardware included in the hardware search space. As used herein, a “software search space” is a space of feasible ML models, configurations of the ML models, etc., and/or combination(s) thereof, among which a desired software configuration resides to execute a workload (e.g., a compute workload, an ML workload, an ML task, an ML operation, etc.). For example, an AutoML system may evaluate various types of ML models based on the ML models and/or configurations of the ML models included in the software search space.

Some AutoML approaches may use a single and inflexible template of hardware (e.g., a CPU, a GPU, an FPGA, etc.) to express a hardware search space that an AutoML system may use to identify an ML model to execute a workload of interest. For example, the hardware template may be inflexible because interconnect topologies of the hardware may be fixed and/or otherwise non-configurable. Some such AutoML approaches may evaluate different types of ML models and/or configurations of the ML models based on a single type of hardware. In some such examples, the type of hardware may have weaknesses when instantiating particular one(s) of the ML models. Thus, the one(s) of the ML models may not be selected for a particular type of ML workload based on the type of hardware evaluated. In some such examples, the one(s) of the ML models may be efficient when executing the particular type of ML workload on different hardware, but the AutoML system may not choose the one(s) of the ML models because of the inefficiencies of the underlying type of hardware on which the one(s) of the ML models is/are being evaluated.

Some AutoML approaches may use a single and inflexible software template (e.g., a type of neural network, a configuration of the neural network, etc.) to express a software search space that an AutoML system may use to identify an ML model to execute a workload of interest. Some such AutoML approaches may evaluate execution(s) of workload(s) based on a single type of ML model. In some such examples, the ML model may have weaknesses when executing a particular type of workload. Thus, the one(s) of the ML models may not be selected for a particular type of ML workload. In some such examples, the one(s) of the ML models may be efficient when executing the particular type of ML workload, but the AutoML system may not choose the one(s) of the ML models because of the inefficiencies of the inflexible configurations of the software search space on which the one(s) of the ML models are being evaluated.

Co-development of artificial intelligence/machine learning (AI/ML) models and the hardware on which they are executed and/or instantiated is beneficial for obtaining highly efficient solutions. However, such co-development requires many slow, manual iterations by interdisciplinary human experts in both hardware design and AI/ML algorithms. Recently, AutoML approaches as described above have been proposed to reduce human design effort by performing automatic AI/ML hardware/software (HW/SW) co-design. However, as described above, existing AutoML approaches lack the hardware and software design flexibility that can unlock the true potential of AI/ML HW/SW co-design. For example, existing AutoML approaches typically use a single fixed hardware architecture template based on a fixed set of modules and connectivity, with a fixed set of low-level design parameters for each module (e.g., buffer sizes, a number of compute units, etc.). As a result, the hardware design search space is restricted to a limited set of instances from only a single hardware architecture style. Similarly, the software search space also has limitations. In a neural network search, typically a search space targets a single class of network (e.g., recurrent neural network (RNN) class only or convolution neural network (CNN) class only, for example).

Examples disclosed herein include apparatus, articles of manufacture, and methods for composable machine learning compute nodes. In some disclosed examples, incorporating hardware and software heterogeneity into an AutoML search can potentially discover new models (e.g., AI/ML models) that exploit the strengths of different compute platforms (e.g., branches and control-heavy on CPUs, massively parallel layers on GPUs, custom new layers on FPGAs, etc.) to generate a machine learning system based on composable, modular building blocks of hardware and/or software.

Examples disclosed herein include an expressive search space representation that covers multiple templates of hardware and software architectures. In some disclosed examples, the templates can be dynamically modifiable during the HW/SW co-design search. Advantageously, the expressive search space enables the HW/SW co-design systems to explore a much larger and richer space of HW/SW designs across multiple architecture styles. In some disclosed examples, one(s) of the architectural styles can be flexible in their respective sets of modules and connectivity (e.g., selection and/or configuration of connections, topologies, inputs/outputs, etc.). In some such disclosed examples, the sets of modules and connectivity can be formable through composable building blocks. Advantageously, examples disclosed herein improve the likelihood of discovering more efficient hardware architecture instances and their corresponding co-designed software compared to prior AutoML approaches because examples disclosed herein offer much larger HW/SW search space(s) and composable version(s) thereof.

Examples disclosed herein include a set of hardware architecture templates and software architecture templates. Advantageously, the hardware and software templates can be based on a palette of composable architecture building blocks, each of which can have a set of micro-architectural parameters. In some disclosed examples, the micro-architectural parameters can be searchable to enhance the granularity of AutoML searches. Advantageously, the example hardware and software templates are not limited to a predefined set of modules and their fixed connectivity like templates used in some prior AutoML approaches. In some disclosed examples, the composable architectural building blocks can be flexibly combined, added, removed, modified, and/or mutated based on a set of design rules (e.g., pre-specified design rules, design rules dynamically specified or specified on-the-fly, etc.) to create a plethora of new HW/SW architecture instances. In some disclosed examples, the formal and precise semantics and interfaces of the example hardware and software templates allow for automated search of the HW/SW design space in an AutoML framework, as well as easily extending the HW/SW blocks palette with new user and/or machine-specified blocks.

Examples disclosed herein include simultaneously evolving multiple sets of relevant composable building blocks, each of which may cover a different architecture class and design style. For example, in the hardware search space, having an AI/ML processor architecture based on the systolic array design style can be suitable for compute-intensive AI/ML models, but not suitable for memory-bound and less compute-intensive workloads. Examples disclosed herein, therefore, can simultaneously evolve HW architectures with different architectural design styles to allow the AI/ML models to flexibly evolve to achieve improved software accuracy and hardware efficiency during the co-design process. Similarly, by way of example in the software search space (e.g., the neural network software search space), there are multiple classes of networks with their own beneficial properties (e.g., CNNs, RNNs, Transformers, etc.) and composable building blocks (e.g., matrix times vector operations (e.g., matrix x vector) for RNNs, convolutions for CNNs, etc.). Advantageously, examples disclosed herein can build improved HW/SW solutions based on composable ML compute nodes to execute workloads with less development effort compared to prior AutoML approaches.

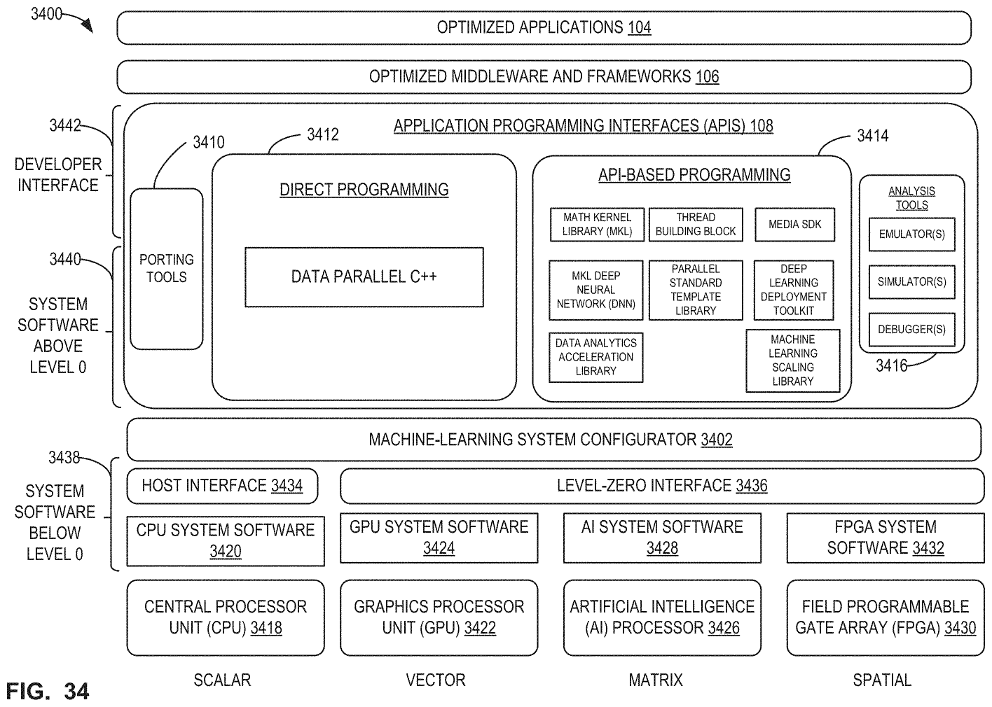

FIG. 34 is an illustration of an example AutoML architecture 3400, which includes an example machine-learning (ML) system configurator 3402 to identify and/or generate a composable ML compute node. The AutoML architecture 3400 includes the ML system configurator 3402 to generate a hardware search space and/or a software search space based on a compute task or workload (e.g., an Artificial Intelligence/Machine Learning (AI/ML) compute task or workload). The ML system configurator 3402 can identify hardware, or portion(s) thereof, from the hardware search space. The ML system configurator 3402 can also discover and/or otherwise identify software (e.g., an AI/ML model), or portion(s) thereof, from the software search space. In some examples, the ML system configurator 3402 can individually and/or simultaneously evolve a composable ML compute node by iterating (i) an architecture and/or type of the hardware and/or the software and/or (ii) configuration(s) of the hardware and/or the software. For example, the ML system configurator 3402 can evolve the composable ML compute node by evaluating the hardware and/or the software when executing a workload and/or based on a simulation of the hardware and/or software executing the workload. In some such examples, the composable ML compute node can be composable because hardware and/or software components can be selected and assembled in various combinations to satisfy specific or pre-defined requirements (e.g., an accuracy requirement, a latency requirement, a throughput requirement, etc.). In some such examples, in response to an identification of a particular combination of hardware and/or software that satisfies the specific or pre-defined requirements, the ML system configurator 3402 can output the combination as a composable ML compute node to execute a workload of interest.

In some examples, a composable ML compute node can be implemented by a single homogeneous computing or electronic system that may be configured and/or otherwise utilized to execute an AI/ML model. For example, the composable ML compute node can be implemented by a single Central Processor Unit (CPU), Graphics Processor Unit (GPU), Artificial Intelligence Processor (AI Processor), Field Programmable Gate Array (FPGA), Digital Signal Processor (DSP), XPU, etc. In some examples, the composable ML compute node can be implemented by portion(s) of a single homogeneous computing or electronic system, such as portion(s) (e.g., kernel(s)) of a single CPU, GPU, AI Processor, FPGA, DSP, XPU, etc. In some such examples, the portion(s) can include a kernel (e.g., a hardware kernel) and/or corresponding interconnect(s) to which different kernel(s), hardware, etc., can be coupled (e.g., physically coupled, communicatively coupled, coupled via a computing or electrical bus, etc.). In some examples, a composable ML compute node can be implemented by multiple ones of the same type of homogeneous computing or electronic system, or portion(s) thereof. For example, the composable ML compute node can be implemented by two or more CPUs (or portion(s) thereof), two or more GPUs (or portion(s) thereof), two or more AI Processors (or portion(s) thereof), two or more FPGAs (or portion(s) thereof), two or more DSPs (or portion(s) thereof), two or more XPUs (or portion(s) thereof), etc.

In some examples, a composable ML compute node can be implemented by a single heterogeneous computing or electronic system that may be configured and/or otherwise utilized to execute an AI/ML model. For example, the composable ML compute node can be implemented by a CPU, a GPU, an AI Processor, an FPGA, a DSP, XPU, etc., and/or any combination(s) thereof. In some such examples, the composable ML compute node can be implemented by one or more CPUs, one or more GPUs, one or more AI Processors, one or more FPGAs, one or more DSPs, one or more XPUs, etc., and/or any combination(s) thereof. In some examples, the composable ML compute node can be implemented by portion(s) of a single heterogeneous computing or electronic system, such as portion(s) of a CPU, GPU, AI Processor, FPGA, DSP, XPU, etc., and/or any combination(s) thereof. In some examples, a composable ML compute node can be implemented by multiple ones of the same heterogeneous computing or electronic system, or portion(s) thereof. For example, the composable ML compute node can be implemented by two or more instances of a heterogeneous computing system, which includes one or more CPUs (or portion(s) thereof), one or more GPUs (or portion(s) thereof), one or more AI Processors (or portion(s) thereof), one or more FPGAs (or portion(s) thereof), one or more DSPs (or portion(s) thereof), one or more XPUs (or portion(s) thereof), etc., and/or combination(s) thereof. In some examples, the composable ML compute node can be implemented by two or more different heterogeneous computing or electronic systems. For example, the composable ML compute node can be implemented by a first heterogeneous computing system and a second heterogeneous computing system. In some such examples, portion(s) of the first heterogeneous computing system and the second heterogeneous computing system can be different.

In some examples, the composable ML compute node can include, store, and/or otherwise access an executable construct to execute an AI/ML model to complete a workload, or portion(s) thereof. For example, the executable construct can be implemented by a configuration image, an executable binary, executable code (e.g., executable machine-readable code), an executable file (e.g., an executable binary file), an executable program, executable instructions (e.g., executable machine-readable instructions), etc., that, when executed, can implement an AI/ML model to effectuate completion of AI/ML workloads.

The AutoML architecture 3400 of the illustrated example includes example optimized applications 3404, example optimized middleware and frameworks 3406, and example application programming interfaces (APIs) 3408. In some examples, the optimized applications 3404 can be implemented by applications (e.g., software applications, web- or browser-based applications, etc.) that are customized, tailored, and/or otherwise optimized to effectuate the identification and/or generation of a composable ML compute node. For example, the optimized applications 3404 can be accessed, utilized, etc., by a developer (e.g., a software developer, a researcher, etc.), Information Technology (IT) personnel, etc. In some such examples, the optimized applications 3404 can be accessed, utilized, etc., to co-design a hardware/software (HW/SW) solution for a technical problem that can benefit from AI/ML techniques. In some examples, the optimized middleware and frameworks 3406 can be implemented by middleware and frameworks that are customized, tailored, and/or otherwise optimized to effectuate the identification and/or generation of a composable ML compute node. For example, the optimized middleware and frameworks 3406 can implement an interface (e.g., communication, connectivity, etc.) between the optimized applications 3404 and the APIs 3408.

The APIs 3408 of the illustrated example can be invoked to program, develop, and/or otherwise generate an AI/ML application by at least one of direct programming or API-based programming. The APIs 3408 of the illustrated example include example porting tools 3410, example direct programming APIs 3412, example API-based programming APIs 3414, and example analysis tools 3416.

In some examples, the porting tools 3410 can be implemented by software (e.g., a software application) that can adapt a program for the purpose of achieving some form of execution in a first computing or electronic environment that is different from a second computing or electronic environment for which the program was originally designed. For example, the porting tools 3410 can convert and/or otherwise adapt a first program developed for a first type of hardware, operating system (OS), library, etc., into a second program for a second type of hardware, OS, library, etc.

In some examples, the direct programming APIs 3412 can be invoked to effectuate direct programming tasks, which may include developing and/or compiling data parallel C++ applications. In some examples, the API-based programming APIs 3414 can be invoked to effectuate API-based programming, which may include developing and/or compiling applications that call (or invoke, instantiate, etc.) a Math Kernel Library (MKL), an MKL Deep Neural Network (DNN) library, a data analytics acceleration library, a thread building block library, a parallel standard template library, a media software development kit (SDK), a deep learning deployment toolkit, a machine learning scaling library, etc., and/or any combination(s) thereof.

In some examples, the analysis tools 3416 can be called, instantiated, and/or otherwise invoked to analyze hardware, software, and/or configuration(s) thereof of a composable ML compute node. For example, the analysis tools 3416 can instantiate emulator(s) to emulate all of the hardware and/or software features of the composable ML compute node to generate and/or otherwise output one or more evaluation parameters. In some such examples, the evaluation parameters can include parameters representative and/or otherwise indicative of accuracy, latency, a number of cycles to complete a workload, or throughput of the composable ML compute node. In some examples, the evaluation parameters can include parameters representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof. For example, the analysis tools 3416 can execute an emulator based on the composable ML compute node. In some such examples, the analysis tools 3416 can execute the emulator to determine a throughput of the composable ML compute node when the composable ML compute node executes a particular AI/ML model having a particular configuration.

In some examples, the analysis tools 3416 can instantiate simulator(s) to simulate the behavior, the configuration, etc., of a composable ML compute node to generate and/or otherwise output one or more evaluation parameters. For example, the analysis tools 3416 can execute a model (e.g., a simulation model, an AI/ML model, etc.) based on the composable ML compute node. In some such examples, the analysis tools 3416 can execute the model to estimate, predict, and/or otherwise determine a throughput of the composable ML compute node when the composable ML compute node executes a particular AI/ML model having a particular configuration.

The AutoML architecture 3400 of the illustrated example includes different types of hardware and/or software from which a composable ML compute node can be generated. In the illustrated example, the AutoML architecture 3400 includes interfaces and target system software for scalar, vector, matrix, and spatial hardware. Additionally and/or alternatively, any other type of hardware may be used. In this example, the scalar hardware is implemented by an example CPU 3418 and example CPU system software 3420. For example, the CPU system software 3420 can include instructions corresponding to a CPU Instruction Set Architecture (ISA). In this example, the vector hardware is implemented by an example GPU 3422 and example GPU system software 3424. For example, the GPU system software 3424 can include kernels, portion(s) of code, etc., such as kernels, compute kernels, and/or shaders. In some examples, the kernels, the portion(s) of code), etc., can be represented in a high-level programming language such as, for example, a High-Level Shader Language (HLSL), OpenCL, etc.

In this example, the matrix hardware is implemented by an example AI processor 3426 and example AI system software 3428. For example, the AI system software 3428 can include one or more AI/ML algorithms, models, etc., such as neural networks (e.g., convolution neural networks (CNNs), deep neural networks (DNNs), recurrent neural networks (RNNs), etc.), Linear Regression models, Logistic Regression Models, Decision Tree Models, Learning Vector Quantization Models, etc., and/or combination(s) thereof. In this example, the spatial hardware is implemented by an example FPGA 3430 and example FPGA system software 3432. For example, the FPGA system software 3432 can include kernels, portion(s) of code, etc., based on a hardware description language (HDL) such as Verilog.

The ML system configurator 3402 of the illustrated example can interface with the CPU 3418 and/or the CPU system software 3420 via an example host interface 3434. The ML system configurator 3402 of the illustrated example can interface with the GPU 3422, the GPU system software 3424, the AI processor 3426, the AI system software 3428, the FPGA 3430, and/or the FPGA system software 3434 via an example level-zero interface 466.

In the illustrated example, the CPU system software 3420, the GPU system software 3424, the AI system software 3428, the FPGA system software 3432, the host interface 3434, and/or the level-zero interface 3436 can correspond to and/or otherwise implement example system software below level zero 3436. For example, system software below level zero 3436 can correspond to and/or otherwise implement low-level direct-to-metal interfaces that are tailored to hardware, such as the CPU 3418, the GPU 3422, etc.

In the illustrated example, the APIs 3408 can implement example system software above level zero 3440 and an example developer interface 3442. For example, a developer, a user, etc., can access and/or otherwise utilize the AutoML architecture 3400 by way of the APIs 3408. In some examples, a developer, a user, etc., can access and/or otherwise utilize system software at a higher level than low-level direct-to-metal interfaces by way of the APIs 3408. In some examples, a developer, a user, etc., can access and/or otherwise utilize the system software below level zero 3436 via the host interface 3434 and/or the level-zero interface 3436.

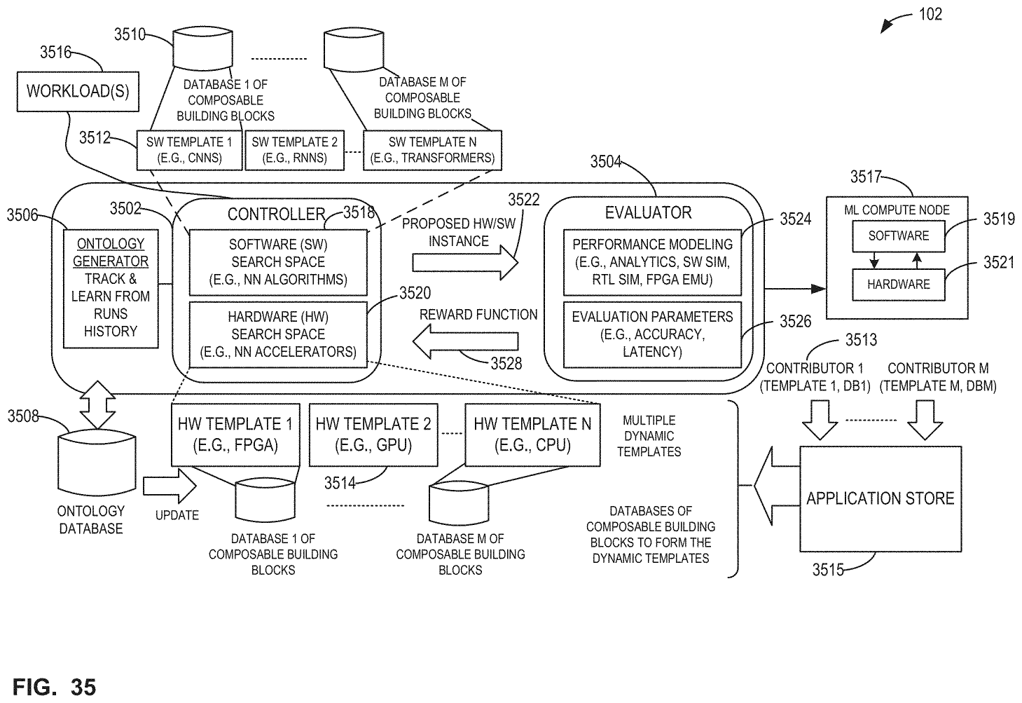

FIG. 35 is a block diagram of an example implementation of the ML system configurator 3402 of FIG. 34. The ML system configurator 3402 includes an example controller 3502, an example evaluator 3504, an example ontology generator 3506, and an example ontology database 3508.

In the illustrated example, the ontology database 3508 includes a plurality of example composable building block databases 3510. In the illustrated example, the composable building block databases 3510 include example software templates 3512 and hardware templates 3514. For example, the composable building block databases 3510 can include a first composable building block database, which can include a first software template (identified by SW TEMPLATE 34) of the software templates 3512. In some such examples, the first software template can include one or more CNNs, configuration(s) thereof, and/or metadata. For example, the metadata can describe an operation of the CNN, different configurations and/or capabilities of the CNN, aspects of the CNN that can be modified or mutated, etc. In some examples, the first software template can expose and/or otherwise make available aspects, configurations, interconnections, etc., of a CNN that can be adjusted, changed, modified, mutated, etc. In some examples, the composable building block databases 3510 can include a second composable building block database, which can include a second software template (identified by SW TEMPLATE 35) of the software templates 3512, a third composable building block database, which can include a third software template (identified by SW TEMPLATE N) of the software templates 3512, etc. In the illustrated example, the second software template can include one or more RNNs and/or configuration(s) thereof. In the illustrated example, the third software template can include one or more Transformers and/or configuration(s) thereof. Additionally and/or alternatively, any other type of AI/ML model and/or configuration(s) thereof may be included in the composable building block databases 3510.

In some examples, the composable building block databases 3510 can include database(s) and/or template(s) from example contributors 3513. For example, the contributors 3513 can be users, developers, researchers, etc. The contributors 3513 of the illustrated example can upload and/or otherwise provide database(s), template(s), etc., to an example repository 3515. In some examples, the contributors 3513 can include metadata in the database(s), the template(s), etc., that provide indications on the configurability of hardware and/or software of the template(s). In the illustrated example, the repository 3515 is an application store (e.g., an App Store) that can be accessed by the ML system configurator 3402 for use in composing, generating, etc., an example ML compute node 3517. For example, the ML compute node 3517 can implement a composable ML compute node. The ML compute node 3517 of the illustrated example incudes example software 3519 and example hardware 3521. For example, the software 3519 can be implemented by one or more AI/ML models. In some examples, the hardware 3521 can be implemented by one or more CPUs (or portion(s) thereof), one or more GPUs (or portion(s) thereof), one or more AI processors (or portion(s) thereof), one or more FPGAs (or portion(s) thereof), one or more ASICs (or portion(s) thereof), etc., and/or any combination(s) thereof.

In the illustrated example, the composable building block databases 3510 can include a fourth composable building block database, which can include a first hardware template (identified by HW TEMPLATE 34) of the hardware templates 3514. In some such examples, the first hardware template can include one or more FPGAs (e.g., one or more architectures, manufacturer models, types, etc., of FPGAs) and/or configuration(s) thereof. For example, the hardware template can expose and/or otherwise make available aspects, configurations, interconnections, etc., of an FPGA that can be adjusted, changed, modified, mutated, etc. In some examples, the composable building block databases 3510 can include a fifth composable building block database, which can include a second hardware template (identified by HW TEMPLATE 35), a sixth composable building block database, which can include a third hardware template (identified by HW TEMPLATE N), etc. In the illustrated example, the second hardware template can include one or more GPUs (e.g., one or more architectures, manufacturer models, types, etc., of GPUs) and/or configuration(s) thereof. In the illustrated example, the third hardware template can include one or more CPUs (e.g., one or more architectures, manufacturer models, types, etc., of CPUs) and/or configuration(s) thereof. Additionally and/or alternatively, any other type of hardware and/or configuration(s) thereof may be included in the composable building block databases 3510.

In example operation, the controller 3502 can receive, obtain, and/or otherwise identify example workload(s) (e.g., one or more AI/ML workloads) 3516. For example, the workload(s) 3516 can be scientific simulations, financial analytics, AI/deep learning, 3D modeling and analysis, image and audio/video processing, cryptography, data compression, etc. In the illustrated example, the controller 3502 can generate an example software search space 3518 and an example hardware search space 3520 based on the workload(s) 3516.

In some examples, the controller 3502 can generate the software search space 3518 and the hardware search space 3520 in response to a query to the ontology generator 3506 for HW/SW solutions for previous AutoML searches that correspond to the workload(s) 3516. For example, the controller 3502 can query the ontology generator 3506 with an identifier that corresponds to the workload(s) 3516, an initial or seed AI/ML model that may execute the workload(s) 3516, etc. In some such examples, the ontology generator 3506 can identify an association of the initial or seed AI/ML model and another AI/ML model in the ontology database 3508. For example, the ontology generator 3506 can track and learn from previous searches, runs of the ML system configurator 3402, etc. In some examples, the ontology generator 3506 can search the ontology database 3508 for such previous searches, runs, etc. For example, the ontology database 3508 can store learnings, mappings, etc., associated with the software templates 3512 and/or the hardware templates 3514 across the hardware and/or software domain from prior searches. In some examples, the prior searches can correspond to searches for a previous workload. In some examples, the prior searches can correspond to iterations of searches for the workload(s) 3516. Advantageously, the controller 3502 can utilize the ontology generator 3506 to identify fine granular composable building blocks to mix and match towards dynamic flexible template generation to be used in the generation of the software search space 3518 and the hardware search space 3520.

Advantageously, the controller 3502 can provide expressive search space representation (e.g., the software search space 3518, the hardware search space 3520, etc.) that covers multiple templates of hardware and software architectures (e.g., the software templates 3512, the hardware templates 3514, etc.), where the templates can be dynamically modifiable during the HW/SW co-design search. Advantageously, the controller 3502 can enable a HW/SW co-design system, which may be implemented by the ML system configurator 3402, to explore a much larger and richer space of HW/SW designs, across multiple architecture styles. In some examples, one(s) of the architectural styles corresponding to the software templates 3512 and/or the hardware templates 3514 can be flexible in their respective sets of modules and connectivity (e.g., selection and/or configuration of connections, topologies, inputs/outputs, etc.). In some such examples, the sets of modules and connectivity can be formable through composable building blocks, which can be included in the software templates 3512 (e.g., composable software building blocks in the software templates 3512) and/or the hardware templates 3514 (e.g., composable hardware building blocks in the hardware templates 3514). Advantageously, the controller 3502, and/or, more generally, the ML system configurator 3402, can improve the likelihood of discovering more efficient hardware architecture instances and their corresponding co-designed software compared to prior AutoML approaches because the controller 3502 of the illustrated example can utilize much larger HW/SW search space(s) and composable version(s) thereof.

In some examples, the controller 3502, the evaluator 3504, the ontology generator 3506, etc., and/or, more generally, the ML system configurator 3402, can utilize Artificial intelligence and/or machine learning techniques to identify and/or otherwise generate the ML compute node 3517 to execute the workload(s) 3516. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process (e.g., a machine-learning training process). For instance, the controller 3502, the evaluator 3504, the ontology generator 3506, and/or, more generally, the ML system configurator 3402, can be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the ML system configurator 3402 generates the software 3519 as neural network model(s). The Advantageously, using a neural network model enables the hardware 3521, and/or, more generally, the ML compute node 3517, to execute an AI/ML workload. In general, machine-learning models/architectures that are suitable to use in the example approaches disclosed herein include reinforcement learning networks. However, other types of machine learning models could additionally or alternatively be used such as recurrent neural networks (RNNs), supervised learning artificial neural network (ANN) models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the ML system configurator 3402 can compile and/or otherwise generate the software 3519 as lightweight machine-learning model(s).

In general, implementing an ML/AI system involves two phases, a learning/training phase and an inference phase. In the learning/training phase, a training algorithm is used to train the ML system configurator 3402 to operate in accordance with patterns and/or associations based on, for example, training data. In general, the ML system configurator 3402 includes internal parameters that guide how input data is transformed into output data, such as through a series of nodes and connections within the ML system configurator 3402 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process. In some examples, hyperparameters can control how the learning is performed (e.g., a learning rate, a number of layers to be used in the machine learning model, etc.). In some examples, hyperparameters that control model performance and training speed can be the learning rate, a number of Epochs, a topology of the neural network, a size of the neural network, and/or regularization parameter(s). Such hyperparameters are selected by, for example, trial and error to reach an optimal model performance. In some examples re-training may be performed. Such re-training may be performed in response to override(s) by a user.

Different types of training may be performed based on the type of ML/AI model and/or the expected output. For example, reinforcement learning includes a machine, an agent, etc., interacting with its environment, performing actions, and learning by a trial-and-error technique. In other examples, supervised training uses inputs and corresponding expected (e.g., labeled) outputs to select parameters (e.g., by iterating over combinations of select parameters) for the AI/ML model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs). Additionally and/or alternatively, any other training technique may be used such as stochastic gradient descent, Simulated Annealing, Particle Swarm Optimization, Evolution Algorithms, Genetic Algorithms, and/or Nonlinear Conjugate Gradient.

Once training is complete, the ML system configurator 3402 is deployed for use as an executable construct that processes an input and provides an output based on the network of nodes and connections defined in the model. For example, the ML system configurator 3402 can be operated in an inference phase to process data. In the inference phase, data to be analyzed (e.g., live data, the workload(s) 3516, etc.) is input to the ML system configurator 3402, and the ML system configurator 3402 executes to create an output. This inference phase can be thought of as the AI “thinking” to generate the output based on what it learned from the training, from the reinforcement learning, etc. In some examples, input data undergoes pre-processing before being used as an input to the ML system configurator 3402. Moreover, in some examples, the output data may undergo post-processing after it is generated by the ML system configurator 3402 to transform the output into a useful result (e.g., a compilation of the software 3519, a generation of a configuration file associated with the hardware 3521, etc.).

In some examples, the ML system configurator 3402 of the illustrated example can be stored in memory of one or more computing systems or in a database of one or more remote computing systems. The ML system configurator 3402 may then be executed by the one or more computing systems or one or more different computing systems.

In the illustrated example, the ML system configurator 3402 can compose and/or otherwise lead to the compilation of the ML compute node 3517 using reinforcement learning. However, any other AI/ML algorithm or technique may additionally or alternatively be used. In some examples, the ML system configurator 3402 can iteratively generate the proposed HW/SW instance 3522 until a level of error is no longer reducing and/or otherwise satisfies a threshold (e.g., an accuracy threshold, a training threshold, etc.). As used herein “threshold” is expressed as data such as a numerical value represented in any form, that may be used by processor circuitry as a reference for a comparison operation. As used herein, data is information in any form that may be ingested, processed, interpreted and/or otherwise manipulated by processor circuitry to produce a result. The produced result may itself be data. As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

In some examples, the ML system configurator 3402 utilizes Bayesian hyperparameter optimization to determine an optimal and/or otherwise improved or more efficient network and/or hardware architecture to avoid model overfitting and improve the overall applicability of the software 3519 and/or the hardware 3521 of the ML compute node 3517. Alternatively, the ML system configurator 3402 may use any other type of optimization.

In example operation, the controller 3502 can receive a history of previous runs of the ML system configurator 3402 for the type of the workload(s) 3516 (or a different type of workload). The controller 3502 can generate the software search space 3518 by populating the software search space 3518 with one or more AI/ML models that were used in the previous runs. In some examples, the controller 3502 can populate the software search space 3518 with one or more different type of AI/ML models based on the workload(s) 3516. In the illustrated example, the software search space 3516 includes one or more neural network (NN) algorithms and/or configuration(s) thereof. Additionally and/or alternatively, the software search space 3516 may include any other type of AI/ML models, algorithms, etc. For example, the controller 3502 can discover and/or otherwise identify one or more RNNs, one or more Transformers, etc., by inspecting and/or otherwise searching the composable building block databases 3510.

In example operation, the controller 3502 can generate the hardware search space 3520 by populating the hardware search space 3520 with one or more types of hardware and/or configuration(s) thereof that were used in the previous runs. In some examples, the controller 3502 can populate the hardware search space 3520 with one or more different type of AI/ML models based on the workload(s) 3516. In the illustrated example, the hardware search space 3520 includes one or more NN accelerators. Additionally and/or alternatively, the hardware search space 3520 may include any other type of hardware (e.g., one or more CPUs, one or more FPGAs, etc.).

In example operation, the controller 3502 can generate an example proposed HW/SW instance 3522 and provide the proposed HW/SW instance 3522 to the evaluator 3504. In some examples, the proposed HW/SW instance 3522 can implement a candidate or proposed ML compute node. For example, the proposed HW/SW instance 3522 can be a composable ML compute node that is implemented by an NN accelerator having a first hardware configuration and an NN algorithm having a first software configuration.

In example operation, the evaluator 3504 can execute example performance modeling 3524 to generate and/or otherwise output example evaluation parameters 3526. For example, the evaluator 3504 can simulate, emulate, debug, etc., the proposed HW/SW instance 3522 to generate the evaluation parameters 3526. For example, the evaluation parameters 3526 can be implemented by values of evaluation metrics representative of and/or otherwise indicative of accuracy, latency, a number of cycles to complete a workload, or throughput of the proposed HW/SW instance 3522. In some examples, the evaluation parameters can be representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof associated with the proposed HW/SW instance 3522.

In some examples, the evaluator 3504 can execute and/or otherwise instantiate analytics, software simulations, Register Transfer Level (RTL) simulations to validate the correctness of digital integrated circuit (IC) operation, emulations (e.g., an NN accelerator emulator), etc. In some such examples, the evaluator 3504 can execute the performance modeling 3524 by simulating, emulating, debugging, etc., the NN accelerator with the first hardware configuration when the NN accelerator executes the NN algorithm with the first software configuration. For example, the evaluator 3504 can instantiate a simulation of the NN accelerator executing the NN algorithm to output the evaluation parameters 3526. In some examples, the evaluator 3504 can instantiate an emulation of the NN accelerator executing the NN algorithm to determine the evaluation parameters 3526.

In example operation, the evaluator 3504 can output an example reward function 3528. In some examples, the reward function 3528 can be implemented by a mathematical function that captures what is desired to be optimized (e.g., a mathematical function that includes higher weights for throughput to optimize throughput) and what is desired to be penalized (e.g., a mathematical function that includes lower weights for latency to optimize throughput at the expense of latency). For example, the reward function 3528 can include one or more outputs (e.g., the evaluation parameters 3526) from the evaluator 3504. In some examples, the evaluator 3504 can generate the reward function 3528 to include at least a first output, such as accuracy, with a first weight and a second output, such as throughput, with a second weight. In some examples, the evaluation parameters 3526 can be implemented using the first output (and/or the first weight) and the second output (and/or the second weight). The evaluator 3504 can generate the first weight to be greater than the second weight to invoke and/or otherwise cause the controller 3502 to increase an emphasis on increasing and/or otherwise optimizing accuracy and decrease an emphasis on increasing and/or otherwise optimizing the second output. In some examples, in response to obtaining the reward function 3528, the controller 3502 can change, modify, and/or otherwise adjust the proposed HW/SW instance 3522 to increase accuracy and decrease throughput based on the respective first and second weights of the first and second outputs of the reward function 3528. In some examples, the reward function 3528 can be an accuracy of the proposed HW/SW instance 3522 when executing the NN algorithm. In the illustrated example, the reward function 3528 can correspond to an evaluation result that is provided and/or otherwise fed back to the controller 3502 to update (e.g., iteratively update) the next version of the proposed HW/SW instance 3522.

In example operation, the controller 3502 can update the proposed HW/SW instance 3522 based on the reward function 3528. For example, the controller 3502 can change the manufacturer model, configuration, etc., of the NN accelerator to maximize and/or otherwise increase the reward function 3528. In some such examples, the controller 3502 can modify hardware interconnections (e.g., input(s) and/or output(s)) of portion(s) of the NN accelerator, a configuration image (e.g., a value of one or more configuration registers of the NN accelerator), etc., and/or any combination(s) thereof. Alternatively, the controller 3502 may replace the NN accelerator with a different type of hardware, such as a GPU. In some examples, the controller 3502 can modify the NN algorithm based on the reward function 3528. For example, the controller 3502 can change a number of layers of the NN algorithm, value(s) of activation(s) and/or weight(s), interconnection(s) (e.g., input(s) and/or output(s)), etc., of the NN algorithm. Alternatively, the controller 3502 may replace the NN algorithm with a different type of AI/ML algorithm, such as a Transformer.

In some examples, the controller 3502 responsive to the reward function 3528 being maximized and/or otherwise satisfying a threshold, such as a reward threshold, can output the proposed HW/SW instance 3522 as the ML compute node 3517 to execute the workload(s) 3516. For example, the controller 3502 can compile the software portion of the proposed HW/SW instance 3522 as an executable construct (e.g., an executable file, a machine readable executable, etc.) to be executed on the hardware portion of the HW/SW instance 3522.

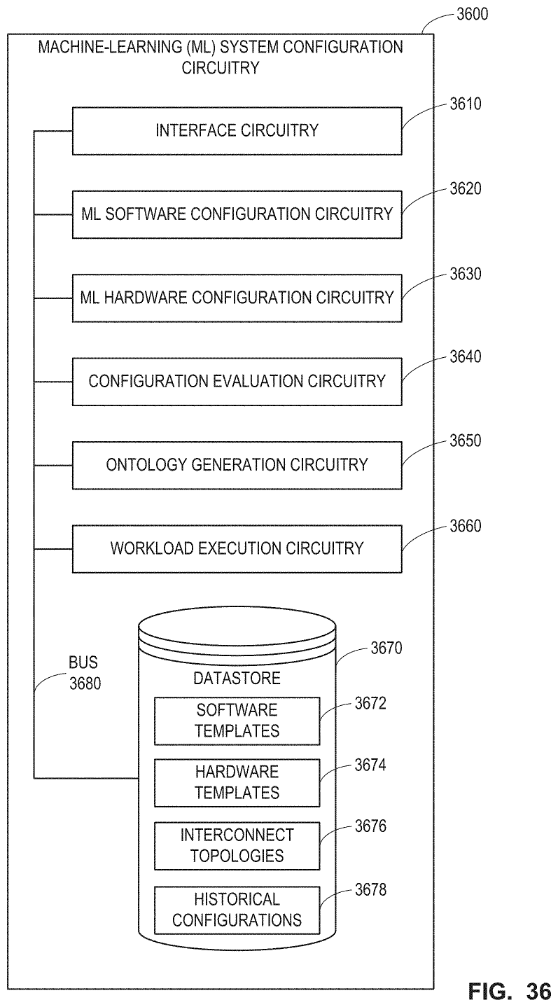

FIG. 36 is a block diagram of example ML system configuration circuitry 3600 to compose an ML compute node (e.g., the ML compute node 3517 of FIG. 35) to execute a workload (e.g., the workload(s) 3516 of FIG. 35). In some examples, the ML system configuration circuitry 3600 of FIG. 36 can implement the ML system configurator 3402 of FIGS. 34 and/or 35. The ML system configuration circuitry 3600 of FIG. 36 may be instantiated (e.g., creating an instance of, bring into being for any length of time, materialize, implement, etc.) by processor circuitry such as a CPU executing instructions. Additionally and/or alternatively, the ML system configuration circuitry 3600 of FIG. 36 may be instantiated (e.g., creating an instance of, bring into being for any length of time, materialize, implement, etc.) by an ASIC or an FPGA structured to perform operations corresponding to the instructions. It should be understood that some or all of the ML system configuration circuitry 3600 of FIG. 36 may, thus, be instantiated at the same or different times. Some or all of the ML system configuration circuitry 3600 may be instantiated, for example, in one or more threads executing concurrently on hardware and/or in series on hardware. Moreover, in some examples, some or all of the ML system configuration circuitry 3600 of FIG. 36 may be implemented by one or more virtual machines and/or containers executing on the microprocessor.

The ML system configuration circuitry 3600 of the illustrated example includes example interface circuitry 3610, example ML software configuration circuitry 3620, example ML hardware configuration circuitry 3630, example configuration evaluation circuitry 3640, example ontology generation circuitry 3650, example workload execution circuitry 3660, an example datastore 3670, and an example bus 3680. The datastore 3670 of the illustrated example includes example software templates 3672, example hardware templates 3674, example interconnect topologies 3676, and example historical configurations 3678.

In the illustrated example of FIG. 36, the interface circuitry 3610, the ML software configuration circuitry 3620, the ML hardware configuration circuitry 3630, the configuration evaluation circuitry 3640, the ontology generation circuitry 3650, the workload execution circuitry 3660, and the datastore 3670 are in communication with the bus 3680. For example, the bus 3680 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 3680 can be implemented by any other type of computing or electrical bus.

The ML system configuration circuitry 3600 of the illustrated example of FIG. 36 includes the interface circuitry 3610 to receive a request to execute an AI/ML workload. For example, the interface circuitry 3610 can receive a request from a user, a computing or electronic system, etc., to compose an AutoML solution (e.g., a combination of hardware and/or software) based on the workload(s) 3516. In some examples, the interface circuitry 3610 can receive a request for an AI/ML model and corresponding hardware to execute an AI/ML workload. In some examples, the interface circuitry 3610 can receive the AI/ML workload.

The ML system configuration circuitry 3600 of the illustrated example of FIG. 36 includes the ML software configuration circuitry 3620 to generate a first configuration of one or more models (e.g., one or more ML models, one or more AI/ML models, etc.) based on a workload. In some examples, the ML software configuration circuitry 3620 can generate a software search space based on at least one of the request or historical configurations. For example, the ML software configuration circuitry 3620 can populate and/or otherwise generate the software search space 3518 to include one or more AI/ML models identified in at least one of the ontology database 3508 or the composable building block databases 3510. In some such examples, the ML software configuration circuitry 3620 can generate the software search space 3518 based on the workload(s) 3516, or aspect(s) or portion(s) thereof.

In some examples, the ML software configuration circuitry 3620 queries a configuration database with the workload using an API. For example, one(s) of the composable building block databases 3510 can implement a configuration database, and the ML software configuration circuitry 3620 can query the one(s) of the composable building block databases 3510. In some such examples, the ML software configuration circuitry 3620 can query the one(s) of the composable building block databases 3510 with the workload(s) 3516 or aspect(s) thereof as input(s).

In some examples, the ML software configuration circuitry 3620 determines a number of layers for an AI/ML model. For example, the ML software configuration circuitry 3620 can identify a CNN in the software templates 3512, the software templates 3672, etc. In some such examples, the ML software configuration circuitry 3620 can determine a number of layers of the CNN.

In some examples, the ML software configuration circuitry 3620 determines weights for the layers of the AI/ML model. For example, the ML software configuration circuitry 3620 can identify weight values that correspond to the CNN in the software templates 3512. In some such examples, the ML software configuration circuitry 3620 can utilize the weights identified in the software templates 3512, determine new one(s) of the weights, adjust values of one(s) of the weights, etc., and/or any combination(s) thereof.

In some examples, the ML software configuration circuitry 3620 determines a type of training for the AI/ML model. For example, the ML software configuration circuitry 3620 can determine that reinforcement learning is associated with the CNN in the software templates 3512. In some examples, the ML software configuration circuitry 3620 can select a different type of training of the CNN such as stochastic gradient descent, Simulated Annealing, Particle Swarm Optimization, Evolution Algorithms, Genetic Algorithms, Nonlinear Conjugate Gradient, etc.

In some examples, the ML software configuration circuitry 3620 determines hyperparameters to train the AI/ML model. For example, the ML software configuration circuitry 3620 can identify hyperparameters, values of the hyperparameters, etc., that correspond to the CNN in the software templates 3512. In some such examples, the ML software configuration circuitry 3620 can utilize the hyperparameters identified in the software templates 3512, determine new one(s) of the hyperparameters, adjust values of one(s) of the hyperparameters, etc., and/or any combination(s) thereof.

In some examples, the ML software configuration circuitry 3620 determines whether another AI/ML model has been identified. For example, the ML software configuration circuitry 3620 can determine that a Transformer model is identified in addition to the CNN. In some such examples, the ML software configuration circuitry 3620 can determine that more than one AI/ML model has been identified, such as the CNN and the Transformer model. In some such examples, the ML software configuration circuitry 3620 can generate a topology (e.g., an interconnection or interconnect topology, an input/output (I/O) topology, etc.) based on connection(s) between one(s) of the AI/ML models. For example, the ML software configuration circuitry 3620 can select the CNN to be a first or primary model and the Transformer model to be a second or secondary model. For example, the ML software configuration circuitry 3620 can determine that the CNN and the Transformer model can be coupled together by connecting output(s) of the CNN to input(s) of the Transformer model.

In some examples, the ML software configuration circuitry 3620 adjusts the first configuration (e.g., a configuration of software to be included in the proposed HW/SW instance 3522) based on an evaluation parameter. For example, the evaluator 3504 can calculate and/or otherwise determine the evaluation parameters 3526 based on an evaluation of the proposed HW/SW instance 3522. In some such examples, the evaluator 3504 can determine a first evaluation parameter of the evaluation parameters 3526 to be an accuracy parameter (e.g., an accuracy of output(s) of the proposed HW/SW instance 3522, an accuracy evaluation parameter, etc.).

In some examples, the ML software configuration circuitry 3620 determines whether to replace a first AI/ML model with a different AI/ML model. For example, the ML software configuration circuitry 3620 can determine to replace the CNN with a different model, such as an ANN, a DNN, etc. In some such examples, the ML software configuration circuitry 3620 can determine to replace the CNN based on a value of the accuracy parameter in an effort to increase and/or otherwise improve the value. In some examples, in response to a determination to replace the first AI/ML model with a different AI/ML model, the ML software configuration circuitry 3620 can identify a second ML model in a configuration database. For example, the ML software configuration circuitry 3620 can identify the ANN, the DNN, etc., in the software templates 3512. In some examples, the ML software configuration circuitry 3620 generates a new configuration based on the replacement of the first AI/ML model with the second AI/ML model. For example, the ML software configuration circuitry 3620 can generate a new, updated, etc., version of the proposed HW/SW instance 3522 based on the replacement of the CNN with a different AI/ML model.

In some examples, the ML software configuration circuitry 3620 can determine to add a second AI/ML model to the configuration. For example, the ML software configuration circuitry 3620 can determine to add another AI/ML model, such as an ANN, a DNN, etc., in connection with the CNN. In some such examples, the ML software configuration circuitry 3620 can determine to add another AI/ML model based on a value of an evaluation parameter, such as a value of the accuracy parameter. In some examples, the ML software configuration circuitry 3620 can identify a second AI/ML model to add to the configuration by identifying the second AI/ML model in the software templates 3512, and/or, more generally, in the composable building block databases 3510.

In some examples, in response to a determination to add another AI/ML model to a configuration of the proposed HW/SW instance 3522, the ML software configuration circuitry 3620 determines one or more first layers of the first AI/ML model to execute a first portion of a workload and one or more second layers of the second AI/ML model to execute a second portion of the workload. For example, the ML software configuration circuitry 3620 can identify (or select) one or more first layers of the CNN to execute a first portion of the workload(s) 3516 and identify (or select) one or more second layers of the ANN, the DNN, etc., to execute a second portion of the workload(s) 3516. In some examples, the ML software configuration circuitry 3620 can determine a new configuration based on a topology of the one or more first layers and the one or more second layers. For example, the ML software configuration circuitry 3620 can determine a new and/or updated instance, version, etc., of the proposed HW/SW instance 3522 based on a topology that couples the first AI/ML model and the second AI/ML model.

The ML system configuration circuitry 3600 of the illustrated example of FIG. 36 includes the ML hardware configuration circuitry 3630 to generate a second configuration of hardware based on an AI/ML workload. In some examples, the ML hardware configuration circuitry 3630 can query a configuration database with the AI/ML workload using an API. For example, one(s) of the composable building block databases 3510 can implement a configuration database, and the ML hardware configuration circuitry 3630 can query the one(s) of the composable building block databases 3510. In some such examples, the ML hardware configuration circuitry 3630 can query the one(s) of the composable building block databases 3510 with the workload(s) 3516 or aspect(s) thereof as input(s).

In some examples, the ML hardware configuration circuitry 3630 can identify a first block (or portion) of hardware to execute a matrix-matrix workload. For example, the workload(s) 3516 can include a matrix-matrix computational operation, a vector-vector computational operation, a matrix-vector computational operation, etc., and/or any combination(s) thereof. In some examples, the ML hardware configuration circuitry 3630 can identify a first kernel of a GPU (or other hardware) to execute the matrix-matrix workload. In some such examples, the ML hardware configuration circuitry 3630 can identify the first kernel, and/or, more generally, the GPU, in one of the hardware templates 3514, the hardware templates 3674, etc.

In some examples, the ML hardware configuration circuitry 3630 can identify a second block (or portion) of the hardware to execute a vector-vector workload. For example, the ML hardware configuration circuitry 3630 can identify a second kernel of the GPU (or other hardware) to execute the vector-vector workload. In some such examples, the ML hardware configuration circuitry 3630 can identify the second kernel, and/or, more generally, the GPU, in one of the hardware templates 3514.

In some examples, the ML hardware configuration circuitry 3630 can identify a third block (or portion) of the hardware to execute a matrix-vector workload. For example, the ML hardware configuration circuitry 3630 can identify a third kernel of the GPU (or other hardware) to execute the matrix-vector workload. In some such examples, the ML hardware configuration circuitry 3630 can identify the third kernel, and/or, more generally, the GPU, in one of the hardware templates 3514.

In some examples, the ML hardware configuration circuitry 3630 can identify a register file to configure respective ones of the first block, the second block, and/or the third block. For example, the ML hardware configuration circuitry 3630 can identify a register file associated with the GPU, and the register file can be identified in one of the hardware templates 3514. In some such examples, the register file can include a first configuration to configure the first kernel of the GPU, a second configuration to configure the second kernel of the GPU, and/or a third configuration to configure the third kernel of the GPU.

In some examples, the ML hardware configuration circuitry 3630 determines whether another type of hardware and/or another instance of the hardware has been identified. For example, the ML hardware configuration circuitry 3630 can determine that another instance of the GPU is identified in addition to the first instance of the GPU. In some examples, the ML hardware configuration circuitry 3630 can determine that a different type of hardware, such as an AI processor, has been identified in the hardware templates 3514. In some such examples, the ML hardware configuration circuitry 3630 can generate a topology (e.g., an interconnection or interconnect topology, an input/output (I/O) topology, the one(s) of the interconnect topologies 3676, etc.) based on connection(s) between one(s) of the first GPU and the second GPU or the AI processor. For example, the ML hardware configuration circuitry 3630 can select the first GPU to be a first or primary hardware and the second GPU or the AI processor to be a second or secondary hardware. For example, the ML hardware configuration circuitry 3630 can determine that the first GPU and the second GPU or the AI processor can be coupled together by connecting output(s) of the first GPU to input(s) of the second GPU or the AI processor.

In some examples, the ML hardware configuration circuitry 3630 adjusts the second configuration (e.g., a configuration of hardware to be included in the proposed HW/SW instance 3522) based on an evaluation parameter. For example, the evaluator 3504 can calculate and/or otherwise determine the evaluation parameters 3526 based on an evaluation of the proposed HW/SW instance 3522. In some such examples, the evaluator 3504 can determine a first evaluation parameter of the evaluation parameters 3526 to be a throughput parameter (e.g., a throughput of output(s) of the proposed HW/SW instance 3522, a throughput evaluation parameter, etc.).

In some examples, the ML hardware configuration circuitry 3630 determines whether to replace first hardware with different hardware. For example, the ML hardware configuration circuitry 3630 can determine to replace the GPU with different hardware, such as a CPU, an AI processor, an FPGA, etc. In some such examples, the ML hardware configuration circuitry 3630 can determine to replace the GPU based on a value of the throughput parameter in an effort to increase and/or otherwise improve the value. In some examples, in response to a determination to replace the first hardware with different hardware, the ML hardware configuration circuitry 3630 can identify second hardware in a configuration database. For example, the ML hardware configuration circuitry 3630 can identify the CPU, the AI processor, the FPGA, etc., in the hardware templates 3514. In some examples, the ML hardware configuration circuitry 3630 generates a new configuration based on the replacement of the first hardware with the second hardware. For example, the ML hardware configuration circuitry 3630 can generate a new, updated, etc., version of the proposed HW/SW instance 3522 based on the replacement of the GPU with different hardware.

In some examples, the ML hardware configuration circuitry 3630 can determine to add second hardware to the configuration. For example, the ML hardware configuration circuitry 3630 can determine to add additional hardware, such as a CPU, another GPU, an AI processor, an FPGA, etc., in connection with the first GPU. In some such examples, the ML hardware configuration circuitry 3630 can determine to add additional hardware based on a value of an evaluation parameter, such as a value of the throughput parameter. In some examples, the ML hardware configuration circuitry 3630 can identify second hardware to add to the configuration by identifying the second hardware in the hardware templates 3514, and/or, more generally, in the composable building block databases 3510.

In some examples, in response to a determination to add hardware to a configuration of the proposed HW/SW instance 3522, the ML hardware configuration circuitry 3630 determines one or more first portions of the first hardware to execute a first portion of a workload and one or more second portions of the second hardware to execute a second portion of the workload. For example, the ML hardware configuration circuitry 3630 can identify (or select) one or more first kernels of the first GPU to execute a first portion of the workload(s) 3516 and identify (or select) one or more second kernels of the second GPU, the AI processor, the CPU, the FPGA, etc., to execute a second portion of the workload(s) 3516. In some examples, the ML hardware configuration circuitry 3630 can determine a new configuration based on a topology of the one or more first portions and the one or more second portions. For example, the ML hardware configuration circuitry 3630 can determine a new and/or updated instance, version, etc., of the proposed HW/SW instance 3522 based on a topology that couples the first hardware and the second hardware.

The ML system configuration circuitry 3600 of the illustrated example of FIG. 36 includes the configuration evaluation circuitry 3640 to generate an evaluation parameter based on an execution of a workload based on a first configuration and a second configuration. For example, the configuration evaluation circuitry 3640 can generate the evaluation parameters 3526. In some such examples, the configuration evaluation circuitry 3640 can generate the evaluation parameters 3526 in response to emulating, simulating, etc., an execution of the workload(s) 3516 (or a different workload) utilizing the proposed HW/SW instance 3522. In some such examples, the configuration evaluation circuitry 3640 can evaluate the proposed HW/SW instance 3522 based on a first configuration of software (e.g., one or more AI/ML models) and a second configuration of hardware (e.g., one or more instances and/or types of hardware) that compose the proposed HW/SW instance 3522.

In some examples, the configuration evaluation circuitry 3640 can determine whether an evaluation parameter satisfies a threshold. For example, the configuration evaluation circuitry 3640 can determine whether a first value of an accuracy parameter satisfies an accuracy threshold. In some such examples, the configuration evaluation circuitry 3640 can determine that the first value satisfies the accuracy threshold in response to a determination that the first value is greater than the accuracy threshold. For example, the configuration evaluation circuitry 3640 can determine that an accuracy parameter of 40% does not satisfy an accuracy threshold of 90% because 40% is less than 90%. In some examples, the configuration evaluation circuitry 3640 can determine that an accuracy parameter of 95% satisfies an accuracy threshold of 90% because 95% is greater than 90%. Additionally or alternatively, the configuration evaluation circuitry 3640 may determine whether one or more other evaluation parameters (e.g., a latency parameter, a throughput parameter, etc.) satisfies one or more respective evaluation thresholds (e.g., a latency threshold, a throughput threshold, etc.).

The ML system configuration circuitry 3600 of the illustrated example of FIG. 36 includes the ontology generation circuitry 3650 to generate, update, and/or otherwise maintain an ontology database. In some examples, the ontology generation circuitry 3650 generates the ontology database 3508 based on at least one of the composable building block databases 3510 or the application store 3515. In some such examples, the ontology generation circuitry 3650 can generate the ontology database 3508 by including associations between different AI/ML models, configuration(s) thereof, types of AI/ML workload(s), etc., and/or any combination(s) thereof. In some such examples, the associations can be implemented by an identifier, a variable, a pointer, etc., or any other identification data structure. In some examples, the ontology generation circuitry 3650 can update the ontology database 3508 based on the proposed HW/SW instance 3522, historical configurations such as the historical configurations 3678, the evaluation parameters 3526, the reward function 3528, etc., and/or any combination(s) thereof. For example, the ontology generation circuitry 3650 can update the ontology database 3508 based on previous versions of the proposed HW/SW instance 3522, one(s) of the evaluation parameters 3526 associated therewith, etc.

In some examples, the ontology generation circuitry 3650 identifies an AI/ML model based on historical configurations. For example, the ontology generation circuitry 3650 can identify an AI/ML model, such as an NN, based on previously generated ML compute nodes, proposed HW/SW instances, etc., and/or any combination(s) thereof. In some examples, the ontology generation circuitry 3650 identifies hardware based on historical configurations, such as the historical configurations 3678. For example, the ontology generation circuitry 3650 can identify hardware, such as a GPU, based on previously generated ML compute nodes, proposed HW/SW instances, etc., and/or any combination(s) thereof.

The ML system configuration circuitry 3600 of the illustrated example of FIG. 36 includes the workload execution circuitry 3660 to deploy compute node(s) to execute a workload. For example, the workload execution circuitry 3660 can deploy the ML compute node 3517 to execute the workload(s) 3516. In some such examples, the workload execution circuitry 3660 can deploy the ML compute node 3517 in response to one or more evaluation parameters satisfying one or more respective thresholds. In some examples, the workload execution circuitry 3660 can deploy the ML compute node 3517 by compiling the software 3519 using a software configuration determined by the ML software configuration circuitry 3620. In some examples, the workload execution circuitry 3660 can deploy the ML compute node 3517 by configuring the hardware 3521 using a hardware configuration determined by the ML hardware configuration circuitry 3630. In some such examples, the workload execution circuitry 3660 can execute one or more AI/ML models, which may be implemented by the software 3519, based on the software configuration and the hardware configuration.

The ML system configuration circuitry 3600 of the illustrated example of FIG. 36 includes the datastore 3670 to record data (e.g., the software templates 3672, the hardware templates 3674, the interconnect topologies 3676, the historical configurations 3678, etc.). The datastore 3670 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., electrically erasable programmable read-only memory (EEPROM), FLASH memory, a hard disk drive (HDD), a solid-state disk (SSD) drive, etc.). The datastore 3670 may additionally or alternatively be implemented by one or more double data rate (DDR) memories, such as DDR, DDR2, DDR3, DDR4, DDR5, mobile DDR (mDDR), DDR SDRAM, etc. The datastore 3670 may additionally or alternatively be implemented by one or more mass storage devices such as HDD(s), compact disk (CD) drive(s), digital versatile disk (DVD) drive(s), SSD drive(s), Secure Digital (SD) card(s), CompactFlash (CF) card(s), etc. While in the illustrated example the datastore 3670 is illustrated as a single datastore, the datastore 3670 may be implemented by any number and/or type(s) of datastores. Furthermore, the data stored in the datastore 3670 can be in any data format such as, for example, binary data, comma delimited data, tab delimited data, structured query language (SQL) structures, etc. In some examples, the datastore 3670 can include and/or otherwise implement one or more databases. The term “database” as used herein means an organized body of related data, regardless of the manner in which the data or the organized body thereof is represented. For example, the organized body of related data may be in the form of one or more of a table, a map, a grid, a packet, a datagram, a frame, a file, a document, a report, a list or in any other form.

In some examples, the software templates 3672 can be implemented by the software templates 3512 of FIG. 35. For example, the software templates 3672 can include a first template corresponding to a first type of AI/ML model (e.g., a NN such as an ANN, a CNN, a DNN, an RNN, etc.) and/or configuration(s) associated thereof. In some such examples, the software templates 3672 can include a second template corresponding to a second type of AI/ML model (e.g., a Transformer model) and/or configuration(s) thereof, a third type of AI/ML model (e.g., a reinforcement learning model) and/or configuration(s) thereof, etc.

In some examples, the hardware templates 3674 can be implemented by the hardware templates 3514 of FIG. 35. For example, the hardware templates 3674 can include a first template corresponding to a first type of hardware (e.g., a CPU, etc.) and/or configuration(s) associated thereof, a second template corresponding to a second type of hardware (e.g., a GPU) and/or configuration(s) thereof, a third type of hardware (e.g., an AI processor) and/or configuration(s) thereof, etc.

In some examples, the interconnect topologies 3676 can be implemented by portion(s) of the software templates 3512 and/or the hardware templates 3514. For example, the interconnect topologies 3676 can include AI/ML network topologies (e.g., layer configurations, etc.), model input(s), model output(s), etc. In some such examples, the AI/ML network topologies, the model input(s), the model output(s), etc., can be included in portion(s) of the software templates 3512. In some examples, the interconnect topologies 3676 can include hardware architectural topologies (e.g., kernel couplings, printed circuit board layouts, etc.), input(s) (e.g., bare metal input(s), interface(s), etc.), output(s) (e.g., bare metal output(s), interface(s), etc.), etc. In some such examples, the hardware architectural topologies, the input(s), the output(s), etc., can be included in portion(s) of the hardware templates 3514.

In some examples, the historical configurations 3678 can be implemented by portion(s) of the ontology database 3508, and/or, more generally, the ontology database 3508. For example, the historical configurations 3678 can include previously generated, determined, identified, etc., ML compute nodes, proposed HW/SW instances, workload(s), etc., and/or any combination(s) thereof. In some examples, the historical configurations 3678 can include occurrences or other statistics associated with hardware and/or software kernels in ML compute nodes.

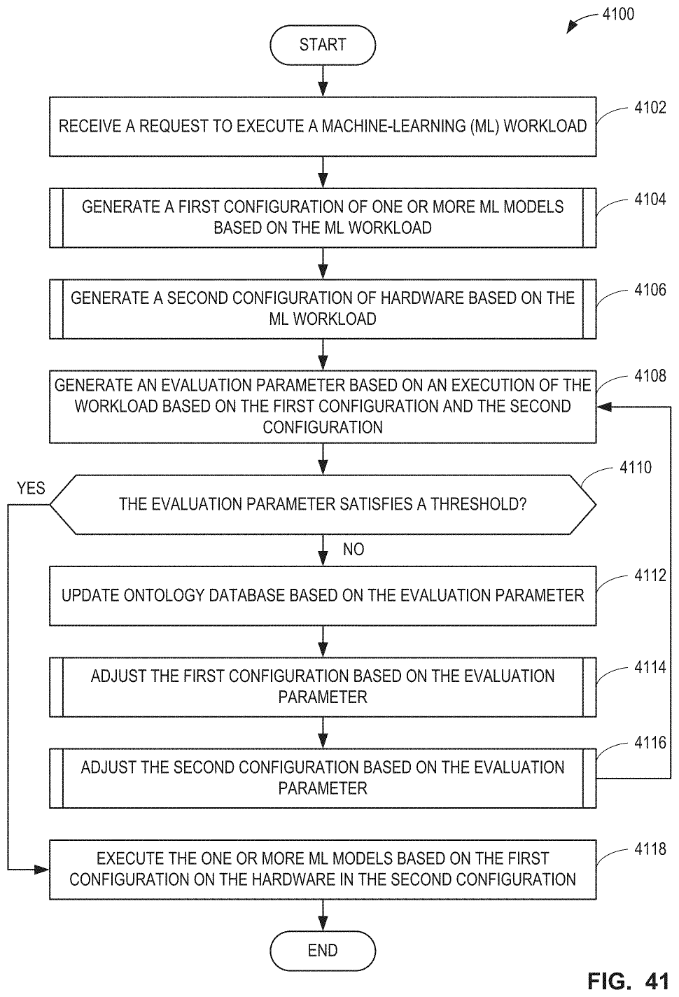

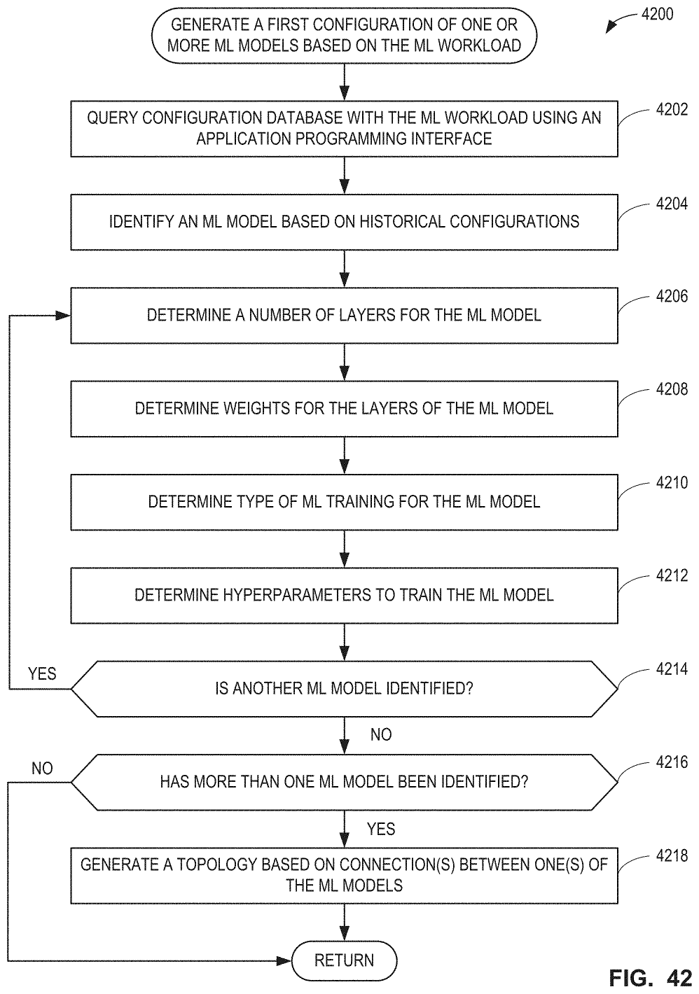

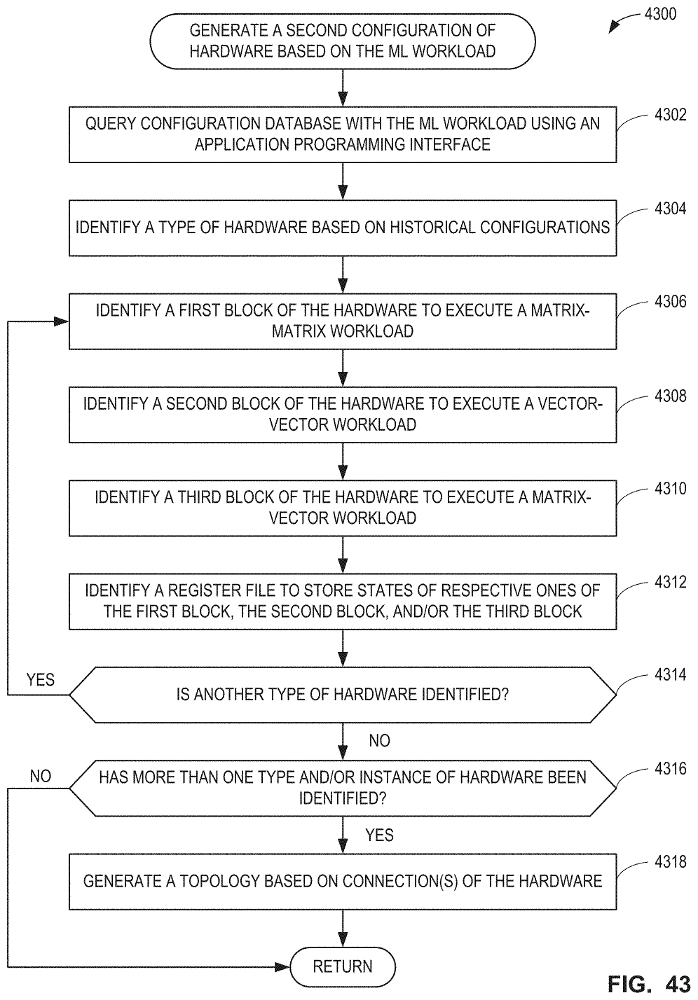

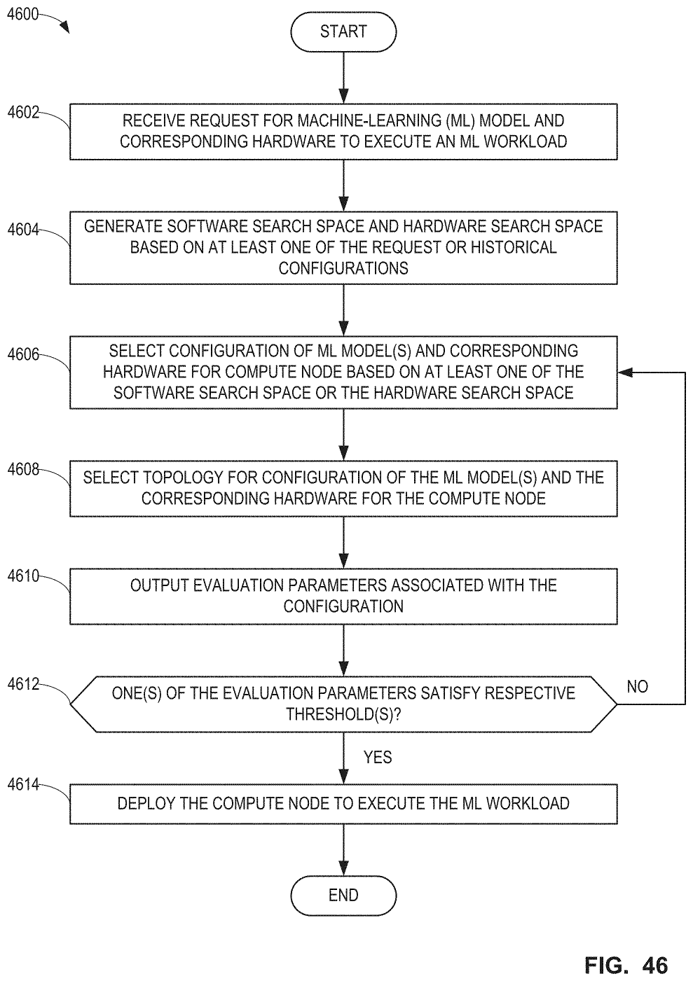

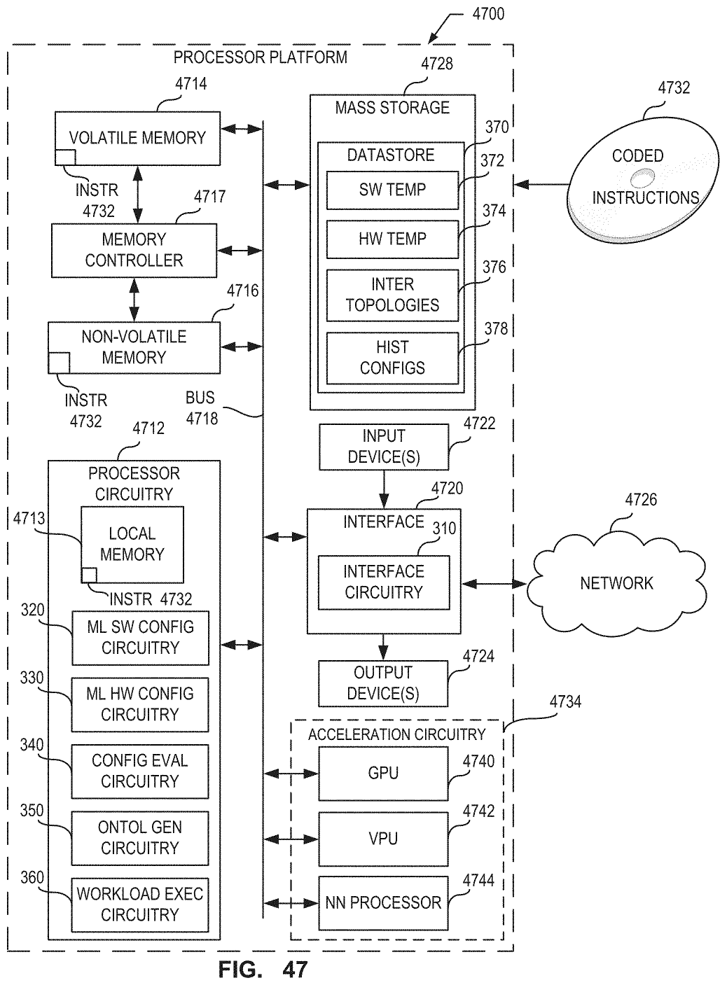

In some examples, the ML system configuration circuitry 3600 includes means for receiving a workload. For example, the means for receiving may be implemented by the interface circuitry 3610. In some examples, the interface circuitry 3610 may be instantiated by processor circuitry such as the example processor circuitry 4712 of FIG. 47. For instance, the interface circuitry 3610 may be instantiated by the example general purpose processor circuitry 34500 of FIG. 345 executing machine executable instructions such as that implemented by at least block 4102 of FIG. 41, block 4202 of FIG. 42, block 4302 of FIG. 43, and block 4602 of FIG. 46. In some examples, the interface circuitry 3610 may be instantiated by hardware logic circuitry, which may be implemented by an ASIC or the FPGA circuitry 34600 of FIG. 346 structured to perform operations corresponding to the machine readable instructions. Additionally or alternatively, the interface circuitry 3610 may be instantiated by any other combination of hardware, software, and/or firmware. For example, the interface circuitry 3610 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.), a transmitter, a receiver, a transceiver, a modem, a residential gateway, a wireless access point, and/or a network interface of any kind structured to execute some or all of the machine readable instructions and/or to perform some or all of the operations corresponding to the machine readable instructions without executing software or firmware, but other structures are likewise appropriate.

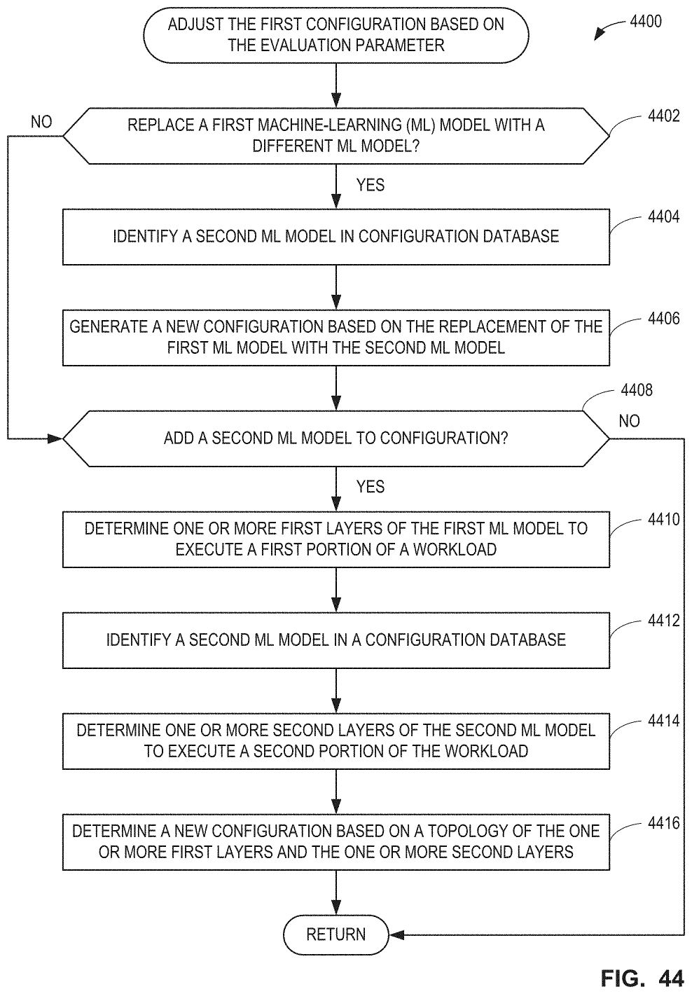

In some examples, the ML system configuration circuitry 3600 includes first means for generating a first configuration of one or more machine-learning models based on a workload. In some such examples, the first configuration is stored in a first configuration database, the first configuration database includes a plurality of machine-learning models, and the plurality of the machine-learning models including the one or more machine-learning models. For example, the first means for generating may be implemented by the ML software configuration circuitry 3620. In some examples, the ML software configuration circuitry 3620 may be instantiated by processor circuitry such as the example processor circuitry 4712 of FIG. 47. For instance, the ML software configuration circuitry 3620 may be instantiated by the example general purpose processor circuitry 34500 of FIG. 345 executing machine executable instructions such as that implemented by at least blocks 4104 and 4114 of FIG. 41, blocks 4202, 4206, 4208, 4210, 4212, 4214, 4216, and 4218 of FIG. 42, blocks 4402, 4404, 4406, 4408, 4410, 4412, 4414, and 4416 of FIG. 44, and blocks 4604, 4606, and 4608 of FIG. 46. In some examples, the ML software configuration circuitry 3620 may be instantiated by hardware logic circuitry, which may be implemented by an ASIC or the FPGA circuitry 34600 of FIG. 346 structured to perform operations corresponding to the machine readable instructions. Additionally or alternatively, the ML software configuration circuitry 3620 may be instantiated by any other combination of hardware, software, and/or firmware. For example, the ML software configuration circuitry 3620 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which the one or more machine-learning models include a first machine-learning model, the first means for generating is to, in response to the evaluation parameter not satisfying the threshold, identify a second machine-learning model in the first configuration database, generate a third configuration of the second machine-learning model, determine the evaluation parameter based on an execution of the workload based on the third configuration, and deploy the second machine-learning model to execute the workload based on the third configuration.

In some examples in which the one or more machine-learning models include a first machine-learning model, the first means for generating is to, in response to the evaluation parameter not satisfying the threshold, determine one or more first layers of the first machine-learning model to execute a first portion of the workload, identify a second machine-learning model in the first configuration database, determine one or more second layers of the second machine-learning model to execute a second portion of the workload, and determine a third configuration based on a topology of the one or more first layers and the one or more second layers, the topology based on an output from the one or more first layers as an input to the one or more second layers.

In some examples in which the one or more machine-learning models include a first machine-learning model, the first means for generating is to identify the first machine-learning model in the first configuration database, identify a second machine-learning model based on a query of an ontology database with an identifier of the first machine-learning model as an input, the ontology database including an association of the first machine-learning model and the second machine-learning model, and in response to the evaluation parameter satisfying the threshold, update the ontology database based on the first configuration.

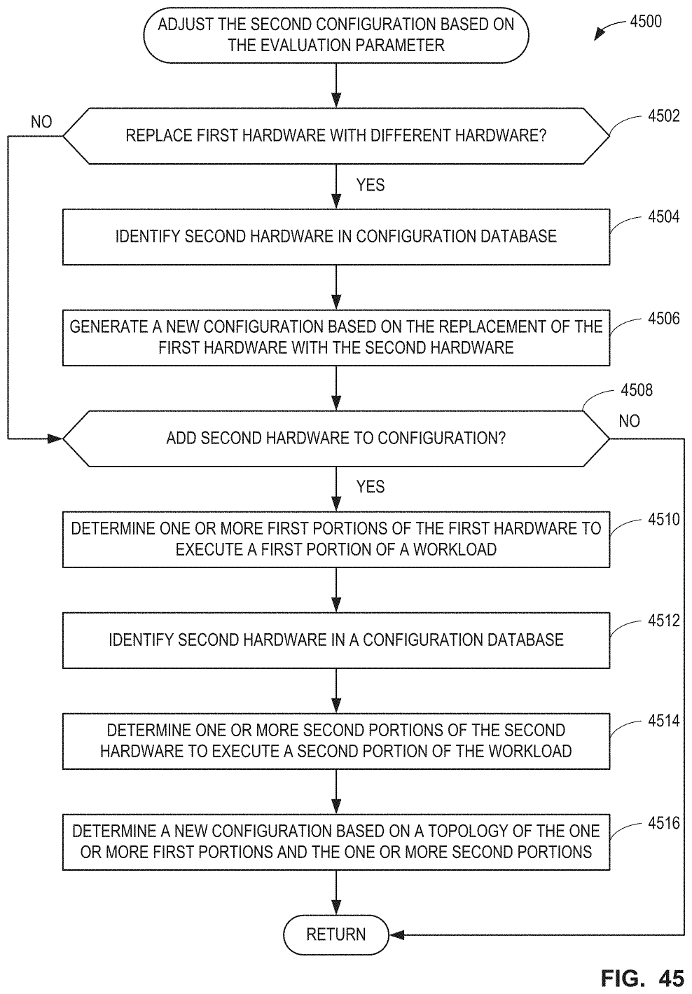

In some examples, the ML system configuration circuitry 3600 includes second means for generating a second configuration of hardware. In some such examples, the second configuration is stored in a second configuration database, the second configuration database includes one or more portions of a plurality of hardware, and the plurality of the hardware including the hardware. For example, the second means for generating may be implemented by the ML hardware configuration circuitry 3630. In some examples, the ML hardware configuration circuitry 3630 may be instantiated by processor circuitry such as the example processor circuitry 4712 of FIG. 47. For instance, the ML hardware configuration circuitry 3630 may be instantiated by the example general purpose processor circuitry 34500 of FIG. 345 executing machine executable instructions such as that implemented by at least blocks 4106 and 4116 of FIG. 41, blocks 4302, 4306, 4308, 4310, 4312, 4314, 4316, and 4318 of FIG. 43, blocks 4502, 4504, 4506, 4508, 4510, 4512, 4514, and 4516 of FIG. 45, and blocks 4604, 4606, and 4608 of FIG. 46. In some examples, the ML hardware configuration circuitry 3630 may be instantiated by hardware logic circuitry, which may be implemented by an ASIC or the FPGA circuitry 34600 of FIG. 346 structured to perform operations corresponding to the machine readable instructions. Additionally or alternatively, the ML hardware configuration circuitry 3630 may be instantiated by any other combination of hardware, software, and/or firmware. For example, the ML hardware configuration circuitry 3630 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which the one or more portions include at least one of a first block, a second block, or a third block, the second means for generating is to identify the first block of the hardware to execute a matrix-matrix workload, identify the second block of the hardware to execute a vector-vector workload, identify the third block of the hardware to execute a matrix-vector workload, and identify register files for respective ones of the first block, the second block, and the third block, the register files to store states for the respective ones of the first block, the second block, and the third block, the second configuration based on a topology including at least one of the first block, the second block, or the third block.

In some examples in which the hardware is first hardware, the second means for generating is to, in response to the evaluation parameter not satisfying the threshold, identify second hardware in the second configuration database, generate a third configuration of the second hardware, determine the evaluation parameter based on an execution of the workload by the second hardware in the third configuration, and deploy the second hardware with the third configuration to execute the one or more machine-learning models to execute the workload.

In some examples in which the hardware is first hardware, the second means for generating is to, in response to the evaluation parameter not satisfying the threshold, determine one or more first portions of the first hardware to execute a first portion of the workload, identify second hardware in the first configuration database, determine one or more second portions of the second hardware to execute a second portion of the workload, and determine a third configuration based on a topology of the one or more first portions and the one or more second portions, the topology based on an output from the one or more first portions as an input to the one or more second portions.

In some examples, the ML system configuration circuitry 3600 includes means for determining an evaluation parameter based on an execution of a workload. In some such examples, the execution of the workload is based on a first configuration of one or more machine-learning models and a second configuration of hardware. In some such examples, the second configuration is stored in a second configuration database, the second configuration database includes one or more portions of a plurality of hardware, and the plurality of the hardware including the hardware. In some examples in which the evaluation parameter is a first evaluation parameter, the means for determining is to determine a reward function including the first evaluation parameter with a first weight and a second evaluation parameter with a second weight, the first weight greater than the second weight, and, in response to determining that at least one of the first evaluation parameter or the second evaluation parameter does not satisfy the threshold, change at least one of the first configuration or the second configuration to at least one of increase the first evaluation parameter or decrease the second evaluation parameter. For example, the means for determining may be implemented by the configuration evaluation circuitry 3640. In some examples, the configuration evaluation circuitry 3640 may be instantiated by processor circuitry such as the example processor circuitry 4712 of FIG. 47. For instance, the configuration evaluation circuitry 3640 may be instantiated by the example general purpose processor circuitry 34500 of FIG. 345 executing machine executable instructions such as that implemented by at least blocks 4108 and 4110 of FIG. 41 and blocks 4610 and 4612 of FIG. 46. In some examples, the configuration evaluation circuitry 3640 may be instantiated by hardware logic circuitry, which may be implemented by an ASIC or the FPGA circuitry 34600 of FIG. 346 structured to perform operations corresponding to the machine readable instructions. Additionally or alternatively, the configuration evaluation circuitry 3640 may be instantiated by any other combination of hardware, software, and/or firmware. For example, the configuration evaluation circuitry 3640 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ML system configuration circuitry 3600 includes means for generating, maintaining, and/or updating an ontology database based on an evaluation parameter. For example, the means for generating, maintaining, and/or updating may be implemented by the ontology generation circuitry 3650. In some examples, the ontology generation circuitry 3650 may be instantiated by processor circuitry such as the example processor circuitry 4712 of FIG. 47. For instance, the ontology generation circuitry 3650 may be instantiated by the example general purpose processor circuitry 34500 of FIG. 345 executing machine executable instructions such as that implemented by at least block 4112 of FIG. 41, block 4204 of FIG. 42, block 4304 of FIG. 43, and block 4604 of FIG. 46. In some examples, the ontology generation circuitry 3650 may be instantiated by hardware logic circuitry, which may be implemented by an ASIC or the FPGA circuitry 34600 of FIG. 346 structured to perform operations corresponding to the machine readable instructions. Additionally or alternatively, the ontology generation circuitry 3650 may be instantiated by any other combination of hardware, software, and/or firmware. For example, the ontology generation circuitry 3650 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ML system configuration circuitry 3600 includes means for executing one or more machine-learning models in a first configuration on hardware in a second configuration. In some such examples, the executing is in response to an evaluation parameter satisfying a threshold. In some such examples, the one or more machine-learning models and the hardware are to execute a workload. For example, the means for executing may be implemented by the workload execution circuitry 3660. In some examples, the workload execution circuitry 3660 may be instantiated by processor circuitry such as the example processor circuitry 4712 of FIG. 47. For instance, the configuration evaluation circuitry 3640 may be instantiated by the example general purpose processor circuitry 34500 of FIG. 345 executing machine executable instructions such as that implemented by at least blocks 4118 of FIG. 41 and block 4614 of FIG. 46. In some examples, the workload execution circuitry 3660 may be instantiated by hardware logic circuitry, which may be implemented by an ASIC or the FPGA circuitry 34600 of FIG. 346 structured to perform operations corresponding to the machine readable instructions. Additionally or alternatively, the workload execution circuitry 3660 may be instantiated by any other combination of hardware, software, and/or firmware. For example, the workload execution circuitry 3660 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ML system configuration circuitry 3600 includes means for storing data. In some examples, the data can include the software templates 3672, the hardware templates 3674, the interconnect topologies 3676, the historical configurations 3678, or any other data described herein. For example, the means for storing may be implemented by the datastore 3670. In some examples, the datastore 3670 may be instantiated by processor circuitry such as the example processor circuitry 4712 of FIG. 47. For instance, the datastore 3670 may be instantiated by the general purpose processor circuitry 34500 of FIG. 345 executing machine executable instructions. In some examples, the datastore 3670 may be instantiated by hardware logic circuitry, which may be implemented by an ASIC or the FPGA circuitry 34600 of FIG. 346 structured to perform operations corresponding to the machine readable instructions. Additionally or alternatively, the datastore 3670 may be instantiated by any other combination of hardware, software, and/or firmware. For example, the datastore 3670 may be implemented by one or more mass storage devices (e.g., the one or more mass storage devices 4728 of FIG. 47), one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the ML system configurator 3402 of FIGS. 34 and/or 35 is illustrated in FIG. 36, one or more of the elements, processes, and/or devices illustrated in FIG. 36 may be combined, divided, re-arranged, omitted, eliminated, and/or implemented in any other way. Further, the example interface circuitry 3610, the example ML software configuration circuitry 3620, the example ML hardware configuration circuitry 3630, the example configuration evaluation circuitry 3640, the example ontology generation circuitry 3650, the example workload execution circuitry 3660, the example datastore 3670, the example bus 3680, and/or, more generally, the example ML system configurator 3402 of FIGS. 34 and/or 35, may be implemented by hardware alone or by hardware in combination with software and/or firmware. Thus, for example, any of the example interface circuitry 3610, the example ML software configuration circuitry 3620, the example ML hardware configuration circuitry 3630, the example configuration evaluation circuitry 3640, the example ontology generation circuitry 3650, the example workload execution circuitry 3660, the example datastore 3670, the example bus 3680, and/or, more generally, the example ML system configurator 3402, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as FPGAs. Further still, the example ML system configurator 3402 of FIGS. 34 and/or 35 may include one or more elements, processes, and/or devices in addition to, or instead of, those illustrated in FIG. 36, and/or may include more than one of any or all of the illustrated elements, processes and devices.

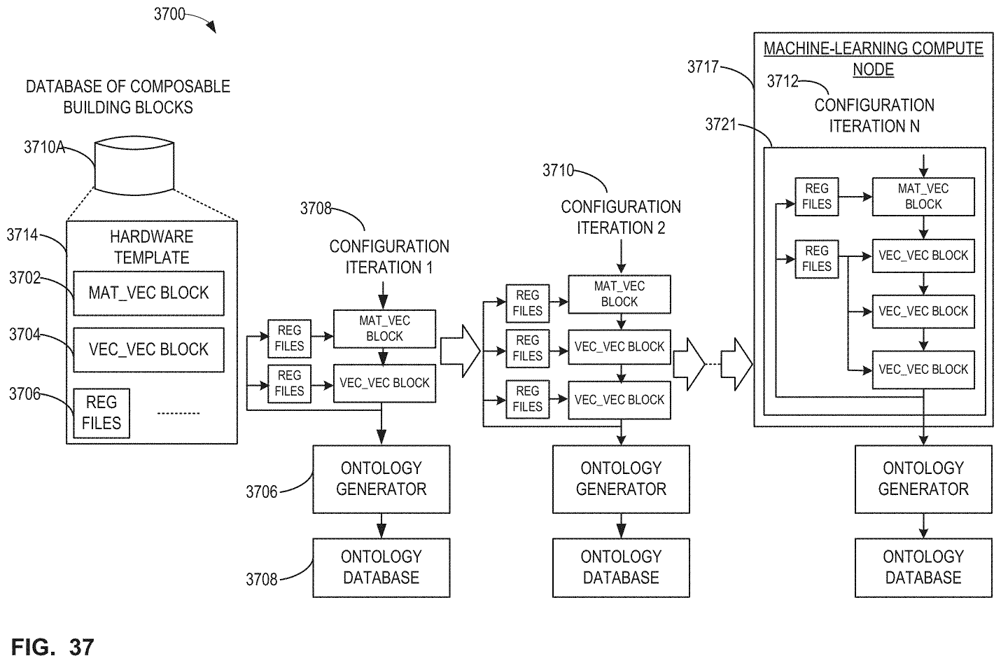

FIG. 37 is an illustration of an example workflow 3700 to generate an ML compute node, such as the composable ML compute node 3517 of FIG. 35. The workflow 3700 includes a first composable building block database 3510A of the composable building block databases 3510 of FIG. 35, a first hardware template 3514A of the hardware templates 3514 of FIG. 35, the ontology generator 3506 of FIG. 35, the ontology database 3508 of FIG. 35, the ML compute node 3517 of FIG. 35, and the hardware 3521 of FIG. 35.

The first hardware template 3514A of the illustrated example includes a first example block 3702, a second example block 3704, and example register files 3706. In this example, the first block 3702 is a matrix-vector block (identified by MAT_VEC BLOCK). For example, the first block 3702 can be a hardware block or portion of hardware, such as the GPU 3422 of FIG. 34 (or the CPU 3418, the AI processor 3426, the FPGA 3430, etc., of FIG. 34), that can execute a matrix-vector computational operation. Additionally and/or alternatively, the first block 3702 can be a software block, kernel, etc., which can include a portion or snippet of machine readable instructions. In some such examples, the first block 3702 can be implemented by code that, when executed by hardware or processor circuitry, can execute a matrix-vector calculation.

In this example, the second block 3702 is a vector-vector block (identified by VEC_VEC BLOCK). For example, the second block 3704 can be a hardware block or portion of hardware, such as the GPU 3422 of FIG. 34 (or the CPU 3418, the AI processor 3426, the FPGA 3430, etc., of FIG. 34), that can execute a vector-vector computational operation. Additionally and/or alternatively, the second block 3704 can be a software block, kernel, etc., which can include a portion or snippet of machine readable instructions. In some such examples, the second block 3704 can be implemented by code that, when executed by hardware or processor circuitry, can execute a vector-vector calculation.

In this example, the register files 3706 can include one or more register files that each can be implemented by an array, a bank, etc., of processor registers. For example, the register files 3706 can store states of processor threads (e.g., CPU threads, GPU threads, etc.) that support execution of workloads.

In the illustrated example of FIG. 37, the workflow 3700 begins when the ML system configurator 3402 of FIGS. 34 and/or 35 generate a first example configuration 3708 (identified by CONFIGURATION ITERATION 34) based on the first hardware template 3514A, and/or, more generally, the first composable building block database 3510A. The first configuration 3708 of the illustrated example includes the first block 3702, the second block 3704, and two register files of the register files 3706. In response to generating the first configuration 3708, the ML system configurator 3402 can evaluate the first configuration 3708 based on an execution of the workload(s) 3516 of FIG. 35 utilizing the first configuration 3708. The ontology generator 3506 can update the ontology database 3508 based on the first configuration 3708, evaluation parameter(s) associated with the first configuration 3708, etc., and/or any combination(s) thereof.

In the illustrated example of FIG. 37, the workflow 3700 includes the ML system configurator 3402 generating a second example configuration 3710 (identified by CONFIGURATION ITERATION 35) based on the first hardware template 3514A, and/or, more generally, the first composable building block database 3510A. In the illustrated example, the second configuration 3710 is an iteration, an update, etc., of the first configuration 3708. In some examples, the iteration of the first configuration 3708 can be effectuated based on evaluation parameter(s) associated with the first configuration 3708 (e.g., effectuated by a motivation to increase evaluation parameter values such as accuracy, latency, throughput, etc.). The second configuration 3710 of the illustrated example includes the first block 3702, two instances of the second block 3704, and three register files of the register files 3706. In response to generating the second configuration 3710, the ML system configurator 3402 can evaluate the second configuration 3710 based on an execution of the workload(s) 3516 with the second configuration 3710. The ontology generator 3506 can update the ontology database 3508 based on the second configuration 3710, evaluation parameter(s) associated with the second configuration 3710, etc., and/or any combination(s) thereof.

Advantageously, the ML system configurator 3402 can simultaneously evolve multiple sets of relevant composable building blocks, each covering a different architecture class and design style. For example, the workflow 3700 can be execute for different hardware simultaneously (e.g., substantially simultaneously). In some such examples, the workflow 3700 can be executed for a GPU, a CPU, an AI processor, etc., at substantially the same time. Advantageously, simultaneously evolving multiple sets of relevant composable building blocks for different hardware, can result in the identification of hardware that satisfies requirements for a given workload. For example, the ML system configurator 3402 can determine that an AI processor architecture based on the systolic array design style can be suitable for compute-intensive AI models, but not suitable for memory-bound and less compute-intensive workloads. Therefore, by simultaneously evolving hardware architectures with different design styles allows the ML system configurator 3402 to evolve flexibly to achieve the best accuracy and hardware efficiency combination during the co-design process, which may be implemented entirely and/or partially by the workflow 3700. Similarly, the workflow 3700 can be executed in the software search space 3518 of FIG. 35 by simultaneously evolving multiple sets of relevant composable building blocks for different software. By way of example in the neural network software search, there are multiple classes of networks with their own beneficial properties (e.g., RNNs, CNNs, Transfomers, etc.) and its own composable building block(s) (e.g., matrix x vector for RNNs, convolutions for CNNs, etc.).

During the workflow 3700, the ML system configurator 3402 can generate and/or otherwise identify the ML compute node 3517 based on multiple configuration iterations (e.g., the first configuration 3708, the second configuration 3710, etc.). In this example, the ML system configurator 3402 can generate the ML compute node 3517 based on a third example configuration 3712 (identified by CONFIGURATION ITERATION N). The third configuration 3712 includes the first block 3702, three instances of the third block 3704, and two register files of the register files 3706. The ontology generator 3506 can update the ontology database 3508 based on the third configuration 3712, evaluation parameter(s) associated with the third configuration 3712, etc., and/or any combination(s) thereof.

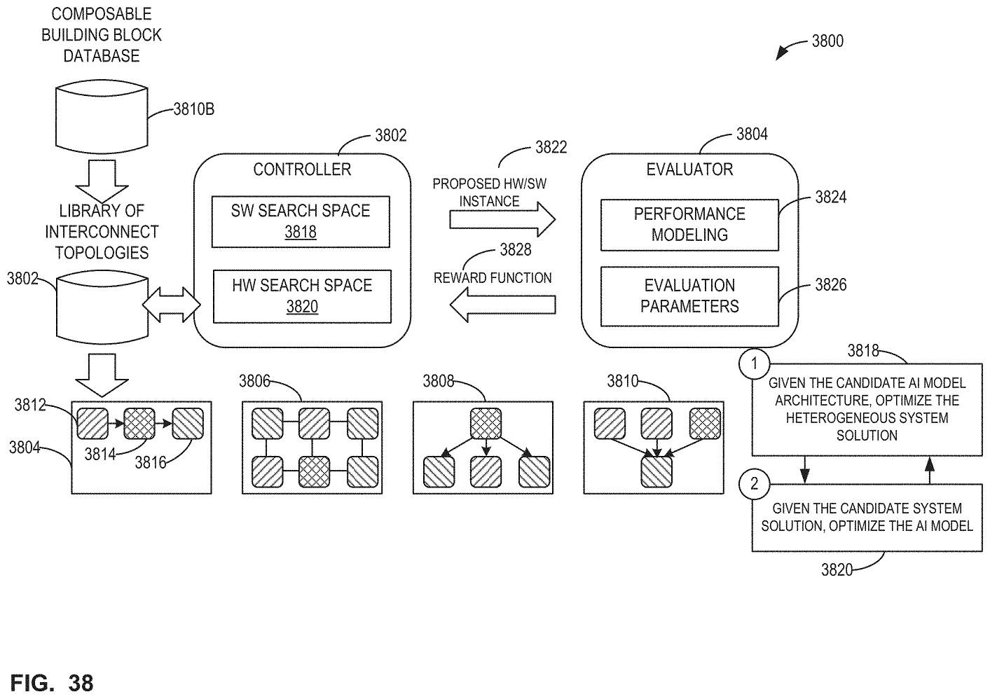

FIG. 38 is an illustration of another example workflow 3800 to identify a composable machine learning compute node, such as the ML compute node 3517 of FIG. 35. The workflow 3800 of the illustrated example includes a second composable building block database 3510B of the composable building block databases 3510 of FIG. 35, the controller 3502 of FIG. 35, the evaluator 3504 of FIG. 35, the software search space 3518 of FIG. 35, the hardware search space 3520 of FIG. 35, the proposed HW/SW instance 3522 of FIG. 35, the performance modeling 3524 of FIG. 35, the evaluation parameters 3526 of FIG. 35, the reward function 3528 of FIG. 35, and an example library of interconnect topologies 3802.

In the illustrated example, the second composable building block database 3510B includes and/or otherwise implements the library of interconnect topologies 3802. In some examples, the library of interconnect topologies 3802 can be implemented by the interconnect topologies 3676 of FIG. 36. In the illustrated example, the library of interconnect topologies 3802 depict example topologies of different example nodes 3804, 3806, 3808, 3810 including a first example node 3804, a second example node 3806, a third example node 3808, and a fourth example node 3810. The nodes 3804, 3806, 3808, 3810 of the illustrated example are heterogeneous compute nodes, which may be implemented by one or more portions from different types of hardware. For example, the first node 3804 includes a first example hardware kernel 3812, a second example hardware kernel 3814, and a third example hardware kernel 3816. In some such examples, the first hardware kernel 3812 can be a hardware kernel of a GPU, the second hardware kernel 3814 can be a hardware kernel of an AI processor, and the third hardware kernel 3816 can be a hardware kernel of a CPU.

In the illustrated example, each of the nodes 3804, 3806, 3808, 3810 have a different topology (e.g., an interconnection configuration). For example, the first node 3804 has a first topology in which each of the kernels 3812, 3814, 3816 are in sequence. The second node 3806 has a second topology in which each of the kernels 3812, 3814, 3816 are coupled to two other kernels. The third node 3808 has a third topology in which one kernel provides outputs to each of the remaining kernels. The fourth node 3810 has a fourth topology in which all but one kernel provide their respective outputs to another kernel. Alternatively, any other topology may be included in the library of interconnect topologies 3802.

The workflow 3800 can generally implement a first example operation 3818 and a second example operation 3820. For example, the ML system configurator 3402 can execute the first operation 3818 by optimizing and/or otherwise improving a heterogeneous system solution (e.g., an example implementation of the ML compute node 3517) given a candidate AI model architecture (e.g., the software 3519 of FIG. 35, portion(s) of the proposed HW/SW instance 3522 of FIG. 35, etc.). In some such examples, the ML system configurator 3402 can iteratively evolve the hardware portion of the proposed HW/SW instance 3522 by iteratively evaluating one(s) of the nodes 3804, 3806, 3808, 3810 and their respective topologies to determine which one(s) of the nodes 3804, 3806, 3808, 3810 achieves improved and/or otherwise optimal values of evaluation parameters of interest.

In some examples, the ML system configurator 3402 can execute the second operation 3820 by optimizing and/or otherwise improving the AI model given the candidate system solution. For example, the ML system configurator 3402 can iteratively evolve the software portion of the proposed HW/SW instance 3522 by iteratively evaluating different AI/ML models, different AI/ML model topologies, etc., in response to a change in the hardware portion of the proposed HW/SW instance 3522. In some examples, the first operation 3818 and the second operation 3820 can be iteratively executed to identify (i) the best and/or otherwise optimal target platform (e.g., hardware and/or software platform) of different compute kernels and/or (ii) the best and/or otherwise optimal interconnect topology between different compute nodes.

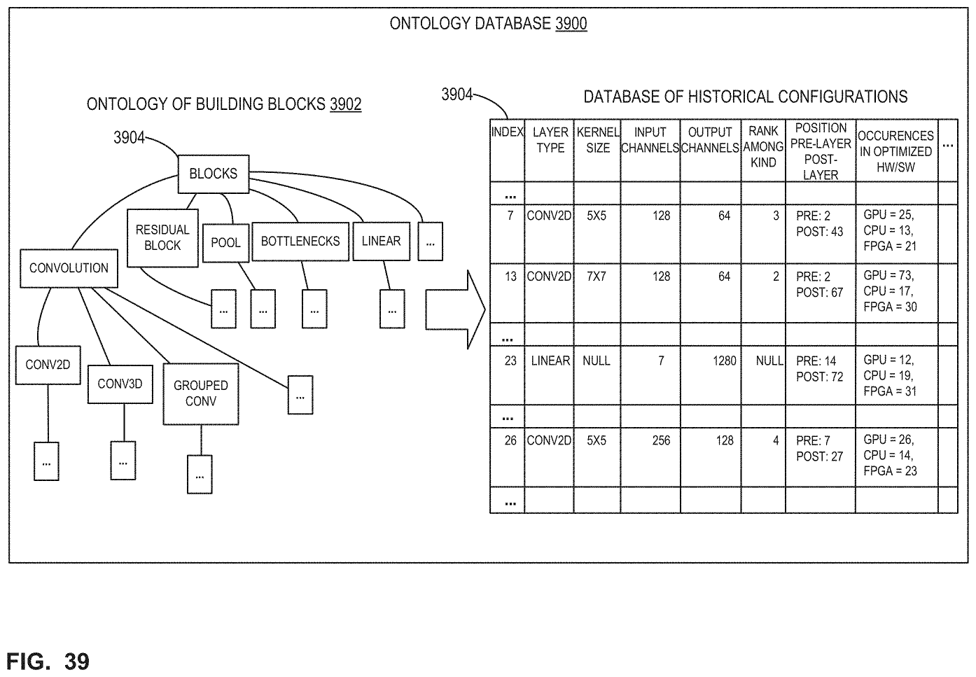

FIG. 39 is an illustration of an example implementation of an example ontology database 3900. In some examples, the ontology database 3900 can implement the ontology database 3508 of FIG. 35, the historical configurations 3678 of FIG. 36, and/or the datastore 3670 of FIG. 36.

The ontology database 3900 of the illustrated example includes an example ontology of building blocks 3902. The ontology of building blocks 3902 of the illustrated example is implemented by a graph (e.g., an ontology graph). Additionally and/or alternatively, the ontology of building blocks 3902 may be implemented by any other data representation such as a table, a map, a grid, a packet, a datagram, a frame, a file, a document, a report, a list or in any other form. The ontology of building blocks 3902 includes relationships of example software blocks 3904 with one(s) of each other. For example, the software blocks 3904 can correspond to portion(s) of an AI/ML model. In the illustrated example, the software blocks 3904 include convolution blocks, residual blocks, pool blocks, bottleneck blocks, linear blocks, etc. In the illustrated example, the convolution blocks include two-dimensional convolution (identified by CONV2D), three-dimensional convolution (CONV3D), grouped convolution, etc. For example, different layers of the ontology of building blocks 3902 can provide increased granularity of different types and sub-types of AI/ML components.

The ontology database 3900 of the illustrated example includes an example database of historical configurations 3904. The database 3904 of the illustrated example is implemented by a table (e.g., a historical configuration table). Additionally and/or alternatively, the database 3904 may be implemented by any other data representation such as a graph, a map, a grid, a packet, a datagram, a frame, a file, a document, a report, a list or in any other form. The database 3904 of the illustrated example includes columns for indices, layer types, kernel sizes, input channels, output channels, rank among kind, positions of pre- and post-layers, occurrences in optimized SW/HW, etc. In the illustrated example, a first one of the indices (identified by INDEX 7) corresponds to a layer of an AI/ML model, which in this example is a layer at a particular position in a neural network that may implement two-dimensional convolution. In the illustrated example, INDEX 7 corresponds to two-dimensional convolution with a kernel size of 5×5, 128 input channels, 64 output channels, and a rank of third among two-dimensional convolution layers. In the illustrated example, the two-dimensional convolution layer identified by INDEX 7 typically has a pre-layer corresponding to the layer identified at INDEX 2 in the table and a post-layer corresponding to the layer identified at INDEX 43 in the table. For example, an AI/ML model can have a first layer (e.g., a layer identified by INDEX 2), a second layer (e.g., a layer identified by INDEX 7), and a third layer (e.g., a layer identified by INDEX 43). In some such examples, output(s) of the layer identified by INDEX 2 is/are provided to input(s) of the layer identified by INDEX 7. In some such examples, output(s) of the layer identified by INDEX 7 is/are provided to input(s) of the layer identified by INDEX 43.

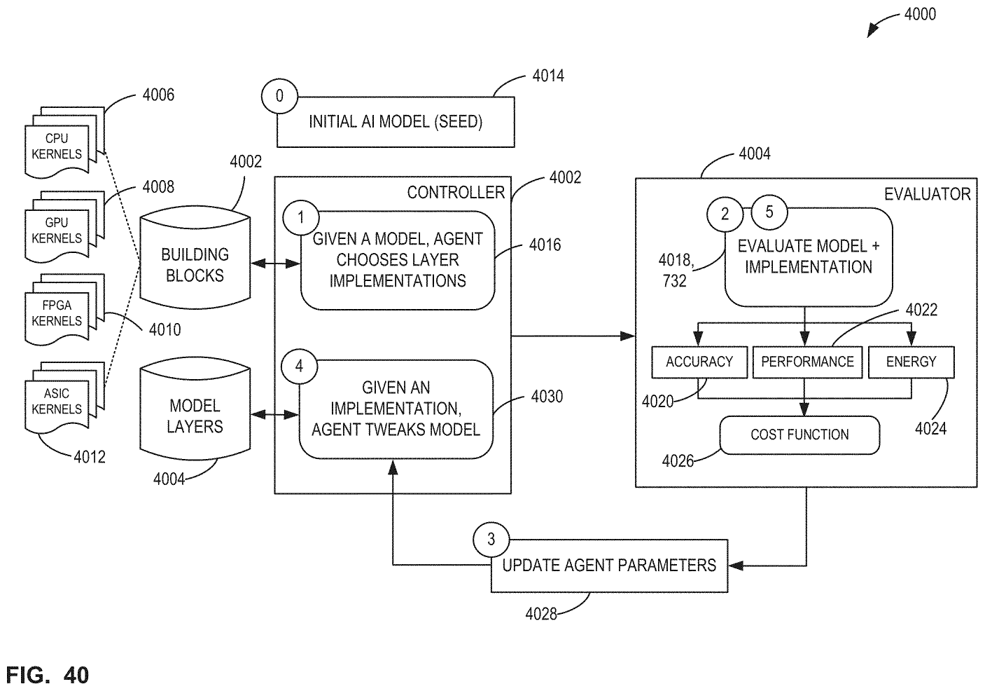

FIG. 40 is an illustration of an example workflow 4000 to identify a composable ML compute node, such as the ML compute node 3517 of FIG. 35. The workflow 4000 includes the controller 3502 and the evaluator 3504 of FIG. 35. The workflow 4000 includes example building blocks 4002 and example model layers 4004. In some examples, the building blocks 4002 can be implemented by the software templates 3512, the hardware templates 3514, and/or, more generally, the composable building block databases 3510 of FIG. 35. In the illustrated example, the building blocks 4002 include example CPU kernels 4006, example GPU kernels 4008, example FPGA kernels 4010, and example ASIC kernels 4012. In some examples, one(s) of the kernels 4006, 4008, 4010, 4012 can be implemented by one(s) of the hardware templates 3514 of FIG. 35. For example, the CPU kernels 4006 can be implemented by HW TEMPLATE N of FIG. 35, the GPU kernels 4008 can be implemented by HW TEMPLATE 35 of FIG. 35, the FPGA kernels 4010 can be implemented by HW TEMPLATE 34 of FIG. 34, etc.

In some examples, the model layers 4004 can be implemented by the proposed HW/SW instance 3522 of FIG. 35 and/or the software 3519 of FIG. 35. For example, the model layers 4004 can be implemented by a database including historical implementations of ML compute nodes, the instant or current implementation of an ML compute node under evaluation, etc.

During the workflow 4000, at an initial example operation 4014, the controller 3502 receives an initial AI model, which may be referred to as a seed AI model. For example, the initial AI model can be a specific neural network that is known to be efficient for a workload of interest, such as image processing. Additionally and/or alternatively, the initial operation 4014 may include a function input, a request, etc., indicative of a desired AI/ML operation (e.g., a desire to do image processing without specifying the initial AI model). In some such examples, the controller 3502 can identify the initial AI model based on the function input, the request, etc.

At a first example operation 4016, the controller 3502 can choose layer implementations given the initial AI model. For example, the controller 3502 can map the initial AI model to one(s) of the kernels 4006, 4008, 4010, 4012 of the building blocks 4002. In some such examples, the controller 3502 can identify the GPU kernels 4008 based on a determination that the GPU kernels 4008 are efficient to execute the initial AI model. For example, the controller 3502 can identify implementation(s) of layer(s) of the initial AI model in which the implementation(s) can correspond to hardware, such as one or more of the GPU kernels 4008.

During a second example operation 4018, the controller 3502 can provide the initial AI model and the layer implementations to the evaluator 3504. For example, the evaluator 3504 can evaluate the model and the layer implementations based on emulation(s), simulation(s), etc., of the model and the layer implementations when the model and the layer implementations are to execute a desired or intended workload. The evaluator 3504 can evaluate the model and the layer implementations to generate an example accuracy parameter 4020, an example performance parameter 4022, an example energy parameter 4024, and/or any other type of parameter such as latency, cost (e.g., computational cost, monetary cost, production or manufacturing cost, cost to purchase energy to power hardware running the model, etc.), etc. For example, the accuracy parameter 4020 can be an accuracy of the model and the layer implementations. In some examples, the performance parameter 4022 can be an efficiency, throughput, etc., of the model and the layer implementations. In some examples, the energy parameter 4024 can be a power consumption by the layer implementations when executing the model. In some examples, the energy parameter 724 can be a thermal dissipation of hardware configured using the layer implementations when executing the model. In the illustrated example, the parameters 4020, 4022, 4024 are provided as inputs to an example cost function 4026. In some examples, the cost function 4026 can be implemented by the reward function 3528 of FIG. 35. For example, the cost function 4026 can determine a difference between values of the parameters 4020, 4022, 4024 and expected or predicted values of the parameters 4020, 4022, 4024.

During a third example operation 4028, the outputs of the cost function 4026 can cause an update of agent parameters (e.g., agent parameters in a reinforcement learning AI/ML model) handled and/or otherwise maintained by the controller 3502. For example, the controller 3502 can determine whether to modify a model to prioritize one parameter (such as thermal dissipation, accuracy) over another parameter (such as energy consumption, etc.).

During a fourth example operation 4030, the controller 3502 can tweak the model and/or the layer implementations based on the outputs from the cost function 4026. For example, the controller 3502 can replace the initial AI model with a different type of AI/ML model, change a configuration of the initial AI model, etc. In some examples, the controller 3502 can replace the GPU kernels 4008 with different kernels (such as the FPGA kernels 4010, etc.), change a configuration (e.g., a register file, a topology, etc.) of the GPU kernels 4008, etc.

During a fifth example operation 4032, the controller 3502 provides another iteration of the model and the layer implementations to the evaluator 3504 for evaluation. Advantageously, the workflow 4000 of FIG. 40 can be executed (e.g., iteratively executed) to identify a model and corresponding layer implementations to execute a workload with improved accuracy, performance, energy consumption, thermal dissipation, cost, etc.

Flowcharts representative of example hardware logic circuitry, machine readable instructions, hardware implemented state machines, and/or any combination thereof for implementing the ML system configurator 3402 of FIGS. 34 and/or 35 and/or the ML system configuration circuitry 3600 of FIG. 36 are shown in FIGS. 41-13. The machine readable instructions may be one or more executable programs or portion(s) of an executable program for execution by processor circuitry, such as the processor circuitry 4712 shown in the example processor platform 4700 discussed below in connection with FIG. 47 and/or the example processor circuitry discussed below in connection with FIGS. 345 and/or 346. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 41-13, many other methods of implementing the example ML system configurator 3402 of FIGS. 34 and/or 35 and/or the example ML system configuration circuitry 3600 of FIG. 36 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 41-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 41 is a flowchart representative of example machine readable instructions and/or example operations 4100 that may be executed and/or instantiated by processor circuitry to execute a workload with a composable ML compute node. The example machine readable instructions and/or the example operations 4100 of FIG. 41 begin at block 4102, at which the ML system configuration circuitry 3600 receives a request to execute a machine-learning (ML) workload. For example, the interface circuitry 3610 (FIG. 36) can receive a request to identify a combination of hardware and/or software to execute the workload(s) 3516 of FIG. 35. In some such examples, the combination of the hardware and/or the software can be implemented by the software 3519, the hardware 3521, and/or, more generally, the ML compute node 3517 of FIG. 35.

At block 4104, the ML system configuration circuitry 3600 generates a first configuration of one or more ML models based on the ML workload. For example, the ML software configuration circuitry 3620 (FIG. 36) can identify an AI/ML model such as a CNN from the software search space 3518. In some such examples, the ML software configuration circuitry 3620 can identify a configuration of the CNN based on one of the software templates 3512 of FIG. 35, the software templates 3672 of FIG. 36, etc., that corresponds to the CNN. An example process that may be executed to implement block 4104 is described below in connection with FIG. 42.

At block 4106, the ML system configuration circuitry 3600 generates a second configuration of hardware based on the ML workload. For example, the ML hardware configuration circuitry 3630 (FIG. 36) can identify hardware such as a GPU from the hardware search space 3520. In some such examples, the ML hardware configuration circuitry 3630 can identify a configuration of the GPU based on one of the hardware templates 3514 of FIG. 35, the hardware templates 3674 of FIG. 36, etc., that corresponds to the GPU. An example process that may be executed to implement block 4104 is described below in connection with FIG. 43.

At block 4108, the ML system configuration circuitry 3600 generates an evaluation parameter based on an execution of the workload based on the first configuration and the second configuration. For example, the configuration evaluation circuitry 3640 (FIG. 36) can execute performance modeling (e.g., emulation(s), simulation(s), debugging, etc.) associated with the GPU executing the CNN. In some such examples, the configuration evaluation circuitry 3640 can generate the evaluation parameters 3526, which can correspond to a simulation, an emulation, etc., of the GPU executing an AI/ML workload with the CNN.

At block 4110, the ML system configuration circuitry 3600 determines whether the evaluation parameter satisfies a threshold. For example, the configuration evaluation circuitry 3640 can determine whether an evaluation parameter, such as an accuracy parameter, has a value that satisfies an evaluation parameter threshold, such as an accuracy threshold (e.g., an accuracy parameter threshold). In some such examples, the configuration evaluation circuitry 3640 can determine that the accuracy parameter has a value of 425%, which satisfies the accuracy threshold of 420% because the value of 425% is greater than 420%.

If, at block 4110, the ML system configuration circuitry 3600 determines that the evaluation parameter does not satisfy a threshold, then, at block 4112, the ML system configuration circuitry 3600 updates an ontology database based on the evaluation parameter. For example, the ontology generation circuitry 3650 (FIG. 36) can update the ontology database 3508 of FIG. 35 based on the evaluation parameters 3526, the proposed HW/SW instance 3522 that are associated with the evaluation parameters 3526, etc., and/or any combination(s) thereof.

At block 4114, the ML system configuration circuitry 3600 adjusts the first configuration based on the evaluation parameter. For example, the ML software configuration circuitry 3620 can replace the CNN with a different AI/ML model, add another AI/ML model, change a configuration of the CNN, etc., and/or any combination(s) thereof. An example process that may be executed to implement block 4114 is described below in connection with FIG. 44.

At block 4116, the ML system configuration circuitry 3600 adjusts the second configuration based on the evaluation parameter. For example, the ML hardware configuration circuitry 3630 can replace the GPU with different hardware, add additional hardware, change a configuration of the GPU, etc., and/or any combination(s) thereof. An example process that may be executed to implement block 4116 is described below in connection with FIG. 45. In response to adjusting the second configuration based on the evaluation parameter at block 4116, control returns to block 4108 to generate an evaluation parameter based on an execution of the workload based on the first configuration (e.g., an updated or adjusted version of the first configuration) and the second configuration (e.g., an updated or adjusted version of the second configuration).

If, at block 4110, the ML system configuration circuitry 3600 determines that the evaluation parameter satisfies a threshold, control proceeds to block 4118 to execute the one or more ML models based on the ML models based on the first configuration on the hardware in the second configuration. For example, the workload execution circuitry 3660 (FIG. 36) can compile, compose, generate, identify, and/or otherwise instantiate the ML compute node 3517 of FIG. 35. In some such examples, the software 3519 of the ML compute node 3517 can be implemented by one or more AI/ML models based on the first configuration. In some examples, the hardware 3521 of the ML compute node 3517 can be implemented by one or more types and/or instances of hardware based on the second configuration. In some examples, the ML compute node 3517 can be deployed and/or otherwise made available to execute the workload(s) 3516. In response to executing the one or more ML models based on the first configuration on the hardware in the second configuration at block 4118, the example machine readable instructions and/or the example operations 4100 of FIG. 41 conclude.

FIG. 42 is a flowchart representative of example machine readable instructions and/or example operations 4200 that may be executed and/or instantiated by processor circuitry to generate a first configuration of one or more machine-learning models based on a machine-learning workload. The example machine readable instructions and/or the example operations 4200 of FIG. 42 can be executed and/or instantiated by processor circuitry to implement block 4104 of the example machine readable instructions and/or the example operations 4100 of FIG. 41. The example machine readable instructions and/or the example operations 4200 of FIG. 42 begin at block 4202, at which the ML system configuration circuitry 3600 of FIG. 36 queries a configuration database with the ML workload using an application programming interface. For example, the ML software configuration circuitry 3620 (FIG. 36) can query one(s) of the composable building block databases 3510 of FIG. 35, the software templates 3672 of FIG. 36, and/or the interconnect topologies 3676 of FIG. 36 via one or more APIs.

At block 4204, the ML system configuration circuitry 3600 identifies an ML model based on historical configurations. For example, the ontology generation circuitry 3660 (FIG. 36) can identify an ML model, such as an NN, that was utilized in previous AutoML searches. In some such examples, the ontology generation circuitry 3660 can identify the ML model based on historical configurations that may be stored in the ontology database 3508 of FIG. 35 and/or the historical configurations 3678 of FIG. 36.

At block 4206, the ML system configuration circuitry 3600 determines a number of layers for the ML model. For example, the ML software configuration circuitry 3620 can determine that the NN is to have a plurality of layers (e.g., network layers, NN layers, etc.) in which one(s) of the plurality of layers is/are coupled to different one(s) of the plurality of layers in a NN configuration. In some such examples, the ML software configuration circuitry 3620 can determine the plurality of layers and/or configuration(s) thereof based on information (e.g., metadata or other data) included in the software templates 3512 of FIG. 35, the software templates 3672 of FIG. 36, etc.

At block 4208, the ML system configuration circuitry 3600 determines weights for the layers of the ML model. For example, the ML software configuration circuitry 3620 can determine that one(s) of the plurality of layers is/are to have specific weights (e.g., weight values). In some such examples, the ML software configuration circuitry 3620 can determine the weights based on information (e.g., metadata or other data) included in the software templates 3512, the software templates 3672 of FIG. 36, etc.

At block 4210, the ML system configuration circuitry 3600 determines a type of ML training for the ML model. For example, the ML software configuration circuitry 3620 can determine that the NN model is to be trained with reinforcement learning. In some such examples, the ML software configuration circuitry 3620 can determine the type of ML training to use to train the NN model based on information (e.g., metadata or other data) included in the software templates 3512, the software templates 3672 of FIG. 36, etc.

At block 4212, the ML system configuration circuitry 3600 determines hyperparameters to train the ML model. For example, the ML software configuration circuitry 3620 can determine values of one or more hyperparameters that may be utilized to train the NN model. In some such examples, the ML software configuration circuitry 3620 can determine the values of the hyperparameters based on information (e.g., metadata or other data) included in the software templates 3512, the software templates 3672 of FIG. 36, etc.

At block 4214, the ML system configuration circuitry 3600 determines whether another ML model is identified. For example, the ML software configuration circuitry 3620 can determine that another type of AI/ML model, such as a Transformer, is identified to be used in conjunction with the NN. In some such examples, the ML software configuration circuitry 3620 can identify a number of AI/ML models and/or types thereof by searching the software search space 3518. In some examples, the ML software configuration circuitry 3620 can determine that the first NN model identified is a CNN and that another type of NN model such as an ANN, DNN, etc., that can be utilized in conjunction with the CNN.

If, at block 4214, the ML system configuration circuitry 3600 determines that another ML model is identified, control returns to block 4206 to determine a number of layers for the additionally identified ML model. If, at block 4214, the ML system configuration circuitry 3600 determines that another ML model is not identified, then, at block 4216, the ML system configuration circuitry 3600 determines whether more than one ML model has been identified. For example, the ML software configuration circuitry 3620 can determine that only one ML model has been identified (e.g., a CNN) while in other examples, the ML software configuration circuitry 3620 can determine that more than one ML model has been identified (e.g., a CNN and a Transformer model).

If, at block 4216, the ML system configuration circuitry 3600 determines that only one ML model has been identified, then the example machine readable instructions and/or the example operations 4200 of FIG. 42 conclude. For example, the machine readable instructions and/or the example operations 4200 of FIG. 42 can return to block 4106 of the machine readable instructions and/or the example operations 4100 of FIG. 41 to generate a second configuration of hardware based on the ML workload.

If, at block 4216, the ML system configuration circuitry 3600 determines that more than one ML model has been identified, then, at block 4218, the ML system configuration circuitry 3600 generates a topology based on connection(s) between one(s) of the ML models. For example, the ML software configuration circuitry 3620 can analyze the different topologies in the interconnect topologies 3676 to identify connection(s) between a first identified AI/ML model (e.g., a CNN) and a second identified AI/ML model (e.g., a Transformer model). In some such examples, the ML software configuration circuitry 3620 can couple output(s) of the first identified AI/ML model to input(s) of the second identified AI/ML model based on a topology in the interconnect topologies 3676.

In response to generating a topology based on connection(s) between one(s) of the ML models at block 4218, the example machine readable instructions and/or the example operations 4200 of FIG. 42 conclude. For example, the machine readable instructions and/or the example operations 4200 of FIG. 42 can return to block 4106 of the machine readable instructions and/or the example operations 4100 of FIG. 41 to generate a second configuration of hardware based on the ML workload.

FIG. 43 is a flowchart representative of example machine readable instructions and/or example operations 4300 that may be executed and/or instantiated by processor circuitry to generate a second configuration of hardware based on a machine-learning workload. The example machine readable instructions and/or the example operations 4300 of FIG. 43 can be executed and/or instantiated by processor circuitry to implement block 4106 of the example machine readable instructions and/or the example operations 4100 of FIG. 41. The example machine readable instructions and/or the example operations 4300 of FIG. 43 begin at block 4302, at which the ML system configuration circuitry 3600 of FIG. 36 queries a configuration database with the ML workload using an application programming interface. For example, the ML hardware configuration circuitry 3630 (FIG. 36) can query one(s) of the composable building block databases 3510 of FIG. 35, the hardware templates 3674 of FIG. 36, and/or the interconnect topologies 3676 of FIG. 36 via one or more APIs.

At block 4304, the ML system configuration circuitry 3600 identifies a type of hardware based on historical configurations. For example, the ontology generation circuitry 3660 (FIG. 36) can identify a type of hardware, such as a GPU, that was utilized in previous AutoML searches. In some such examples, the ontology generation circuitry 3660 can identify the GPU based on historical configurations that may be stored in the ontology database 3508 of FIG. 35 and/or the historical configurations 3678 of FIG. 36.

At block 4306, the ML system configuration circuitry 3600 determines a first block of the hardware to execute a matrix-matrix workload. For example, the ML hardware configuration circuitry 3630 can identify a first kernel of the GPU to execute matrix-matrix computational operation(s). In some such examples, the ML hardware configuration circuitry 3630 can identify the first kernel and/or configuration(s) thereof based on information (e.g., metadata or other data) included in the hardware templates 3514 of FIG. 35, the hardware templates 3674 of FIG. 36, etc.

At block 4308, the ML system configuration circuitry 3600 determines a second block of the hardware to execute a vector-vector workload. For example, the ML hardware configuration circuitry 3630 can identify a second kernel (e.g., the second block 404 of FIG. 4) of the GPU to execute vector-vector computational operation(s). In some such examples, the ML hardware configuration circuitry 3630 can identify the second kernel and/or configuration(s) thereof based on information (e.g., metadata or other data) included in the hardware templates 3514 of FIG. 35, the hardware templates 3674 of FIG. 36, etc.

At block 4310, the ML system configuration circuitry 3600 determines a third block of the hardware to execute a matrix-vector workload. For example, the ML hardware configuration circuitry 3630 can identify a third kernel (e.g., the first block 402 of FIG. 4) of the GPU to execute matrix-vector computational operation(s). In some such examples, the ML hardware configuration circuitry 3630 can identify the third kernel and/or configuration(s) thereof based on information (e.g., metadata or other data) included in the hardware templates 3514 of FIG. 35, the hardware templates 3674 of FIG. 36, etc.

At block 4312, the ML system configuration circuitry 3600 identifies register file(s) to store states of respective ones of the first block, the second block, and/or the third block. For example, the ML hardware configuration circuitry 3630 can generate and/or otherwise identify a first register file (e.g., one of the register files 406 of FIG. 4) in which state(s) of hardware thread(s) corresponding to the first kernel can be stored. In some such examples, the ML hardware configuration circuitry 3630 can generate, identify, and/or otherwise instantiate a second register file corresponding to the second kernel and/or a third register file corresponding to the third kernel.

At block 4314, the ML system configuration circuitry 3600 determines whether another type of hardware is identified. For example, the ML hardware configuration circuitry 3630 can determine that another type of hardware, such as a CPU, an AI processor, an FPGA, etc., is identified to be used in conjunction with the GPU. In some such examples, the ML hardware configuration circuitry 3630 can identify a number of instances of hardware (or portion(s) thereof) and/or types thereof by searching the hardware search space 3520. In some examples, the ML hardware configuration circuitry 3630 can determine that another instance of the GPU (or portion(s) thereof) can be utilized in conjunction with the GPU.

If, at block 4314, the ML system configuration circuitry 3600 determines that another type of hardware is identified, control returns to block 4306 to identify a first block of the identified hardware. If, at block 4314, the ML system configuration circuitry 3600 determines that another type of hardware is not identified, then, at block 4316, the ML system configuration circuitry 3600 determines whether more than one type and/or instance of hardware been identified. For example, the ML hardware configuration circuitry 3630 can determine that only one type and/or instance of hardware has been identified (e.g., a single GPU kernel, a single GPU, etc.). In some such examples, the ML hardware configuration circuitry 3630 can determine that a homogeneous ML compute node has been identified. In some examples, the ML hardware configuration circuitry 3630 can determine that more than one instance and/or type of hardware (e.g., more than one GPU, more than one GPU kernel, a GPU and an FPGA, at least one GPU kernel and at least one FPGA kernel, etc.) has been identified. In some such examples, the ML hardware configuration circuitry 3630 can determine that a heterogeneous ML compute node has been identified.

If, at block 4316, the ML system configuration circuitry 3600 determines that only one type and/or instance of hardware has been identified, then the example machine readable instructions and/or the example operations 4300 of FIG. 43 conclude. For example, the machine readable instructions and/or the example operations 4300 of FIG. 43 can return to block 4108 of the machine readable instructions and/or the example operations 4100 of FIG. 41 to generate an evaluation parameter based on an execution of the workload based on the first configuration and the second configuration.

If, at block 4316, the ML system configuration circuitry 3600 determines that more than one type and/or instance of hardware has been identified, then, at block 4318, the ML system configuration circuitry 3600 generates a topology based on connection(s) of the hardware. For example, the ML hardware configuration circuitry 3630 can analyze the different topologies in the interconnect topologies 3676 to identify connection(s) between a first hardware kernel (e.g., a first GPU kernel) and a second hardware kernel (e.g., a second GPU kernel). In some examples, the ML hardware configuration circuitry 3630 can analyze the different topologies in the interconnect topologies 3676 to identify connection(s) between a first type of hardware (e.g., a GPU) and a second type of hardware (e.g., an AI processor). In some examples, the ML hardware configuration circuitry 3630 can couple output(s) of the first hardware kernel and the second hardware kernel based on a topology included in the interconnect topologies 3676. In some examples, the ML hardware configuration circuitry 3630 can couple output(s) of the first type of hardware and the second type of hardware based on a topology included in the interconnect topologies 3676.

In response to generating a topology based on connection(s) of the hardware at block 4318, the example machine readable instructions and/or the example operations 4300 of FIG. 43 conclude. For example, the machine readable instructions and/or the example operations 4300 of FIG. 43 can return to block 4108 of the machine readable instructions and/or the example operations 4100 of FIG. 41 to generate an evaluation parameter based on an execution of the workload based on the first configuration and the second configuration.

FIG. 44 is a flowchart representative of example machine readable instructions and/or example operations 4400 that may be executed and/or instantiated by processor circuitry to adjust the first configuration based on the evaluation parameter. The example machine readable instructions and/or the example operations 4400 of FIG. 44 may be executed and/or instantiated by processor circuitry to implement block 4114 of the example machine readable instructions and/or the example operations 4100 of FIG. 41. The example machine readable instructions and/or the example operations 4400 of FIG. 44 begin at block 4402, at which the ML system configuration circuitry 3600 determines whether to replace a first ML model with a different ML model. For example, the ML software configuration circuitry 3620 (FIG. 36) can determine that the proposed HW/SW instance 3522 of FIG. 35 includes a first AI/ML model, such as a CNN. In some such examples, the ML software configuration circuitry 3620 can determine the CNN model is to be replaced with a DNN model.

If, at block 4402, the ML system configuration circuitry 3600 determines not to replace the first ML model with a different ML model, control proceeds to block 4408. If, at block 4402, the ML system configuration circuitry 3600 determines to replace the first ML model with a different ML model, then, at block 4404, the ML system configuration circuitry 3600 identifies a second ML model in a configuration database. For example, the ML software configuration circuitry 3620 can identify a DNN in the software templates 3512 of the composable building blocks database 3510.

At block 4406, the ML system configuration circuitry 3600 generates a new configuration based on the replacement of the first ML model with the second ML model. For example, the ML software configuration circuitry 3620 can generate a new or updated configuration of software in the proposed HW/SW instance 3522 by replacing the CNN with the DNN.

At block 4408, the ML system configuration circuitry 3600 determines whether to add a second ML model to a configuration. For example, the ML software configuration circuitry 3620 can determine to add the DNN to the configuration of the software in conjunction with the CNN and/or a different AI/ML model.

If, at block 4408, the ML system configuration circuitry 3600 determines not to add a second ML model to a configuration, the example machine readable instructions and/or the example operations 4400 of FIG. 44 conclude. For example, the machine readable instructions and/or the example operations 4400 of FIG. 44 can return to block 4116 of the machine readable instructions and/or the example operations 4100 of FIG. 41 to adjust the second configuration based on the evaluation parameter.

If, at block 4408, the ML system configuration circuitry 3600 determines to add a second ML model to a configuration, then, at block 4410, the ML system configuration circuitry 3600 determines one or more first layers of the first ML model to execute a first portion of a workload. For example, in a configuration that includes a CNN and a DNN, the ML software configuration circuitry 3620 can identify and/or otherwise determine one or more first layers of the CNN to execute a first portion of the workload(s) 3516.

At block 4412, the ML system configuration circuitry 3600 identifies a second ML model in a configuration database. For example, the ML software configuration circuitry 3620 can identify the DNN in the software templates 3512 of the composable building block databases 3510.

At block 4414, the ML system configuration circuitry 3600 determines one or more second layers of the second ML model to execute a second portion of the workload. For example, in a configuration that includes a CNN and a DNN, the ML software configuration circuitry 3620 can identify and/or otherwise determine one or more second layers of the DNN to execute a second portion of the workload(s) 3516.

At block 4416, the ML system configuration circuitry 3600 determines a new configuration based on a topology of the one or more first layers and the one or more second layers. For example, the ML software configuration circuitry 3620 can determine to couple output(s) of the CNN to input(s) of the DNN (or vice versa) based on a topology included in the interconnect topologies 3676.

In response to determining a new configuration based on a topology of the one or more first layers and the one or more second layers at block 4416, the example machine readable instructions and/or the example operations 4400 of FIG. 44 conclude. For example, the machine readable instructions and/or the example operations 4400 of FIG. 44 can return to block 4116 of the machine readable instructions and/or the example operations 4100 of FIG. 41 to adjust the second configuration based on the evaluation parameter.

FIG. 45 is a flowchart representative of example machine readable instructions and/or example operations 4500 that may be executed and/or instantiated by processor circuitry to adjust the second configuration based on the evaluation parameter. The example machine readable instructions and/or the example operations 4500 of FIG. 45 may be executed and/or instantiated by processor circuitry to implement block 4116 of the example machine readable instructions and/or the example operations 4100 of FIG. 41. The example machine readable instructions and/or the example operations 4500 of FIG. 45 begin at block 4502, at which the ML system configuration circuitry 3600 determines whether to replace first hardware with different hardware. For example, the ML hardware configuration circuitry 3630 (FIG. 36) can determine that the proposed HW/SW instance 3522 of FIG. 35 includes first hardware, such as a GPU. In some such examples, the ML hardware configuration circuitry 3630 can determine the GPU is to be replaced with an FPGA.

If, at block 4502, the ML system configuration circuitry 3600 determines not to replace the first hardware with different hardware, control proceeds to block 4508. If, at block 4502, the ML system configuration circuitry 3600 determines to replace the first hardware with different hardware, then, at block 4504, the ML system configuration circuitry 3600 identifies second hardware in a configuration database. For example, the ML hardware configuration circuitry 3630 can identify an FPGA in the hardware templates 3514 of the composable building blocks database 3510.

At block 4506, the ML system configuration circuitry 3600 generates a new configuration based on the replacement of the first hardware with the second hardware. For example, the ML hardware configuration circuitry 3630 can generate a new or updated configuration of hardware in the proposed HW/SW instance 3522 by replacing the GPU with the FPGA.

At block 4508, the ML system configuration circuitry 3600 determines whether to add second hardware to a configuration. For example, the ML hardware configuration circuitry 3630 can determine to add the FPGA to the configuration of the hardware in conjunction with the GPU and/or different hardware (such as an AI processor).

If, at block 4508, the ML system configuration circuitry 3600 determines not to add second hardware to a configuration, the example machine readable instructions and/or the example operations 4500 of FIG. 45 conclude. For example, the machine readable instructions and/or the example operations 4500 of FIG. 45 can return to block 4118 of the machine readable instructions and/or the example operations 4100 of FIG. 41 to execute the one or more ML models based on the first configuration on the hardware in the second configuration.

If, at block 4508, the ML system configuration circuitry 3600 determines to add second hardware to a configuration, then, at block 4510, the ML system configuration circuitry 3600 determines one or more first portions of the first hardware to execute a first portion of a workload. For example, in a configuration that includes a GPU and an FPGA, the ML hardware configuration circuitry 3630 can identify and/or otherwise determine one or more first kernels of the GPU to execute a first portion of the workload(s) 3516.

At block 4512, the ML system configuration circuitry 3600 identifies second hardware in a configuration database. For example, the ML hardware configuration circuitry 3630 can identify the FPGA in the hardware templates 3514 of the composable building block databases 3510.

At block 4514, the ML system configuration circuitry 3600 determines one or more second portions of the second hardware to execute a second portion of the workload. For example, in a configuration that includes a GPU and an FPGA, the ML hardware configuration circuitry 3630 can identify and/or otherwise determine one or more second kernels of the FPGA to execute a second portion of the workload(s) 3516.

At block 4516, the ML system configuration circuitry 3600 determines a new configuration based on a topology of the one or more first portions and the one or more second portions. For example, the ML hardware configuration circuitry 3630 can determine to couple output(s) of the GPU to input(s) of the FPGA (or output(s) of the FPGA to input(s) of the GPU) based on a topology included in the interconnect topologies 3676.

In response to determining a new configuration based on a topology of the one or more first portions and the one or more second portions at block 4516, the example machine readable instructions and/or the example operations 4500 of FIG. 45 conclude. For example, the machine readable instructions and/or the example operations 4500 of FIG. 45 can return to block 4118 of the machine readable instructions and/or the example operations 4100 of FIG. 41 to execute the one or more ML models based on the first configuration on the hardware in the second configuration.

FIG. 46 is a flowchart representative of example machine readable instructions and/or example operations 4600 that may be executed and/or instantiated by processor circuitry to deploy a compute node to execute a machine-learning workload. The example machine readable instructions and/or the example operations 4600 of FIG. 46 begin at block 4602, at which the ML system configuration circuitry 3600 receives a request for a machine-learning (ML) model and corresponding hardware to execute an ML workload. For example, the interface circuitry 3610 (FIG. 36) can receive a request to identify a combination of hardware and/or software to execute the workload(s) 3516 of FIG. 35. In some such examples, the combination of the hardware and/or the software can be implemented by the software 3519, the hardware 3521, and/or, more generally, the ML compute node 3517 of FIG. 35.

At block 4604, the ML system configuration circuitry 3600 generates a software search space and a hardware search space based on at least one of the request or historical configurations. For example, the ML software configuration circuitry 3620 can generate the software search space 3518 of FIG. 35 based on the workload(s) 3516, historical configurations of ML compute nodes that may be stored in the ontology database 3508 of FIG. 35, the historical configurations 3678 of FIG. 36, etc., and/or any combination(s) thereof. In some examples, the ML hardware configuration circuitry 3630 can generate the hardware search space 3520 of FIG. 35 based on the workload(s) 3516, historical configurations of ML compute nodes that may be stored in the ontology database 3508 of FIG. 35, the historical configurations 3678 of FIG. 36, etc., and/or any combination(s) thereof.

At block 4606, the ML system configuration circuitry 3600 selects a configuration of ML model(s) and corresponding hardware for a compute node based on at least one of the software search space or the hardware search space. For example, the ML software configuration circuitry 3620 and/or the ML hardware configuration circuitry 3630 can generate the proposed HW/SW instance 3522 of FIG. 35 based on one or more AI/ML models from the software search space 3518 and hardware from the hardware search space 3520.

At block 4608, the ML system configuration circuitry 3600 selects a topology for a configuration of the ML model(s) and the corresponding hardware for the compute node. For example, the ML software configuration circuitry 3620 can couple together one or more ML models of the proposed HW/SW instance 3522. In some examples, the ML hardware configuration circuitry 3630 can couple together hardware of the proposed HW/SW instance 3522.

At block 4610, the ML system configuration circuitry 3600 outputs evaluation parameters associated with the configuration. For example, the configuration evaluation circuitry 3640 (FIG. 36) can determine the evaluation parameters 3526 based on the performance modeling 3524 of the proposed HW/SW instance 3522.

At block 4612, the ML system configuration circuitry 3600 determines whether one(s) of the evaluation parameters satisfy respective thresholds. For example, the configuration evaluation circuitry 3640 can determine whether a first value of an accuracy parameter satisfies an accuracy threshold, a second value of a latency parameter satisfies a latency parameter, etc., and/or any combination(s) thereof.

If, at block 4612, the ML system configuration circuitry 3600 determines that one(s) of the evaluation parameters do not satisfy respective threshold(s), control returns to block 4606, otherwise, at block 4614, the ML system configuration circuitry 3600 deploys the compute node to execute the ML workload. For example, the workload execution circuitry 3660 (FIG. 36) can deploy the ML compute node 3517 to execute the workload(s) 3516. In some such examples, the workload execution circuitry 3660 can compile and/or otherwise provide the ML compute node 3517 as an executable construct that, when executed and/or instantiated, can execute the workload(s) 3516. In response to deploying the compute node to execute the ML workload at block 4614, the example machine readable instructions and/or the example operations 4600 of FIG. 46 conclude.

FIG. 47 is a block diagram of an example processor platform 4700 structured to execute and/or instantiate the machine readable instructions and/or the operations of FIGS. 41-13 to implement the ML system configurator 3402 of FIGS. 34 and/or 35 and/or the ML system configuration circuitry 3600 of FIG. 36. The processor platform 4700 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, or any other type of computing device.

The processor platform 4700 of the illustrated example includes processor circuitry 4712. The processor circuitry 4712 of the illustrated example is hardware. For example, the processor circuitry 4712 can be implemented by one or more integrated circuits, logic circuits, FPGAs, microprocessors, CPUs, GPUs, DSPs, and/or microcontrollers from any desired family or manufacturer. The processor circuitry 4712 may be implemented by one or more semiconductor based (e.g., silicon based) devices. In this example, the processor circuitry 4712 implements the ML software configuration circuitry 3620 (identified by ML SW CONFIG CIRCUITRY), the ML hardware configuration circuitry 3630 (identified by ML HW CONFIG CIRCUITRY), the configuration evaluation circuitry 3640 (identified by CONFIG EVAL CIRCUITRY), the ontology generation circuitry 3650 (identified by ONTOL GEN CIRCUITRY), and the workload execution circuitry 3660 (identified by WORKLOAD EXEC CIRCUITRY) of FIG. 36.

The processor circuitry 4712 of the illustrated example includes a local memory 4713 (e.g., a cache, registers, etc.). The processor circuitry 4712 of the illustrated example is in communication with a main memory including a volatile memory 4714 and a non-volatile memory 4716 by a bus 4718. In some examples, the bus 4718 implements the bus 3680 of FIG. 36. The volatile memory 4714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 4716 may be implemented by flash memory and/or any other desired type of memory device. Access to the main memory 4714, 4716 of the illustrated example is controlled by a memory controller 4717.

The processor platform 4700 of the illustrated example also includes interface circuitry 4720. In this example, the interface circuitry 4720 implements the interface circuitry 3610 of FIG. 36. The interface circuitry 4720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 4722 are connected to the interface circuitry 4720. The input device(s) 4722 permit(s) a user to enter data and/or commands into the processor circuitry 4712. The input device(s) 4722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 4724 are also connected to the interface circuitry 4720 of the illustrated example. The output device(s) 4724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 4720 of the illustrated example, thus, typically includes a graphics driver card, a graphics driver chip, and/or graphics processor circuitry such as a GPU.

The interface circuitry 4720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 4726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 4700 of the illustrated example also includes one or more mass storage devices 4728 to store software and/or data. In this example, the one or more mass storage devices 4728 implement the datastore 3670, the software templates 3672 (identified by SW TEMP), the hardware templates 3674 (identified by HW TEMP), the interconnect topologies 3676 (identified by INTER TOPOLOGIES), and the historical configurations 3678 (identified by HIST CONFIGS). Examples of such mass storage devices 4728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 4732, which may be implemented by the machine readable instructions of FIGS. 41-13, may be stored in the mass storage device 4728, in the volatile memory 4714, in the non-volatile memory 4716, and/or on a removable non-transitory computer readable storage medium such as a CD or DVD.

The processor platform 4700 of the illustrated example of FIG. 47 includes example acceleration circuitry 4734, which includes an example GPU 4740, an example vision processing unit (VPU) 4742, and an example neural network processor 4744. Additionally and/or alternatively, the acceleration circuitry 4734 may include any other type of hardware such as a CPU, an FPGA, an ASIC, etc. In this example, the GPU 4740, the VPU 4742, and the neural network processor 4744 are in communication with different hardware of the processor platform 4700, such as the volatile memory 4714, the non-volatile memory 4716, etc., via the bus 4718. In this example, the neural network processor 4744 may be implemented by one or more integrated circuits, logic circuits, microprocessors, GPUs, DSPs, or controllers from any desired family or manufacturer that can be used to execute an AI model, such as a neural network. In some examples, one or more of the ML software configuration circuitry 3620, the ML hardware configuration circuitry 3630, the configuration evaluation circuitry 3640, the ontology generation circuitry 3650, and/or the workload execution circuitry 3660 can be implemented in or with at least one of the GPU 4740, the VPU 4742, or the neural network processor 4744 instead of or in addition to the processor 4712.

From the foregoing, it will be appreciated that example systems, methods, apparatus, and articles of manufacture have been disclosed for composable machine learning compute nodes. Disclosed systems, methods, apparatus, and articles of manufacture improve the efficiency of using a computing device by identifying and/or generating an improved and/or otherwise optimal combination of hardware and/or software to effectuate an AI/ML workload. Disclosed systems, methods, apparatus, and articles of manufacture include an expressive search space representation that covers multiple templates of hardware and software architectures. The templates can be dynamically modifiable during the HW/SW co-design search. Advantageously, the expressive search space enables the HW/SW co-design systems to explore a much larger and richer space of HW/SW designs across multiple architecture styles. One(s) of the architectural styles can be flexible in their respective sets of modules and connectivity (e.g., selection and/or configuration of connections, topologies, inputs/outputs, etc.). The sets of modules and connectivity can be formable through composable building blocks. Advantageously, disclosed systems, methods, apparatus, and articles of manufacture improve the likelihood of discovering more efficient hardware architecture instances and their corresponding co-designed software compared to prior AutoML approaches because examples disclosed herein offer much larger HW/SW search space(s) and composable version(s) thereof. Disclosed systems, methods, apparatus, and articles of manufacture are accordingly directed to one or more improvement(s) in the operation of a machine such as a computer or other electronic and/or mechanical device.

FIG. 48 is a block diagram of an example implementation of the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47. In this example, the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47 is implemented by a general purpose microprocessor 4800. The general purpose microprocessor circuitry 4800 executes some or all of the machine readable instructions of the flowcharts disclosed herein to effectively instantiate logic circuits to perform the operations corresponding to those machine readable instructions. For example, the microprocessor 4800 may implement multi-core hardware circuitry such as a CPU, a DSP, a GPU, an XPU, etc. Although it may include any number of example cores 4802 (e.g., 1 core), the microprocessor 4800 of this example is a multi-core semiconductor device including N cores. The cores 4802 of the microprocessor 4800 may operate independently or may cooperate to execute machine readable instructions. For example, machine code corresponding to a firmware program, an embedded software program, or a software program may be executed by one of the cores 4802 or may be executed by multiple ones of the cores 4802 at the same or different times. In some examples, the machine code corresponding to the firmware program, the embedded software program, or the software program is split into threads and executed in parallel by two or more of the cores 4802. The software program may correspond to a portion or all of the machine readable instructions and/or operations represented by one or more of the flowcharts disclosed herein.

The cores 4802 may communicate by a first example bus 4804. In some examples, the first bus 4804 may implement a communication bus to effectuate communication associated with one(s) of the cores 4802. For example, the first bus 4804 may implement at least one of an Inter-Integrated Circuit (I2C) bus, a Serial Peripheral Interface (SPI) bus, a PCI bus, or a PCIe bus. Additionally or alternatively, the first bus 4804 may implement any other type of computing or electrical bus. The cores 4802 may obtain data, instructions, and/or signals from one or more external devices by example interface circuitry 4806. The cores 4802 may output data, instructions, and/or signals to the one or more external devices by the interface circuitry 4806. Although the cores 4802 of this example include example local memory 4820 (e.g., Level 1 (L1) cache that may be split into an L1 data cache and an L1 instruction cache), the microprocessor 4800 also includes example shared memory 4810 that may be shared by the cores (e.g., Level 2 (L2_cache)) for high-speed access to data and/or instructions. Data and/or instructions may be transferred (e.g., shared) by writing to and/or reading from the shared memory 4810. The local memory 4820 of each of the cores 4802 and the shared memory 4810 may be part of a hierarchy of storage devices including multiple levels of cache memory and the main memory (e.g., the main memory of one or more of FIGS. 16, 21, 26, 33, and 47). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 4802 may be referred to as a CPU, DSP, GPU, etc., or any other type of hardware circuitry. Each core 4802 includes control unit circuitry 4814, arithmetic and logic (AL) circuitry (sometimes referred to as an ALU) 4816, a plurality of registers 4818, the L1 cache 4820, and a second example bus 4822. Other structures may be present. For example, each core 4802 may include vector unit circuitry, single instruction multiple data (SIMD) unit circuitry, load/store unit (LSU) circuitry, branch/jump unit circuitry, floating-point unit (FPU) circuitry, etc. The control unit circuitry 4814 includes semiconductor-based circuits structured to control (e.g., coordinate) data movement within the corresponding core 4802. The AL circuitry 4816 includes semiconductor-based circuits structured to perform one or more mathematic and/or logic operations on the data within the corresponding core 4802. The AL circuitry 4816 of some examples performs integer based operations. In other examples, the AL circuitry 4816 also performs floating point operations. In yet other examples, the AL circuitry 4816 may include first AL circuitry that performs integer based operations and second AL circuitry that performs floating point operations. In some examples, the AL circuitry 4816 may be referred to as an Arithmetic Logic Unit (ALU). The registers 4818 are semiconductor-based structures to store data and/or instructions such as results of one or more of the operations performed by the AL circuitry 4816 of the corresponding core 4802. For example, the registers 4818 may include vector register(s), SIMD register(s), general purpose register(s), flag register(s), segment register(s), machine specific register(s), instruction pointer register(s), control register(s), debug register(s), memory management register(s), machine check register(s), etc. The registers 4818 may be arranged in a bank as shown in FIG. 48. Alternatively, the registers 4818 may be organized in any other arrangement, format, or structure including distributed throughout the core 4802 to shorten access time. The second bus 4822 may implement at least one of an I2C bus, a SPI bus, a PCI bus, or a PCIe bus

Each core 4802 and/or, more generally, the microprocessor 4800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 4800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 49 is a block diagram of another example implementation of the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47. In this example, the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47 is implemented by FPGA circuitry 4900. The FPGA circuitry 4900 can be used, for example, to perform operations that could otherwise be performed by the example microprocessor 4800 of FIG. 48 executing corresponding machine readable instructions. However, once configured, the FPGA circuitry 4900 instantiates the machine readable instructions in hardware and, thus, can often execute the operations faster than they could be performed by a general purpose microprocessor executing the corresponding software.

More specifically, in contrast to the microprocessor 4800 of FIG. 48 described above (which is a general purpose device that may be programmed to execute some or all of the machine readable instructions represented by the flowcharts disclosed herein but whose interconnections and logic circuitry are fixed once fabricated), the FPGA circuitry 4900 of the example of FIG. 49 includes interconnections and logic circuitry that may be configured and/or interconnected in different ways after fabrication to instantiate, for example, some or all of the machine readable instructions represented by the flowcharts disclosed herein. In particular, the FPGA 4900 may be thought of as an array of logic gates, interconnections, and switches. The switches can be programmed to change how the logic gates are interconnected by the interconnections, effectively forming one or more dedicated logic circuits (unless and until the FPGA circuitry 4900 is reprogrammed). The configured logic circuits enable the logic gates to cooperate in different ways to perform different operations on data received by input circuitry. Those operations may correspond to some or all of the software represented by the flowcharts disclosed herein. As such, the FPGA circuitry 4900 may be structured to effectively instantiate some or all of the machine readable instructions of the flowcharts disclosed herein as dedicated logic circuits to perform the operations corresponding to those software instructions in a dedicated manner analogous to an ASIC. Therefore, the FPGA circuitry 4900 may perform the operations corresponding to the some or all of the machine readable instructions disclosed herein faster than the general purpose microprocessor can execute the same.

In the example of FIG. 49, the FPGA circuitry 4900 is structured to be programmed (and/or reprogrammed one or more times) by an end user by a hardware description language (HDL) such as Verilog. The FPGA circuitry 4900 of FIG. 49, includes example input/output (I/O) circuitry 4902 to obtain and/or output data to/from example configuration circuitry 4904 and/or external hardware (e.g., external hardware circuitry) 1606. For example, the configuration circuitry 1604 may implement interface circuitry that may obtain machine readable instructions to configure the FPGA circuitry 4900, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 48. The FPGA circuitry 4900 also includes an array of example logic gate circuitry 4908, a plurality of example configurable interconnections 4910, and example storage circuitry 4912. The logic gate circuitry 4908 and interconnections 4910 are configurable to instantiate one or more operations that may correspond to at least some of the machine readable instructions of FIGS. 8-13 and/or other desired operations. The logic gate circuitry 4908 shown in FIG. 49 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 4908 to enable configuration of the electrical structures and/or the logic gates to form circuits to perform desired operations. The logic gate circuitry 4908 may include other electrical structures such as look-up tables (LUTs), registers (e.g., flip-flops or latches), multiplexers, etc.

The interconnections 4910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 4908 to program desired logic circuits.

The storage circuitry 4912 of the illustrated example is structured to store result(s) of the one or more of the operations performed by corresponding logic gates. The storage circuitry 4912 may be implemented by registers or the like. In the illustrated example, the storage circuitry 4912 is distributed amongst the logic gate circuitry 4908 to facilitate access and increase execution speed.

The example FPGA circuitry 4900 of FIG. 49 also includes example Dedicated Operations Circuitry 4914. In this example, the Dedicated Operations Circuitry 4914 includes special purpose circuitry 4916 that may be invoked to implement commonly used functions to avoid the need to program those functions in the field. Examples of such special purpose circuitry 4916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 4900 may also include example general purpose programmable circuitry 4918 such as an example CPU 4920 and/or an example DSP 4922. Other general purpose programmable circuitry 4918 may additionally or alternatively be present such as a GPU, an XPU, etc., that can be programmed to perform other operations.

Although FIGS. 48 and 49 illustrate two example implementations of the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47, many other approaches are contemplated. For example, as mentioned above, modern FPGA circuitry may include an on-board CPU, such as one or more of the example CPU 4920 of FIG. 49. Therefore, the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47 may additionally be implemented by combining the example microprocessor 4800 of FIG. 48 and the example FPGA circuitry 4900 of FIG. 49. In some such hybrid examples, a first portion of the machine readable instructions represented by the flowcharts of FIGS. 8-13 may be executed by one or more of the cores 4802 of FIG. 48, a second portion of the machine readable instructions represented by the flowcharts of FIGS. 8-13 may be executed by the FPGA circuitry 4900 of FIG. 49, and/or a third portion of the machine readable instructions represented by the flowcharts disclosed herein may be executed by an ASIC. Some or all of the circuitry may be instantiated, for example, in one or more threads executing concurrently and/or in series.

In some examples, the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47 may be in one or more packages. For example, the processor circuitry 4800 of FIG. 48 and/or the FPGA circuitry 1600 of FIG. 49 may be in one or more packages. In some examples, an XPU may be implemented by the processor circuitry 1612 of FIG. 16, the processor circuitry 2112 of FIG. 21, the processor circuitry 2612 of FIG. 26, the processor circuitry 312 of FIG. 33, and/or the processor circuitry 4712 of FIG. 47, which may be in one or more packages. For example, the XPU may include a CPU in one package, a DSP in another package, a GPU in yet another package, and an FPGA in still yet another package.

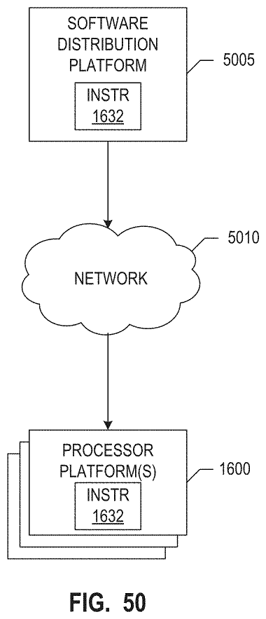

A block diagram illustrating an example software distribution platform 5005 to distribute software such as the example machine readable instructions 1632 or machine readable instructions of one or more of FIG. 16, FIG. 21, FIG. 26, FIG. 33, and/or FIG. 47 to hardware devices owned and/or operated by third parties is illustrated in FIG. 50. The example software distribution platform 5005 may be implemented by any computer server, data facility, cloud service, etc., capable of storing and transmitting software to other computing devices. The third parties may be customers of the entity owning and/or operating the software distribution platform 5005. For example, the entity that owns and/or operates the software distribution platform 5005 may be a developer, a seller, and/or a licensor of software such as the example machine readable instructions 1632. The third parties may be consumers, users, retailers, OEMs, etc., who purchase and/or license the software for use and/or re-sale and/or sub-licensing. In the illustrated example, the software distribution platform 5005 includes one or more servers and one or more storage devices. The storage devices store the machine readable instructions 1632, which may correspond to the example machine readable instructions of the flowcharts disclosed herein, as described above. The one or more servers of the example software distribution platform 5005 are in communication with a network 5010, which may correspond to any one or more of the Internet and/or any of the example networks 1626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 5005. For example, the software, which may correspond to the example machine readable instructions of the flowcharts disclosed herein, may be downloaded to the example processor platform 1600 or any processor platform disclosed in one or more of FIGS. 16, 21, 26, 33, and/or 47, which is to execute the machine readable instructions. In some example, one or more servers of the software distribution platform 5005 periodically offer, transmit, and/or force updates to the software (e.g., the example machine readable instructions 1632) to ensure improvements, patches, updates, etc., are distributed and applied to the software at the end user devices.

Example methods, apparatus, systems, and articles of manufacture for composable machine learning compute nodes are disclosed herein. Further examples and combinations thereof include the following:

Example methods, apparatus, systems, and articles of manufacture to managing processing units are disclosed herein. Further examples and combinations thereof include the following:

Example 1 includes an apparatus for managing processing units, comprising interface circuitry to detect a request to initialize a computing system, and processor circuitry including one or more of at least one of a central processing unit, a graphic processing unit or a digital signal processor, the at least one of the central processing unit, the graphic processing unit or the digital signal processor having control circuitry, arithmetic and logic circuitry, and one or more registers, the processor circuitry to execute instructions to execute a system boot software retrieved from a memory, execute firmware for a heterogenous processing unit, the firmware retrieved from the memory, identify, via a silicon initialization code, a type of the heterogenous processing unit, and cause, via the silicon initialization code, initialization of the heterogeneous processing unit.

Example 2 includes an apparatus as defined in example 1, wherein the memory is serial peripheral interface flash memory.

Example 3 includes an apparatus as defined in example 2, further comprising an enhanced serial peripheral interface to facilitate sharing the serial peripheral interface flash memory between the central processing unit and the heterogenous processing unit.

Example 4 includes an apparatus as defined in example 1, wherein the heterogeneous processor is a graphics processing unit.

Example 5 includes an apparatus as defined in example 1, wherein the heterogeneous processor is a discrete graphics processing unit.

Example 6 includes an apparatus as defined in example 1, wherein the processor circuitry is to execute the instructions to retrieve, via the silicon initialization code, a mainboard specific configuration including peripheral connect interface enhanced (PCI-E) slot information.

Example 7 includes an apparatus as defined in example 1, wherein the processor circuitry is to execute the instructions to store updateable product data including address information for the heterogenous processing unit.

Example 8 includes an apparatus as defined in example 7, wherein the processor circuitry is to execute the instructions to retrieve, via the silicon initialization code, the updateable product data to access the information for the heterogenous processing unit.

Example 9 includes a non-transitory computer readable medium comprising instructions that, when executed cause a processor to at least detect a request to initialize a computing system, and execute a system boot software retrieved from a memory, execute firmware for a heterogenous processing unit, the firmware retrieved from the memory, identify, via a silicon initialization code, a type of the heterogenous processing unit, and cause, via the silicon initialization code, initialization of the heterogeneous processing unit.

Example 10 includes a non-transitory computer readable medium as defined in example 9, wherein the memory is serial peripheral interface flash memory.

Example 11 includes a non-transitory computer readable medium as defined in example 10, wherein the instructions, when executed, cause the processor to facilitate sharing the serial peripheral interface flash memory between the central processing unit and the heterogenous processing unit.

Example 12 includes a non-transitory computer readable medium as defined in example 9, wherein the heterogeneous processor is a graphics processing unit.

Example 13 includes a non-transitory computer readable medium as defined in example 9, wherein the heterogeneous processor is a discrete graphics processing unit.

Example 14 includes a non-transitory computer readable medium as defined in example 9, wherein the instructions, when executed, cause the processor to retrieve, via the silicon initialization code, a mainboard specific configuration including peripheral connect interface enhanced (PCI-E) slot information.

Example 15 includes a non-transitory computer readable medium as defined in example 9, wherein the instructions, when executed, cause the processor to store updateable product data including address information for the heterogenous processing unit.

Example 16 includes a non-transitory computer readable medium as defined in example 15, wherein the instructions, when executed, cause the processor to retrieve, via the silicon initialization code, the updateable product data to access the information for the heterogenous processing unit.

Example 17 includes a method comprising detecting a request to initialize a computing system, and executing a system boot software retrieved from a memory, executing firmware for a heterogenous processing unit, the firmware retrieved from the memory, identifying, via a silicon initialization code, a type of the heterogenous processing unit, and causing, via the silicon initialization code, initialization of the heterogeneous processing unit.

Example 18 includes a method as defined in example 17, wherein the memory is serial peripheral interface flash memory.

Example 19 includes a method as defined in example 18, further comprising facilitating sharing the serial peripheral interface flash memory between the central processing unit and the heterogenous processing unit.

Example 20 includes a method as defined in example 17, wherein the heterogeneous processor is a graphics processing unit.

Example 21 includes a method as defined in example 17, wherein the heterogeneous processor is a discrete graphics processing unit.

Example 22 includes a method as defined in example 17, further comprising retrieving, via the silicon initialization code, a mainboard specific configuration including peripheral connect interface enhanced (PCI-E) slot information.

Example 23 includes a method as defined in example 17, further comprising storing updateable product data including address information for the heterogenous processing unit.

Example 24 includes a method as defined in example 23, further comprising retrieving, via the silicon initialization code, the updateable product data to access the information for the heterogenous processing unit.

Example 25 includes an apparatus for managing processing units, comprising interface circuitry to detect a request to obtain a resource request from a workload, processor circuitry including one or more of at least one of a central processing unit, a graphic processing unit or a digital signal processor, the at least one of the central processing unit, the graphic processing unit or the digital signal processor having control circuitry, arithmetic and logic circuitry, and one or more registers, the processor circuitry to execute instructions to determine if resources are available for the workload on an infrastructure processing unit managed system, negotiate with the infrastructure processing unit to determine if an executing workload can be migrated, in response to determining that an executing workload can be migrated, cause the executing workload to be migrated, and cause the workload to execute on the resource.

Example 26 includes an apparatus as defined in example 25, wherein the workload is a virtual machine.

Example 27 includes an apparatus as defined in example 25, wherein the processor circuitry is to execute the instructions to validate the resource request.

Example 28 includes an apparatus as defined in example 25, wherein the resource request identifies a service level agreement.

Example 29 includes an apparatus as defined in example 28, wherein the processor circuitry is to execute the instructions to determine if the service level agreement identified in the resource request can be met by any available resources.

Example 30 includes an apparatus as defined in example 29, wherein the processor circuitry is to prompt a user to provide a valid request in response to determining that the service level agreement cannot be met.

Example 31 includes an apparatus as defined in example 25, wherein the processor circuitry is to execute the instructions to update a class of service for the executing workload.

Example 32 includes an apparatus as defined in example 25, wherein the processor circuitry is to execute the instructions to store an association of the workload and the resources in a blockchain.

Example 33 includes a non-transitory computer readable medium comprising instructions that, when executed, causes a processor to at least detect a request to obtain a resource request from a workload, determine if resources are available for the workload on an infrastructure processing unit managed system, negotiate with the infrastructure processing unit to determine if an executing workload can be migrated, in response to determining that an executing workload can be migrated, cause the executing workload to be migrated, and cause the workload to execute on the resource.

Example 34 includes a non-transitory computer readable medium as defined in example 33, wherein the workload is a virtual machine.

Example 35 includes a non-transitory computer readable medium as defined in example 33, wherein the instructions, when executed, cause the processor to validate the resource request.

Example 36 includes a non-transitory computer readable medium as defined in example 33, wherein the resource request identifies a service level agreement.

Example 37 includes a non-transitory computer readable medium as defined in example 36, wherein the instructions, when executed, cause the processor to execute the instructions to determine if the service level agreement identified in the resource request can be met by any available resources.

Example 38 includes a non-transitory computer readable medium as defined in example 37, wherein the instructions, when executed, cause the processor to prompt a user to provide a valid request in response to determining that the service level agreement cannot be met.

Example 39 includes a non-transitory computer readable medium as defined in example 33, wherein the instructions, when executed, cause the processor to update a class of service for the executing workload.

Example 40 includes a non-transitory computer readable medium as defined in example 33, wherein the instructions, when executed, cause the processor to store an association of the workload and the resources in a blockchain.

Example 41 includes a method comprising detecting a request to obtain a resource request from a workload, determining if resources are available for the workload on an infrastructure processing unit managed system, negotiating with the infrastructure processing unit to determine if an executing workload can be migrated, in response to determining that an executing workload can be migrated, causing the executing workload to be migrated, and causing the workload to execute on the resource.

Example 42 includes a method as defined in example 41, wherein the workload is a virtual machine.

Example 43 includes a method as defined in example 41, further comprising validating the resource request.

Example 44 includes a method as defined in example 41, wherein the resource request identifies a service level agreement.

Example 45 includes a method as defined in example 44, further comprising executing the instructions to determine if the service level agreement identified in the resource request can be met by any available resources.

Example 46 includes a method as defined in example 45, further comprising prompting a user to provide a valid request in response to determining that the service level agreement cannot be met.

Example 47 includes a method as defined in example 41, further comprising updating a class of service for the executing workload.

Example 48 includes a method as defined in example 41, further comprising storing an association of the workload and the resources in a blockchain.

Example 49 includes an apparatus for managing processing units, comprising interface circuitry to detect a request to execute a deep neural network, and processor circuitry including one or more of at least one of a central processing unit, a graphic processing unit or a digital signal processor, the at least one of the central processing unit, the graphic processing unit or the digital signal processor having control circuitry, arithmetic and logic circuitry, and one or more registers, the processor circuitry to execute instructions to obtain a service level agreement associated with the request, determine a candidate set of operation parameters to service the request based on the service level agreement, generate a kernel for a group of operation parameters from the candidate set, and execute the kernel to determine performance of the kernel.

Example 50 includes an apparatus as defined in example 49, wherein the processor circuitry is to execute the instructions to determine if the performance meets the service level agreement.

Example 51 includes an apparatus as defined in example 49, wherein the processor circuitry is to execute the instructions to determine the candidate set based on the hardware capabilities of a computing system for executing the kernel.

Example 52 includes an apparatus as defined in example 49, wherein the processor circuitry is to execute the instructions to obtain an operation description associated with the request.

Example 53 includes an apparatus as defined in example 49, wherein the processor circuitry is to execute the instructions to implement an application programming interface to receive the request.

Example 54 includes an apparatus as defined in example 53, wherein the application programming interface manages a plurality of heterogenous processors.

Example 55 includes an apparatus as defined in example 53, wherein the application programming interface is included in a oneAPI framework.

Example 56 includes a non-transitory computer readable medium comprising instructions that, when executed, cause a processor to at least detect a request to execute a deep neural network, and obtain a service level agreement associated with the request, determine a candidate set of operation parameters to service the request based on the service level agreement, generate a kernel for a group of operation parameters from the candidate set, and execute the kernel to determine performance of the kernel.

Example 57 includes a non-transitory computer readable medium as defined in example 56, wherein the instructions, when executed, cause the processor to determine if the performance meets the service level agreement.

Example 58 includes a non-transitory computer readable medium as defined in example 56, wherein the instructions, when executed, cause the processor to determine the candidate set based on the hardware capabilities of a computing system for executing the kernel.

Example 59 includes a non-transitory computer readable medium as defined in example 56, wherein the instructions, when executed, cause the processor to obtain an operation description associated with the request.

Example 60 includes a non-transitory computer readable medium as defined in example 56, wherein the instructions, when executed, cause the processor to implement an application programming interface to receive the request.

Example 61 includes a non-transitory computer readable medium as defined in example 60, wherein the application programming interface manages a plurality of heterogenous processors.

Example 62 includes a non-transitory computer readable medium as defined in example 60, wherein the application programming interface is included in a oneAPI framework.

Example 63 includes a method comprising detecting a request to execute a deep neural network, and obtaining a service level agreement associated with the request, determining a candidate set of operation parameters to service the request based on the service level agreement, generating a kernel for a group of operation parameters from the candidate set, and executing the kernel to determine performance of the kernel.

Example 64 includes a method as defined in example 63, further comprising determining if the performance meets the service level agreement.

Example 65 includes a method as defined in example 63, further comprising determining the candidate set based on the hardware capabilities of a computing system for executing the kernel.

Example 66 includes a method as defined in example 63, further comprising obtaining an operation description associated with the request.

Example 67 includes a method as defined in example 63, further comprising implementing an application programming interface to receive the request.

Example 68 includes a method as defined in example 67, wherein the application programming interface manages a plurality of heterogenous processors.

Example 69 includes a method as defined in example 67, wherein the application programming interface is included in a oneAPI framework.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus for managing processing units, comprising:
interface circuitry to detect a request to obtain a resource request from a workload;
processor circuitry including one or more of:
at least one of a central processing unit, a graphic processing unit or a digital signal processor, the at least one of the central processing unit, the graphic processing unit or the digital signal processor having control circuitry, arithmetic and logic circuitry, and one or more registers, the processor circuitry to execute instructions to:
determine if resources are available for the workload on an infrastructure processing unit managed system;
negotiate with the infrastructure processing unit to determine if an executing workload can be migrated;
in response to determining that an executing workload can be migrated, cause the executing workload to be migrated; and
cause the workload to execute on the resource.

2. An apparatus as defined in claim 1, wherein the workload is a virtual machine.

3. An apparatus as defined in claim 1, wherein the processor circuitry is to execute the instructions to validate the resource request.

4. An apparatus as defined in claim 1, wherein the resource request identifies a service level agreement.

5. An apparatus as defined in claim 4, wherein the processor circuitry is to execute the instructions to determine if the service level agreement identified in the resource request can be met by any available resources.

6. An apparatus as defined in claim 5, wherein the processor circuitry is to prompt a user to provide a valid request in response to determining that the service level agreement cannot be met.

7. An apparatus as defined in claim 1, wherein the processor circuitry is to execute the instructions to update a class of service for the executing workload.

8. An apparatus as defined in claim 1, wherein the processor circuitry is to execute the instructions to store an association of the workload and the resources in a blockchain.

9. A non-transitory computer readable medium comprising instructions that, when executed, causes a processor to at least:
detect a request to obtain a resource request from a workload;
determine if resources are available for the workload on an infrastructure processing unit managed system;
negotiate with the infrastructure processing unit to determine if an executing workload can be migrated;
in response to determining that an executing workload can be migrated, cause the executing workload to be migrated; and
cause the workload to execute on the resource.

10. A non-transitory computer readable medium as defined in claim 9, wherein the workload is a virtual machine.

11. A non-transitory computer readable medium as defined in claim 9, wherein the instructions, when executed, cause the processor to validate the resource request.

12. A non-transitory computer readable medium as defined in claim 9, wherein the resource request identifies a service level agreement.

13. A non-transitory computer readable medium as defined in claim 12, wherein the instructions, when executed, cause the processor to execute the instructions to determine if the service level agreement identified in the resource request can be met by any available resources.

14. A non-transitory computer readable medium as defined in claim 13, wherein the instructions, when executed, cause the processor to prompt a user to provide a valid request in response to determining that the service level agreement cannot be met.

15. A non-transitory computer readable medium as defined in claim 9, wherein the instructions, when executed, cause the processor to update a class of service for the executing workload.

16. A non-transitory computer readable medium as defined in claim 9, wherein the instructions, when executed, cause the processor to store an association of the workload and the resources in a blockchain.

17. A method comprising:
detecting, a request to obtain a resource request from a workload;
determining if resources are available for the workload on an infrastructure processing unit managed system;
negotiating, via instructions executing on a processor, with the infrastructure processing unit to determine if an executing workload can be migrated;
in response to determining that an executing workload can be migrated, causing the executing workload to be migrated; and
causing the workload to execute on the resource.

18. A method as defined in claim 17, wherein the workload is a virtual machine.

19. A method as defined in claim 17, further comprising validating the resource request.

20. A method as defined in claim 17, wherein the resource request identifies a service level agreement.

21. A method as defined in claim 20, further comprising determining if the service level agreement identified in the resource request can be met by any available resources.

22. A method as defined in claim 21, further comprising prompting a user to provide a valid request in response to determining that the service level agreement cannot be met.

23. A method as defined in claim 17, further comprising updating a class of service for the executing workload.

24. A method as defined in claim 17, further comprising storing an association of the workload and the resources in a blockchain.
